SEQUENCE LISTING (395 sequences)

SEQ ID NO: 1 - RNA, 19 nt, Artificial Sequence
  Synthetic oligonucleotide siRNA.
ggaauauacuggucaauag

SEQ ID NO: 2 - RNA, 19 nt, Artificial Sequence
  Synthetic oligonucleotide siRNA.
aaacaucauucgccuagaa

SEQ ID NO: 3 - RNA, 19 nt, Artificial Sequence
  Synthetic oligonucleotide siRNA.
ccacauggaucggcaaaga

SEQ ID NO: 4 - RNA, 19 nt, Artificial Sequence
  Synthetic oligonucleotide siRNA.
gaucccaguugccauuaaa

SEQ ID NO: 5 - RNA, 19 nt, Artificial Sequence
  Synthetic oligonucleotide siRNA.
ggaaaucagugacauagug

SEQ ID NO: 6 - RNA, 19 nt, Artificial Sequence
  Synthetic oligonucleotide siRNA.
gguccacacugcaauguuu

SEQ ID NO: 7 - RNA, 19 nt, Artificial Sequence
  Synthetic oligonucleotide siRNA.
gaaggaaaucagugacaua

SEQ ID NO: 8 - RNA, 19 nt, Artificial Sequence
  Synthetic oligonucleotide siRNA.
ucacugaguucaugaccua

SEQ ID NO: 9 - RNA, 19 nt, Artificial Sequence
  Synthetic oligonucleotide siRNA.
gaaauggagcgaacagaua

SEQ ID NO: 10 - RNA, 19 nt, Artificial Sequence
  Synthetic oligonucleotide siRNA.
gagccaaauuuccuauuaa

SEQ ID NO: 11 - RNA, 19 nt, Artificial Sequence
  Synthetic oligonucleotide siRNA.
guaauaagccuacagucua

SEQ ID NO: 12 - RNA, 19 nt, Artificial Sequence
  Synthetic oligonucleotide siRNA.
ggagugaaguucgcucuaa

SEQ ID NO: 13 - RNA, 19 nt, Artificial Sequence
  Synthetic oligonucleotide siRNA.
gcaagucguggaugaguaa

SEQ ID NO: 14 - RNA, 19 nt, Artificial Sequence
  Synthetic oligonucleotide siRNA.
gaaagcgacuggaggcuga

SEQ ID NO: 15 - RNA, 19 nt, Artificial Sequence
  Synthetic oligonucleotide siRNA.
cauccuaccuggagcgcua

SEQ ID NO: 16 - RNA, 19 nt, Artificial Sequence
  Synthetic oligonucleotide siRNA.
gcaggaacaucgcaaggug

SEQ ID NO: 17 - RNA, 19 nt, Artificial Sequence
  Synthetic oligonucleotide siRNA.
gacaagauccugcagaaua

SEQ ID NO: 18 - RNA, 19 nt, Artificial Sequence
  Synthetic oligonucleotide siRNA.
ggaagagucuggcaguuga

SEQ ID NO: 19 - RNA, 19 nt, Artificial Sequence
  Synthetic oligonucleotide siRNA.
gcacguggcucgggacauu

SEQ ID NO: 20 - RNA, 19 nt, Artificial Sequence
  Synthetic oligonucleotide siRNA.
ggucauagcuccuuggaau

SEQ ID NO: 21 - RNA, 19 nt, Artificial Sequence
  Synthetic oligonucleotide siRNA.
gaaagaaggagacccguua

SEQ ID NO: 22 - RNA, 19 nt, Artificial Sequence
  Synthetic oligonucleotide siRNA.
ccaagaagaucuacaaugg

SEQ ID NO: 23 - RNA, 19 nt, Artificial Sequence
  Synthetic oligonucleotide siRNA.
ggaacugcaugcugaauga

SEQ ID NO: 24 - RNA, 19 nt, Artificial Sequence
  Synthetic oligonucleotide siRNA.
gaaggagacccguuaugga

SEQ ID NO: 25 - RNA, 19 nt, Artificial Sequence
  Synthetic oligonucleotide siRNA.
ggucagcgcccaagacaag

SEQ ID NO: 26 - RNA, 19 nt, Artificial Sequence
  Synthetic oligonucleotide siRNA.
gaaacucgggucuggacaa

SEQ ID NO: 27 - RNA, 19 nt, Artificial Sequence
  Synthetic oligonucleotide siRNA.
cgaaucaucgacagugaau

SEQ ID NO: 28 - RNA, 19 nt, Artificial Sequence
  Synthetic oligonucleotide siRNA.
gagcugaucaagcacuaua

SEQ ID NO: 29 - RNA, 19 nt, Artificial Sequence
  Synthetic oligonucleotide siRNA.
gagaagagauuaccuuguu

SEQ ID NO: 30 - RNA, 19 nt, Artificial Sequence
  Synthetic oligonucleotide siRNA.
guaaggcugugaaugauaa

SEQ ID NO: 31 - RNA, 19 nt, Artificial Sequence
  Synthetic oligonucleotide siRNA.
gaagagagccgaagucagu

SEQ ID NO: 32 - RNA, 19 nt, Artificial Sequence
  Synthetic oligonucleotide siRNA.
guaccacucuagcccaaua

SEQ ID NO: 33 - RNA, 19 nt, Artificial Sequence
  Synthetic oligonucleotide siRNA.
gaacaggaauggaagcuua

SEQ ID NO: 34 - RNA, 19 nt, Artificial Sequence
  Synthetic oligonucleotide siRNA.
gcuaugggcugccaaauuu

SEQ ID NO: 35 - RNA, 19 nt, Artificial Sequence
  Synthetic oligonucleotide siRNA.
gaaagcaacuuaccauggu

SEQ ID NO: 36 - RNA, 19 nt, Artificial Sequence
  Synthetic oligonucleotide siRNA.
gguaaacgaucaaggaguu

SEQ ID NO: 37 - RNA, 19 nt, Artificial Sequence
  Synthetic oligonucleotide siRNA.
caacuuagccaagacaauu

SEQ ID NO: 38 - RNA, 19 nt, Artificial Sequence
  Synthetic oligonucleotide siRNA.
gaaauugaaggcucaguga

SEQ ID NO: 39 - RNA, 19 nt, Artificial Sequence
  Synthetic oligonucleotide siRNA.
uggaacagcugaacauugu

SEQ ID NO: 40 - RNA, 19 nt, Artificial Sequence
  Synthetic oligonucleotide siRNA.
gcuuccaacugcuuauaua

SEQ ID NO: 41 - RNA, 19 nt, Artificial Sequence
  Synthetic oligonucleotide siRNA.
ggagagcucugacguuuga

SEQ ID NO: 42 - RNA, 19 nt, Artificial Sequence
  Synthetic oligonucleotide siRNA.
caacaacgcuaccuuccaa

SEQ ID NO: 43 - RNA, 19 nt, Artificial Sequence
  Synthetic oligonucleotide siRNA.
ccacgcagcugccuuacaa

SEQ ID NO: 44 - RNA, 19 nt, Artificial Sequence
  Synthetic oligonucleotide siRNA.
ggagagagcgggacuauac

SEQ ID NO: 45 - RNA, 19 nt, Artificial Sequence
  Synthetic oligonucleotide siRNA.
gaacaaagucgccgucaag

SEQ ID NO: 46 - RNA, 19 nt, Artificial Sequence
  Synthetic oligonucleotide siRNA.
gcgagugccuuauccaaga

SEQ ID NO: 47 - RNA, 19 nt, Artificial Sequence
  Synthetic oligonucleotide siRNA.
ggagaagggcuacaagaug

SEQ ID NO: 48 - RNA, 19 nt, Artificial Sequence
  Synthetic oligonucleotide siRNA.
ggaacaaagucgccgucaa

SEQ ID NO: 49 - RNA, 19 nt, Artificial Sequence
  Synthetic oligonucleotide siRNA.
ugaaagaggugaagaucau

SEQ ID NO: 50 - RNA, 19 nt, Artificial Sequence
  Synthetic oligonucleotide siRNA.
gggacacccuuugcuggua

SEQ ID NO: 51 - RNA, 19 nt, Artificial Sequence
  Synthetic oligonucleotide siRNA.
gaaugucgcuuccggcgug

SEQ ID NO: 52 - RNA, 19 nt, Artificial Sequence
  Synthetic oligonucleotide siRNA.
gagcgucugucugcgggua

SEQ ID NO: 53 - RNA, 19 nt, Artificial Sequence
  Synthetic oligonucleotide siRNA.
gguaagaacuacacaauca

SEQ ID NO: 54 - RNA, 19 nt, Artificial Sequence
  Synthetic oligonucleotide siRNA.
gaacgagagugccaccaau

SEQ ID NO: 55 - RNA, 19 nt, Artificial Sequence
  Synthetic oligonucleotide siRNA.
gacuuacgaucgcaucuuu

SEQ ID NO: 56 - RNA, 19 nt, Artificial Sequence
  Synthetic oligonucleotide siRNA.
ugucuggccuggacgauuu

SEQ ID NO: 57 - RNA, 19 nt, Artificial Sequence
  Synthetic oligonucleotide siRNA.
ccuagaagcugccauuaaa

SEQ ID NO: 58 - RNA, 19 nt, Artificial Sequence
  Synthetic oligonucleotide siRNA.
gauuaggccuggcuuauga

SEQ ID NO: 59 - RNA, 19 nt, Artificial Sequence
  Synthetic oligonucleotide siRNA.
cccaguagcugcacacaua

SEQ ID NO: 60 - RNA, 19 nt, Artificial Sequence
  Synthetic oligonucleotide siRNA.
ggugguaccugaacuguau

SEQ ID NO: 61 - RNA, 19 nt, Artificial Sequence
  Synthetic oligonucleotide siRNA.
gaaggaaacugaauucaaa

SEQ ID NO: 62 - RNA, 19 nt, Artificial Sequence
  Synthetic oligonucleotide siRNA.
ggaaauauguacuacgaaa

SEQ ID NO: 63 - RNA, 19 nt, Artificial Sequence
  Synthetic oligonucleotide siRNA.
ccacaaagcagugaauuua

SEQ ID NO: 64 - RNA, 19 nt, Artificial Sequence
  Synthetic oligonucleotide siRNA.
guaacaagcucacgcaguu

SEQ ID NO: 65 - RNA, 19 nt, Artificial Sequence
  Synthetic oligonucleotide siRNA.
aggaaguuacucugaugga

SEQ ID NO: 66 - RNA, 19 nt, Artificial Sequence
  Synthetic oligonucleotide siRNA.
agaaagaaccgaggcaacu

SEQ ID NO: 67 - RNA, 19 nt, Artificial Sequence
  Synthetic oligonucleotide siRNA.
agacuguggccauuaagac

SEQ ID NO: 68 - RNA, 19 nt, Artificial Sequence
  Synthetic oligonucleotide siRNA.
gcgcauucuuugcaguauu

SEQ ID NO: 69 - RNA, 19 nt, Artificial Sequence
  Synthetic oligonucleotide siRNA.
ggagggaucuggcaacuug

SEQ ID NO: 70 - RNA, 19 nt, Artificial Sequence
  Synthetic oligonucleotide siRNA.
gcagcaaggugcacgaauu

SEQ ID NO: 71 - RNA, 19 nt, Artificial Sequence
  Synthetic oligonucleotide siRNA.
ggagaaggauggcgaguuc

SEQ ID NO: 72 - RNA, 19 nt, Artificial Sequence
  Synthetic oligonucleotide siRNA.
gaaguucacuaccgagauc

SEQ ID NO: 73 - RNA, 19 nt, Artificial Sequence
  Synthetic oligonucleotide siRNA.
gaucggaccuccagaaaua

SEQ ID NO: 74 - RNA, 19 nt, Artificial Sequence
  Synthetic oligonucleotide siRNA.
gaacucagcucagaagauu

SEQ ID NO: 75 - RNA, 19 nt, Artificial Sequence
  Synthetic oligonucleotide siRNA.
gagcaucaguuuacaaaga

SEQ ID NO: 76 - RNA, 19 nt, Artificial Sequence
  Synthetic oligonucleotide siRNA.
aaauguggguggaauauaa

SEQ ID NO: 77 - RNA, 19 nt, Artificial Sequence
  Synthetic oligonucleotide siRNA.
ggucugggaugaaguauuu

SEQ ID NO: 78 - RNA, 19 nt, Artificial Sequence
  Synthetic oligonucleotide siRNA.
gaaugaaguuaccuuauug

SEQ ID NO: 79 - RNA, 19 nt, Artificial Sequence
  Synthetic oligonucleotide siRNA.
gaacuuggguggauagcaa

SEQ ID NO: 80 - RNA, 19 nt, Artificial Sequence
  Synthetic oligonucleotide siRNA.
gagauuaaauucaccuuga

SEQ ID NO: 81 - RNA, 19 nt, Artificial Sequence
  Synthetic oligonucleotide siRNA.
gaaaagagauguugcagua

SEQ ID NO: 82 - RNA, 19 nt, Artificial Sequence
  Synthetic oligonucleotide siRNA.
cuagaugccuccuguauua

SEQ ID NO: 83 - RNA, 19 nt, Artificial Sequence
  Synthetic oligonucleotide siRNA.
agaagaagguuaucguuua

SEQ ID NO: 84 - RNA, 19 nt, Artificial Sequence
  Synthetic oligonucleotide siRNA.
uagcaaagcugaccaagaa

SEQ ID NO: 85 - RNA, 19 nt, Artificial Sequence
  Synthetic oligonucleotide siRNA.
gaagaugcacuaucagaau

SEQ ID NO: 86 - RNA, 19 nt, Artificial Sequence
  Synthetic oligonucleotide siRNA.
gagaagaugcacuaucaga

SEQ ID NO: 87 - RNA, 19 nt, Artificial Sequence
  Synthetic oligonucleotide siRNA.
ucucagaccugggcuaugu

SEQ ID NO: 88 - RNA, 19 nt, Artificial Sequence
  Synthetic oligonucleotide siRNA.
gcgcgucuaugcugagauc

SEQ ID NO: 89 - RNA, 19 nt, Artificial Sequence
  Synthetic oligonucleotide siRNA.
gcgauaagcuccagcauua

SEQ ID NO: 90 - RNA, 19 nt, Artificial Sequence
  Synthetic oligonucleotide siRNA.
gaaacgggcuuauagcaaa

SEQ ID NO: 91 - RNA, 19 nt, Artificial Sequence
  Synthetic oligonucleotide siRNA.
ggaugaagaucuacauuga

SEQ ID NO: 92 - RNA, 19 nt, Artificial Sequence
  Synthetic oligonucleotide siRNA.
gcacgucucugucaacauc

SEQ ID NO: 93 - RNA, 19 nt, Artificial Sequence
  Synthetic oligonucleotide siRNA.
acuaugagcugcaguacua

SEQ ID NO: 94 - RNA, 19 nt, Artificial Sequence
  Synthetic oligonucleotide siRNA.
guacaacgccacagccaua

SEQ ID NO: 95 - RNA, 19 nt, Artificial Sequence
  Synthetic oligonucleotide siRNA.
ggaaagcaaugacuguucu

SEQ ID NO: 96 - RNA, 19 nt, Artificial Sequence
  Synthetic oligonucleotide siRNA.
cggacaagcugcaacacua

SEQ ID NO: 97 - RNA, 19 nt, Artificial Sequence
  Synthetic oligonucleotide siRNA.
ggaaugaagguuuauauug

SEQ ID NO: 98 - RNA, 19 nt, Artificial Sequence
  Synthetic oligonucleotide siRNA.
gauccuaccuacaccaguu

SEQ ID NO: 99 - RNA, 19 nt, Artificial Sequence
  Synthetic oligonucleotide siRNA.
gaagaccugcuccguauug

SEQ ID NO: 100 - RNA, 19 nt, Artificial Sequence
  Synthetic oligonucleotide siRNA.
cacaauaacuucuaccgug

SEQ ID NO: 101 - RNA, 19 nt, Artificial Sequence
  Synthetic oligonucleotide siRNA.
ggacaaacacggacaguau

SEQ ID NO: 102 - RNA, 19 nt, Artificial Sequence
  Synthetic oligonucleotide siRNA.
guacuaaggucuacaucga

SEQ ID NO: 103 - RNA, 19 nt, Artificial Sequence
  Synthetic oligonucleotide siRNA.
ggagagaagcagaauauuc

SEQ ID NO: 104 - RNA, 19 nt, Artificial Sequence
  Synthetic oligonucleotide siRNA.
gccaauagccacucuaaca

SEQ ID NO: 105 - RNA, 19 nt, Artificial Sequence
  Synthetic oligonucleotide siRNA.
ggaagucgauccugcuuau

SEQ ID NO: 106 - RNA, 19 nt, Artificial Sequence
  Synthetic oligonucleotide siRNA.
ggaccaagguggacacaau

SEQ ID NO: 107 - RNA, 19 nt, Artificial Sequence
  Synthetic oligonucleotide siRNA.
ugugggaagugaugaguua

SEQ ID NO: 108 - RNA, 19 nt, Artificial Sequence
  Synthetic oligonucleotide siRNA.
cgggagaccuucacccuuu

SEQ ID NO: 109 - RNA, 19 nt, Artificial Sequence
  Synthetic oligonucleotide siRNA.
ggacgaauucugcacaaug

SEQ ID NO: 110 - RNA, 19 nt, Artificial Sequence
  Synthetic oligonucleotide siRNA.
gacgaauucugcacaaugg

SEQ ID NO: 111 - RNA, 19 nt, Artificial Sequence
  Synthetic oligonucleotide siRNA.
cuacaacacagacacguuu

SEQ ID NO: 112 - RNA, 19 nt, Artificial Sequence
  Synthetic oligonucleotide siRNA.
agacgaagcauacgugaug

SEQ ID NO: 113 - RNA, 19 nt, Artificial Sequence
  Synthetic oligonucleotide siRNA.
aagaggaugucaacgguua

SEQ ID NO: 114 - RNA, 19 nt, Artificial Sequence
  Synthetic oligonucleotide siRNA.
gaagacugccagacauuga

SEQ ID NO: 115 - RNA, 19 nt, Artificial Sequence
  Synthetic oligonucleotide siRNA.
gcaguggauucgagaagug

SEQ ID NO: 116 - RNA, 19 nt, Artificial Sequence
  Synthetic oligonucleotide siRNA.
ggaccgagaugcugagaua

SEQ ID NO: 117 - RNA, 19 nt, Artificial Sequence
  Synthetic oligonucleotide siRNA.
gcaggaaacaucuauauua

SEQ ID NO: 118 - RNA, 19 nt, Artificial Sequence
  Synthetic oligonucleotide siRNA.
gaucacaacugcugcuuaa

SEQ ID NO: 119 - RNA, 19 nt, Artificial Sequence
  Synthetic oligonucleotide siRNA.
ccucaaagauaccuaguua

SEQ ID NO: 120 - RNA, 19 nt, Artificial Sequence
  Synthetic oligonucleotide siRNA.
gcucuggaguguauacauu

SEQ ID NO: 121 - RNA, 19 nt, Artificial Sequence
  Synthetic oligonucleotide siRNA.
ggagugaccugaagaauuc

SEQ ID NO: 122 - RNA, 19 nt, Artificial Sequence
  Synthetic oligonucleotide siRNA.
uaaagcagauucccauuaa

SEQ ID NO: 123 - RNA, 19 nt, Artificial Sequence
  Synthetic oligonucleotide siRNA.
ggaaaguacuguccaaaug

SEQ ID NO: 124 - RNA, 19 nt, Artificial Sequence
  Synthetic oligonucleotide siRNA.
gaacaacggcugcuaaaga

SEQ ID NO: 125 - RNA, 19 nt, Artificial Sequence
  Synthetic oligonucleotide siRNA.
cgaggauccugaagcagua

SEQ ID NO: 126 - RNA, 19 nt, Artificial Sequence
  Synthetic oligonucleotide siRNA.
aggaauaccuggagauuag

SEQ ID NO: 127 - RNA, 19 nt, Artificial Sequence
  Synthetic oligonucleotide siRNA.
caacaggagcuccggaaug

SEQ ID NO: 128 - RNA, 19 nt, Artificial Sequence
  Synthetic oligonucleotide siRNA.
gguguugggugagcagauu

SEQ ID NO: 129 - RNA, 19 nt, Artificial Sequence
  Synthetic oligonucleotide siRNA.
uaagaaaugucuccuuuga

SEQ ID NO: 130 - RNA, 19 nt, Artificial Sequence
  Synthetic oligonucleotide siRNA.
gauggucccuuguauguca

SEQ ID NO: 131 - RNA, 19 nt, Artificial Sequence
  Synthetic oligonucleotide siRNA.
cuuaagaaaugucuccuuu

SEQ ID NO: 132 - RNA, 19 nt, Artificial Sequence
  Synthetic oligonucleotide siRNA.
auucaaaccugaccacaga

SEQ ID NO: 133 - RNA, 19 nt, Artificial Sequence
  Synthetic oligonucleotide siRNA.
ccaaaucucucaaccagaa

SEQ ID NO: 134 - RNA, 19 nt, Artificial Sequence
  Synthetic oligonucleotide siRNA.
gaacaguauucaccuaguu

SEQ ID NO: 135 - RNA, 19 nt, Artificial Sequence
  Synthetic oligonucleotide siRNA.
ggccaacacugucaaguuu

SEQ ID NO: 136 - RNA, 19 nt, Artificial Sequence
  Synthetic oligonucleotide siRNA.
gugaagauguugaaagaug

SEQ ID NO: 137 - RNA, 19 nt, Artificial Sequence
  Synthetic oligonucleotide siRNA.
ugucggaccuggugucuga

SEQ ID NO: 138 - RNA, 19 nt, Artificial Sequence
  Synthetic oligonucleotide siRNA.
gcaucaagcugcggcauca

SEQ ID NO: 139 - RNA, 19 nt, Artificial Sequence
  Synthetic oligonucleotide siRNA.
ggacggcacacccuacguu

SEQ ID NO: 140 - RNA, 19 nt, Artificial Sequence
  Synthetic oligonucleotide siRNA.
ugcacaaccucgacuacua

SEQ ID NO: 141 - RNA, 19 nt, Artificial Sequence
  Synthetic oligonucleotide siRNA.
gcacuggagucucgugaug

SEQ ID NO: 142 - RNA, 19 nt, Artificial Sequence
  Synthetic oligonucleotide siRNA.
ccucgaauaggcacaguua

SEQ ID NO: 143 - RNA, 19 nt, Artificial Sequence
  Synthetic oligonucleotide siRNA.
auaacuaccugcuagaugu

SEQ ID NO: 144 - RNA, 19 nt, Artificial Sequence
  Synthetic oligonucleotide siRNA.
gcauucggcugcgccauca

SEQ ID NO: 145 - RNA, 19 nt, Artificial Sequence
  Synthetic oligonucleotide siRNA.
gcgaucaugugaagcauua

SEQ ID NO: 146 - RNA, 19 nt, Artificial Sequence
  Synthetic oligonucleotide siRNA.
ucacugagcucaucaccaa

SEQ ID NO: 147 - RNA, 19 nt, Artificial Sequence
  Synthetic oligonucleotide siRNA.
cccagaagcugcccucuuu

SEQ ID NO: 148 - RNA, 19 nt, Artificial Sequence
  Synthetic oligonucleotide siRNA.
gaauaaacgggaaguguug

SEQ ID NO: 149 - RNA, 19 nt, Artificial Sequence
  Synthetic oligonucleotide siRNA.
gagcaaacgugacuuauuu

SEQ ID NO: 150 - RNA, 19 nt, Artificial Sequence
  Synthetic oligonucleotide siRNA.
ccaaauggguuucauguua

SEQ ID NO: 151 - RNA, 19 nt, Artificial Sequence
  Synthetic oligonucleotide siRNA.
caacaaggaugcagcacua

SEQ ID NO: 152 - RNA, 19 nt, Artificial Sequence
  Synthetic oligonucleotide siRNA.
gccggaaguuguaugguua

SEQ ID NO: 153 - RNA, 19 nt, Artificial Sequence
  Synthetic oligonucleotide siRNA.
gaaggcaucuacaccauua

SEQ ID NO: 154 - RNA, 19 nt, Artificial Sequence
  Synthetic oligonucleotide siRNA.
gaaggagucuggaauagaa

SEQ ID NO: 155 - RNA, 19 nt, Artificial Sequence
  Synthetic oligonucleotide siRNA.
gaauuuaagucguguguuc

SEQ ID NO: 156 - RNA, 19 nt, Artificial Sequence
  Synthetic oligonucleotide siRNA.
ggaauucauuucacucuga

SEQ ID NO: 157 - RNA, 19 nt, Artificial Sequence
  Synthetic oligonucleotide siRNA.
gcaagaacgugcaucuguu

SEQ ID NO: 158 - RNA, 19 nt, Artificial Sequence
  Synthetic oligonucleotide siRNA.
gcgaauaccuguccuacga

SEQ ID NO: 159 - RNA, 19 nt, Artificial Sequence
  Synthetic oligonucleotide siRNA.
gaagacauuugaggaauuc

SEQ ID NO: 160 - RNA, 19 nt, Artificial Sequence
  Synthetic oligonucleotide siRNA.
gagcagccauucaucaaca

SEQ ID NO: 161 - RNA, 19 nt, Artificial Sequence
  Synthetic oligonucleotide siRNA.
gaaacagacucuucauauu

SEQ ID NO: 162 - RNA, 19 nt, Artificial Sequence
  Synthetic oligonucleotide siRNA.
gaacaauaccacuccagua

SEQ ID NO: 163 - RNA, 19 nt, Artificial Sequence
  Synthetic oligonucleotide siRNA.
caagaccgguuccuuucua

SEQ ID NO: 164 - RNA, 19 nt, Artificial Sequence
  Synthetic oligonucleotide siRNA.
gcaagaauaucuccaaaau

SEQ ID NO: 165 - RNA, 19 nt, Artificial Sequence
  Synthetic oligonucleotide siRNA.
ggaauggacucauaugcaa

SEQ ID NO: 166 - RNA, 19 nt, Artificial Sequence
  Synthetic oligonucleotide siRNA.
caaaggaaguuuacuggau

SEQ ID NO: 167 - RNA, 19 nt, Artificial Sequence
  Synthetic oligonucleotide siRNA.
gcucugaaauuaccaaauc

SEQ ID NO: 168 - RNA, 19 nt, Artificial Sequence
  Synthetic oligonucleotide siRNA.
cgcaugaauuauauccaua

SEQ ID NO: 169 - RNA, 19 nt, Artificial Sequence
  Synthetic oligonucleotide siRNA.
cgggauagcgagaccacua

SEQ ID NO: 170 - RNA, 19 nt, Artificial Sequence
  Synthetic oligonucleotide siRNA.
ggucaaacuucaugcggug

SEQ ID NO: 171 - RNA, 19 nt, Artificial Sequence
  Synthetic oligonucleotide siRNA.
gaggagcucuacaacauca

SEQ ID NO: 172 - RNA, 19 nt, Artificial Sequence
  Synthetic oligonucleotide siRNA.
ugguugcccuguaugauua

SEQ ID NO: 173 - RNA, 19 nt, Artificial Sequence
  Synthetic oligonucleotide siRNA.
ggccagaaauggagaauaa

SEQ ID NO: 174 - RNA, 19 nt, Artificial Sequence
  Synthetic oligonucleotide siRNA.
gcagacaccuacaacauca

SEQ ID NO: 175 - RNA, 19 nt, Artificial Sequence
  Synthetic oligonucleotide siRNA.
ggacucaguacgccguuua

SEQ ID NO: 176 - RNA, 19 nt, Artificial Sequence
  Synthetic oligonucleotide siRNA.
gugggaggguuggugauua

SEQ ID NO: 177 - RNA, 19 nt, Artificial Sequence
  Synthetic oligonucleotide siRNA.
ggaagacguuugaggauua

SEQ ID NO: 178 - RNA, 19 nt, Artificial Sequence
  Synthetic oligonucleotide siRNA.
gaacaaggcucccgagagu

SEQ ID NO: 179 - RNA, 19 nt, Artificial Sequence
  Synthetic oligonucleotide siRNA.
ggagagaccuuggaaauug

SEQ ID NO: 180 - RNA, 19 nt, Artificial Sequence
  Synthetic oligonucleotide siRNA.
ggacggaacccaccuauuu

SEQ ID NO: 181 - RNA, 19 nt, Artificial Sequence
  Synthetic oligonucleotide siRNA.
gaacaaucccuguauaaag

SEQ ID NO: 182 - RNA, 19 nt, Artificial Sequence
  Synthetic oligonucleotide siRNA.
gaaauuguuuggugggaga

SEQ ID NO: 183 - RNA, 19 nt, Artificial Sequence
  Synthetic oligonucleotide siRNA.
gcaguuaucugguggaaaa

SEQ ID NO: 184 - RNA, 19 nt, Artificial Sequence
  Synthetic oligonucleotide siRNA.
acaguuuggugccuaaaua

SEQ ID NO: 185 - RNA, 19 nt, Artificial Sequence
  Synthetic oligonucleotide siRNA.
ccacauagcugaucugaaa

SEQ ID NO: 186 - RNA, 19 nt, Artificial Sequence
  Synthetic oligonucleotide siRNA.
ugaaaucacucacauugua

SEQ ID NO: 187 - RNA, 19 nt, Artificial Sequence
  Synthetic oligonucleotide siRNA.
uaaggaaccucuaucauga

SEQ ID NO: 188 - RNA, 19 nt, Artificial Sequence
  Synthetic oligonucleotide siRNA.
gcagguggcuguuaaaucu

SEQ ID NO: 189 - RNA, 19 nt, Artificial Sequence
  Synthetic oligonucleotide siRNA.
gagcaaagauccaagacua

SEQ ID NO: 190 - RNA, 19 nt, Artificial Sequence
  Synthetic oligonucleotide siRNA.
gccagaaacuugaaacuua

SEQ ID NO: 191 - RNA, 19 nt, Artificial Sequence
  Synthetic oligonucleotide siRNA.
gauccuggcauuaguauua

SEQ ID NO: 192 - RNA, 19 nt, Artificial Sequence
  Synthetic oligonucleotide siRNA.
acagaaugcuggaacaaua

SEQ ID NO: 193 - RNA, 19 nt, Artificial Sequence
  Synthetic oligonucleotide siRNA.
gcgccuaucuuucuccuuu

SEQ ID NO: 194 - RNA, 19 nt, Artificial Sequence
  Synthetic oligonucleotide siRNA.
ccagaaaucguagacauua

SEQ ID NO: 195 - RNA, 19 nt, Artificial Sequence
  Synthetic oligonucleotide siRNA.
ccucaucucuucagacuau

SEQ ID NO: 196 - RNA, 19 nt, Artificial Sequence
  Synthetic oligonucleotide siRNA.
uguacgagcucuucaccua

SEQ ID NO: 197 - RNA, 19 nt, Artificial Sequence
  Synthetic oligonucleotide siRNA.
ggaaaucucuugcaagcua

SEQ ID NO: 198 - RNA, 19 nt, Artificial Sequence
  Synthetic oligonucleotide siRNA.
gauuacagaucuccauuua

SEQ ID NO: 199 - RNA, 19 nt, Artificial Sequence
  Synthetic oligonucleotide siRNA.
gcagacagaucuacguuug

SEQ ID NO: 200 - RNA, 19 nt, Artificial Sequence
  Synthetic oligonucleotide siRNA.
gcgauggccucuucuguaa

SEQ ID NO: 201 - RNA, 19 nt, Artificial Sequence
  Synthetic oligonucleotide siRNA.
aaacacggcuuaagcaauu

SEQ ID NO: 202 - RNA, 19 nt, Artificial Sequence
  Synthetic oligonucleotide siRNA.
gaacagaaccuucacugau

SEQ ID NO: 203 - RNA, 19 nt, Artificial Sequence
  Synthetic oligonucleotide siRNA.
gggaagcccucaugucuga

SEQ ID NO: 204 - RNA, 19 nt, Artificial Sequence
  Synthetic oligonucleotide siRNA.
gcaauuccauuuauguguu

SEQ ID NO: 205 - RNA, 19 nt, Artificial Sequence
  Synthetic oligonucleotide siRNA.
gaaauucucucaacugaug

SEQ ID NO: 206 - RNA, 19 nt, Artificial Sequence
  Synthetic oligonucleotide siRNA.
gcagaggucuucacacuuu

SEQ ID NO: 207 - RNA, 19 nt, Artificial Sequence
  Synthetic oligonucleotide siRNA.
uaaaugaucuucagacaga

SEQ ID NO: 208 - RNA, 19 nt, Artificial Sequence
  Synthetic oligonucleotide siRNA.
gagcagcccuacucugaua

SEQ ID NO: 209 - RNA, 19 nt, Artificial Sequence
  Synthetic oligonucleotide siRNA.
gaacugccauuaucccaua

SEQ ID NO: 210 - RNA, 19 nt, Artificial Sequence
  Synthetic oligonucleotide siRNA.
gagagguggugaaacauua

SEQ ID NO: 211 - RNA, 19 nt, Artificial Sequence
  Synthetic oligonucleotide siRNA.
gggccaaguuucccauuaa

SEQ ID NO: 212 - RNA, 19 nt, Artificial Sequence
  Synthetic oligonucleotide siRNA.
gcacgcugcucauccgaaa

SEQ ID NO: 213 - RNA, 19 nt, Artificial Sequence
  Synthetic oligonucleotide siRNA.
ugaauucacuccugccaau

SEQ ID NO: 214 - RNA, 19 nt, Artificial Sequence
  Synthetic oligonucleotide siRNA.
guggcaaccucaacacuga

SEQ ID NO: 215 - RNA, 19 nt, Artificial Sequence
  Synthetic oligonucleotide siRNA.
ggagcuagcuguggauaac

SEQ ID NO: 216 - RNA, 19 nt, Artificial Sequence
  Synthetic oligonucleotide siRNA.
gcaaguuucgccaucagaa

SEQ ID NO: 217 - RNA, 19 nt, Artificial Sequence
  Synthetic oligonucleotide siRNA.
agacucaaccaguacguaa

SEQ ID NO: 218 - RNA, 19 nt, Artificial Sequence
  Synthetic oligonucleotide siRNA.
agauuggagaaggcuugua

SEQ ID NO: 219 - RNA, 19 nt, Artificial Sequence
  Synthetic oligonucleotide siRNA.
gcgacaugauuaaacauua

SEQ ID NO: 220 - RNA, 19 nt, Artificial Sequence
  Synthetic oligonucleotide siRNA.
gauccaacguccaauaaac

SEQ ID NO: 221 - RNA, 19 nt, Artificial Sequence
  Synthetic oligonucleotide siRNA.
gcauuacagcaaggacaag

SEQ ID NO: 222 - RNA, 19 nt, Artificial Sequence
  Synthetic oligonucleotide siRNA.
uacugaaccugcagcauuu

SEQ ID NO: 223 - RNA, 19 nt, Artificial Sequence
  Synthetic oligonucleotide siRNA.
ugggaggucuucucauaug

SEQ ID NO: 224 - RNA, 19 nt, Artificial Sequence
  Synthetic oligonucleotide siRNA.
ugacgaagaugcaacacga

SEQ ID NO: 225 - RNA, 19 nt, Artificial Sequence
  Synthetic oligonucleotide siRNA.
gaacuuaccuuacauagcu

SEQ ID NO: 226 - RNA, 19 nt, Artificial Sequence
  Synthetic oligonucleotide siRNA.
ggaccugcauacuuacuua

SEQ ID NO: 227 - RNA, 19 nt, Artificial Sequence
  Synthetic oligonucleotide siRNA.
ugacaggaaucuucuaauu

SEQ ID NO: 228 - RNA, 19 nt, Artificial Sequence
  Synthetic oligonucleotide siRNA.
gguaauggcucagucauga

SEQ ID NO: 229 - RNA, 19 nt, Artificial Sequence
  Synthetic oligonucleotide siRNA.
gaagaucaguuuccuaauu

SEQ ID NO: 230 - RNA, 19 nt, Artificial Sequence
  Synthetic oligonucleotide siRNA.
ccagagacauguaugauaa

SEQ ID NO: 231 - RNA, 19 nt, Artificial Sequence
  Synthetic oligonucleotide siRNA.
gaacagaaucacugacaua

SEQ ID NO: 232 - RNA, 19 nt, Artificial Sequence
  Synthetic oligonucleotide siRNA.
gaaacuguaugcuggauga

SEQ ID NO: 233 - RNA, 19 nt, Artificial Sequence
  Synthetic oligonucleotide siRNA.
guggagcgcuguugugaau

SEQ ID NO: 234 - RNA, 19 nt, Artificial Sequence
  Synthetic oligonucleotide siRNA.
gacagggaguacuauagug

SEQ ID NO: 235 - RNA, 19 nt, Artificial Sequence
  Synthetic oligonucleotide siRNA.
cgacccaccuucagaguac

SEQ ID NO: 236 - RNA, 19 nt, Artificial Sequence
  Synthetic oligonucleotide siRNA.
uagaggaguuugaguguga

SEQ ID NO: 237 - RNA, 19 nt, Artificial Sequence
  Synthetic oligonucleotide siRNA.
gaagaagccucggcagaua

SEQ ID NO: 238 - RNA, 19 nt, Artificial Sequence
  Synthetic oligonucleotide siRNA.
guaauaaucuccaucaugu

SEQ ID NO: 239 - RNA, 19 nt, Artificial Sequence
  Synthetic oligonucleotide siRNA.
ggaaugaacugaaaguagu

SEQ ID NO: 240 - RNA, 19 nt, Artificial Sequence
  Synthetic oligonucleotide siRNA.
gagauuuccuggacuagaa

SEQ ID NO: 241 - RNA, 19 nt, Artificial Sequence
  Synthetic oligonucleotide siRNA.
ggacaacccuuucgaguuc

SEQ ID NO: 242 - RNA, 19 nt, Artificial Sequence
  Synthetic oligonucleotide siRNA.
ccagugaccucaacaggaa

SEQ ID NO: 243 - RNA, 19 nt, Artificial Sequence
  Synthetic oligonucleotide siRNA.
ccacaauacuucagugaug

SEQ ID NO: 244 - RNA, 19 nt, Artificial Sequence
  Synthetic oligonucleotide siRNA.
gaagaguggucuccguuuc

SEQ ID NO: 245 - RNA, 19 nt, Artificial Sequence
  Synthetic oligonucleotide siRNA.
gaacagaaguaaugaaauc

SEQ ID NO: 246 - RNA, 19 nt, Artificial Sequence
  Synthetic oligonucleotide siRNA.
guaaugcuguuucugcuua

SEQ ID NO: 247 - RNA, 19 nt, Artificial Sequence
  Synthetic oligonucleotide siRNA.
gcaagacacuccaaguuug

SEQ ID NO: 248 - RNA, 19 nt, Artificial Sequence
  Synthetic oligonucleotide siRNA.
gaaagucuaucacauuauc

SEQ ID NO: 249 - RNA, 19 nt, Artificial Sequence
  Synthetic oligonucleotide siRNA.
gagcgaaucugcuagugaa

SEQ ID NO: 250 - RNA, 19 nt, Artificial Sequence
  Synthetic oligonucleotide siRNA.
gaaguucacuacagagagu

SEQ ID NO: 251 - RNA, 19 nt, Artificial Sequence
  Synthetic oligonucleotide siRNA.
ggucgacgguccaaauuug

SEQ ID NO: 252 - RNA, 19 nt, Artificial Sequence
  Synthetic oligonucleotide siRNA.
gaauaucacuuccauacac

SEQ ID NO: 253 - RNA, 19 nt, Artificial Sequence
  Synthetic oligonucleotide siRNA.
gcacgccgcuuccugauau

SEQ ID NO: 254 - RNA, 19 nt, Artificial Sequence
  Synthetic oligonucleotide siRNA.
caucagagcuggaucuaga

SEQ ID NO: 255 - RNA, 19 nt, Artificial Sequence
  Synthetic oligonucleotide siRNA.
ggccuuacuuuauuggauu

SEQ ID NO: 256 - RNA, 19 nt, Artificial Sequence
  Synthetic oligonucleotide siRNA.
gagcuucaccuaucaaguu

SEQ ID NO: 257 - RNA, 19 nt, Artificial Sequence
  Synthetic oligonucleotide siRNA.
gaaaggagacgucaaauau

SEQ ID NO: 258 - RNA, 19 nt, Artificial Sequence
  Synthetic oligonucleotide siRNA.
ggaaugagguggucaacuu

SEQ ID NO: 259 - RNA, 19 nt, Artificial Sequence
  Synthetic oligonucleotide siRNA.
caacgagucuccagugcua

SEQ ID NO: 260 - RNA, 19 nt, Artificial Sequence
  Synthetic oligonucleotide siRNA.
ugacaacgacuauaucauc

SEQ ID NO: 261 - RNA, 19 nt, Artificial Sequence
  Synthetic oligonucleotide siRNA.
gaaguuggguugucuagaa

SEQ ID NO: 262 - RNA, 19 nt, Artificial Sequence
  Synthetic oligonucleotide siRNA.
ggaaauugcuuugaaguug

SEQ ID NO: 263 - RNA, 19 nt, Artificial Sequence
  Synthetic oligonucleotide siRNA.
gguucaagcuggauuauuu

SEQ ID NO: 264 - RNA, 19 nt, Artificial Sequence
  Synthetic oligonucleotide siRNA.
gcgauuauauguuagagau

SEQ ID NO: 265 - RNA, 19 nt, Artificial Sequence
  Synthetic oligonucleotide siRNA.
gaacauggcugaccucaua

SEQ ID NO: 266 - RNA, 19 nt, Artificial Sequence
  Synthetic oligonucleotide siRNA.
ggaccacgcugcucuauuu

SEQ ID NO: 267 - RNA, 19 nt, Artificial Sequence
  Synthetic oligonucleotide siRNA.
ggacgaggacuauuacaaa

SEQ ID NO: 268 - RNA, 19 nt, Artificial Sequence
  Synthetic oligonucleotide siRNA.
gaggaaugcucgcuaccga

SEQ ID NO: 269 - RNA, 19 nt, Artificial Sequence
  Synthetic oligonucleotide siRNA.
gagaaaguccugcccguuu

SEQ ID NO: 270 - RNA, 19 nt, Artificial Sequence
  Synthetic oligonucleotide siRNA.
ugaagaagcugcggcacaa

SEQ ID NO: 271 - RNA, 19 nt, Artificial Sequence
  Synthetic oligonucleotide siRNA.
ccgcgacucugaugagaaa

SEQ ID NO: 272 - RNA, 19 nt, Artificial Sequence
  Synthetic oligonucleotide siRNA.
ugcccgagcuugugaacua

SEQ ID NO: 273 - RNA, 19 nt, Artificial Sequence
  Synthetic oligonucleotide siRNA.
gagcauagugggcuguauu

SEQ ID NO: 274 - RNA, 19 nt, Artificial Sequence
  Synthetic oligonucleotide siRNA.
acacuucguugccacauug

SEQ ID NO: 275 - RNA, 19 nt, Artificial Sequence
  Synthetic oligonucleotide siRNA.
gcgcguaacugccugguca

SEQ ID NO: 276 - RNA, 19 nt, Artificial Sequence
  Synthetic oligonucleotide siRNA.
ccgcagagccacaguguuu

SEQ ID NO: 277 - RNA, 19 nt, Artificial Sequence
  Synthetic oligonucleotide siRNA.
gaagaacuacgacagauua

SEQ ID NO: 278 - RNA, 19 nt, Artificial Sequence
  Synthetic oligonucleotide siRNA.
gaaggagacuauuuagagu

SEQ ID NO: 279 - RNA, 19 nt, Artificial Sequence
  Synthetic oligonucleotide siRNA.
gagcggaugcuguauucua

SEQ ID NO: 280 - RNA, 19 nt, Artificial Sequence
  Synthetic oligonucleotide siRNA.
agaggaauucgaagacuaa

SEQ ID NO: 281 - RNA, 19 nt, Artificial Sequence
  Synthetic oligonucleotide siRNA.
agagagagcuccagcagau

SEQ ID NO: 282 - RNA, 19 nt, Artificial Sequence
  Synthetic oligonucleotide siRNA.
uuaacgaggugaagacaga

SEQ ID NO: 283 - RNA, 19 nt, Artificial Sequence
  Synthetic oligonucleotide siRNA.
acacagagcccacggaugu

SEQ ID NO: 284 - RNA, 19 nt, Artificial Sequence
  Synthetic oligonucleotide siRNA.
gcugggaucaggacuauga

SEQ ID NO: 285 - RNA, 19 nt, Artificial Sequence
  Synthetic oligonucleotide siRNA.
gcaaagaccuggagaagau

SEQ ID NO: 286 - RNA, 19 nt, Artificial Sequence
  Synthetic oligonucleotide siRNA.
gcacacggcugcaugagaa

SEQ ID NO: 287 - RNA, 19 nt, Artificial Sequence
  Synthetic oligonucleotide siRNA.
gaacuggccuggagagagu

SEQ ID NO: 288 - RNA, 19 nt, Artificial Sequence
  Synthetic oligonucleotide siRNA.
uuaaauggauggcaauuga

SEQ ID NO: 289 - RNA, 19 nt, Artificial Sequence
  Synthetic oligonucleotide siRNA.
gcaagcaucuuuacuagga

SEQ ID NO: 290 - RNA, 19 nt, Artificial Sequence
  Synthetic oligonucleotide siRNA.
gagcaaggcuaaagagcua

SEQ ID NO: 291 - RNA, 19 nt, Artificial Sequence
  Synthetic oligonucleotide siRNA.
gagagcaacuucauguaaa

SEQ ID NO: 292 - RNA, 19 nt, Artificial Sequence
  Synthetic oligonucleotide siRNA.
gagaauguccugugucaaa

SEQ ID NO: 293 - RNA, 19 nt, Artificial Sequence
  Synthetic oligonucleotide siRNA.
ggaacucgcugcugccuau

SEQ ID NO: 294 - RNA, 19 nt, Artificial Sequence
  Synthetic oligonucleotide siRNA.
gcaggugccuccucagaug

SEQ ID NO: 295 - RNA, 19 nt, Artificial Sequence
  Synthetic oligonucleotide siRNA.
gcaaugugcuaguguacga

SEQ ID NO: 296 - RNA, 19 nt, Artificial Sequence
  Synthetic oligonucleotide siRNA.
gaagacagaauaugguuca

SEQ ID NO: 297 - RNA, 19 nt, Artificial Sequence
  Synthetic oligonucleotide siRNA.
gaggagaccuucuuacuua

SEQ ID NO: 298 - RNA, 19 nt, Artificial Sequence
  Synthetic oligonucleotide siRNA.
uuacagagguucaggauua

SEQ ID NO: 299 - RNA, 19 nt, Artificial Sequence
  Synthetic oligonucleotide siRNA.
gaacaaaccuaagcaugaa

SEQ ID NO: 300 - RNA, 19 nt, Artificial Sequence
  Synthetic oligonucleotide siRNA.
gaaagagcacuucaaauaa

SEQ ID NO: 301 - RNA, 19 nt, Artificial Sequence
  Synthetic oligonucleotide siRNA.
gaaagaugguuaccgaaua

SEQ ID NO: 302 - RNA, 19 nt, Artificial Sequence
  Synthetic oligonucleotide siRNA.
ucacuacgcucuauccuuu

SEQ ID NO: 303 - RNA, 19 nt, Artificial Sequence
  Synthetic oligonucleotide siRNA.
ggugaaggauauagcaaua

SEQ ID NO: 304 - RNA, 19 nt, Artificial Sequence
  Synthetic oligonucleotide siRNA.
cgaaguccaagguugaaua

SEQ ID NO: 305 - RNA, 19 nt, Artificial Sequence
  Synthetic oligonucleotide siRNA.
gagaaccuggugugcaaag

SEQ ID NO: 306 - RNA, 19 nt, Artificial Sequence
  Synthetic oligonucleotide siRNA.
cguccaagccgcagacuca

SEQ ID NO: 307 - RNA, 19 nt, Artificial Sequence
  Synthetic oligonucleotide siRNA.
ccucaggcauggcguacgu

SEQ ID NO: 308 - RNA, 19 nt, Artificial Sequence
  Synthetic oligonucleotide siRNA.
ccaagggccucaacgugaa

SEQ ID NO: 309 - RNA, 19 nt, Artificial Sequence
  Synthetic oligonucleotide siRNA.
aaugccuugguuccaugga

SEQ ID NO: 310 - RNA, 19 nt, Artificial Sequence
  Synthetic oligonucleotide siRNA.
ggaauaaucucaagaauca

SEQ ID NO: 311 - RNA, 19 nt, Artificial Sequence
  Synthetic oligonucleotide siRNA.
gaacugggcucugguaauu

SEQ ID NO: 312 - RNA, 19 nt, Artificial Sequence
  Synthetic oligonucleotide siRNA.
gaacagacaugucaaggau

SEQ ID NO: 313 - RNA, 19 nt, Artificial Sequence
  Synthetic oligonucleotide siRNA.
caccugaaguguuuaauua

SEQ ID NO: 314 - RNA, 19 nt, Artificial Sequence
  Synthetic oligonucleotide siRNA.
guacaaagucgcaaucaaa

SEQ ID NO: 315 - RNA, 19 nt, Artificial Sequence
  Synthetic oligonucleotide siRNA.
uggaggagauucuuauuaa

SEQ ID NO: 316 - RNA, 19 nt, Artificial Sequence
  Synthetic oligonucleotide siRNA.
guaauuacguaacgggaaa

SEQ ID NO: 317 - RNA, 19 nt, Artificial Sequence
  Synthetic oligonucleotide siRNA.
gaaagaauaugccuccaaa

SEQ ID NO: 318 - RNA, 19 nt, Artificial Sequence
  Synthetic oligonucleotide siRNA.
ugaaguaccugauauucua

SEQ ID NO: 319 - RNA, 19 nt, Artificial Sequence
  Synthetic oligonucleotide siRNA.
cgaaagaccuacgugaaua

SEQ ID NO: 320 - RNA, 19 nt, Artificial Sequence
  Synthetic oligonucleotide siRNA.
gugcagaacucuacgagaa

SEQ ID NO: 321 - RNA, 19 nt, Artificial Sequence
  Synthetic oligonucleotide siRNA.
gagaggagguuuaugugaa

SEQ ID NO: 322 - RNA, 19 nt, Artificial Sequence
  Synthetic oligonucleotide siRNA.
gggacagccucuacccuua

SEQ ID NO: 323 - RNA, 19 nt, Artificial Sequence
  Synthetic oligonucleotide siRNA.
gaaguucugugcaaauugg

SEQ ID NO: 324 - RNA, 19 nt, Artificial Sequence
  Synthetic oligonucleotide siRNA.
caacauggccucagaacug

SEQ ID NO: 325 - RNA, 19 nt, Artificial Sequence
  Synthetic oligonucleotide siRNA.
gaacugggucuacaagauc

SEQ ID NO: 326 - RNA, 19 nt, Artificial Sequence
  Synthetic oligonucleotide siRNA.
cgagagguaucggucauga

SEQ ID NO: 327 - RNA, 19 nt, Artificial Sequence
  Synthetic oligonucleotide siRNA.
ggcgcauccuggagcauua

SEQ ID NO: 328 - RNA, 19 nt, Artificial Sequence
  Synthetic oligonucleotide siRNA.
ggucgcaccuucaaagugg

SEQ ID NO: 329 - RNA, 19 nt, Artificial Sequence
  Synthetic oligonucleotide siRNA.
gaacaucuauugagacaag

SEQ ID NO: 330 - RNA, 19 nt, Artificial Sequence
  Synthetic oligonucleotide siRNA.
ucaaggcacuuuaugauuu

SEQ ID NO: 331 - RNA, 19 nt, Artificial Sequence
  Synthetic oligonucleotide siRNA.
ggagaggaauggcuauauu

SEQ ID NO: 332 - RNA, 19 nt, Artificial Sequence
  Synthetic oligonucleotide siRNA.
ggauauaugugaaggaaug

SEQ ID NO: 333 - RNA, 19 nt, Artificial Sequence
  Synthetic oligonucleotide siRNA.
gaggagauccaccacuuua

SEQ ID NO: 334 - RNA, 19 nt, Artificial Sequence
  Synthetic oligonucleotide siRNA.
gcauccacauugcacauaa

SEQ ID NO: 335 - RNA, 19 nt, Artificial Sequence
  Synthetic oligonucleotide siRNA.
ucaaauaccuagccacacu

SEQ ID NO: 336 - RNA, 19 nt, Artificial Sequence
  Synthetic oligonucleotide siRNA.
caaucuugcugacgucuug

SEQ ID NO: 337 - RNA, 19 nt, Artificial Sequence
  Synthetic oligonucleotide siRNA.
acgcugagauuuacaacua

SEQ ID NO: 338 - RNA, 19 nt, Artificial Sequence
  Synthetic oligonucleotide siRNA.
ggauggcuccuuugugaaa

SEQ ID NO: 339 - RNA, 19 nt, Artificial Sequence
  Synthetic oligonucleotide siRNA.
gagaggaacuacgaagauc

SEQ ID NO: 340 - RNA, 19 nt, Artificial Sequence
  Synthetic oligonucleotide siRNA.
gcgcaucgaggccacauug

SEQ ID NO: 341 - RNA, 19 nt, Artificial Sequence
  Synthetic oligonucleotide siRNA.
gaaggacccugaugaaaga

SEQ ID NO: 342 - RNA, 19 nt, Artificial Sequence
  Synthetic oligonucleotide siRNA.
ucaagaagcucagauaaug

SEQ ID NO: 343 - RNA, 19 nt, Artificial Sequence
  Synthetic oligonucleotide siRNA.
cagaaucccuccaugaauu

SEQ ID NO: 344 - RNA, 19 nt, Artificial Sequence
  Synthetic oligonucleotide siRNA.
gcgacuagagguuaaacua

SEQ ID NO: 345 - RNA, 19 nt, Artificial Sequence
  Synthetic oligonucleotide siRNA.
ggaaagacgugucauauua

SEQ ID NO: 346 - RNA, 19 nt, Artificial Sequence
  Synthetic oligonucleotide siRNA.
gagaauggcucuuuagaua

SEQ ID NO: 347 - RNA, 19 nt, Artificial Sequence
  Synthetic oligonucleotide siRNA.
gaacagccuucaagaaaug

SEQ ID NO: 348 - RNA, 19 nt, Artificial Sequence
  Synthetic oligonucleotide siRNA.
ccagaaacaucuuaaucaa

SEQ ID NO: 349 - RNA, 19 nt, Artificial Sequence
  Synthetic oligonucleotide siRNA.
ucacugaccucgccaagga

SEQ ID NO: 350 - RNA, 19 nt, Artificial Sequence
  Synthetic oligonucleotide siRNA.
gcagaagggacggcucuuu

SEQ ID NO: 351 - RNA, 19 nt, Artificial Sequence
  Synthetic oligonucleotide siRNA.
gcuccaagaucccggucaa

SEQ ID NO: 352 - RNA, 19 nt, Artificial Sequence
  Synthetic oligonucleotide siRNA.
gaucaaggucaucaaguca

SEQ ID NO: 353 - RNA, 19 nt, Artificial Sequence
  Synthetic oligonucleotide siRNA.
gacgacagcuacuacacug

SEQ ID NO: 354 - RNA, 19 nt, Artificial Sequence
  Synthetic oligonucleotide siRNA.
gcaagaagcagaucgacgu

SEQ ID NO: 355 - RNA, 19 nt, Artificial Sequence
  Synthetic oligonucleotide siRNA.
aggcagacacggaagagau

SEQ ID NO: 356 - RNA, 19 nt, Artificial Sequence
  Synthetic oligonucleotide siRNA.
gcgauaaccuccucauagc

SEQ ID NO: 357 - RNA, 19 nt, Artificial Sequence
  Synthetic oligonucleotide siRNA.
guacagagaggacuacuuc

SEQ ID NO: 358 - RNA, 19 nt, Artificial Sequence
  Synthetic oligonucleotide siRNA.
gguacgaggugaugcaguu

SEQ ID NO: 359 - RNA, 19 nt, Artificial Sequence
  Synthetic oligonucleotide siRNA.
ucaguggccucaacgagaa

SEQ ID NO: 360 - RNA, 19 nt, Artificial Sequence
  Synthetic oligonucleotide siRNA.
gcaaguacagagaggacua

SEQ ID NO: 361 - RNA, 19 nt, Artificial Sequence
  Synthetic oligonucleotide siRNA.
gaacagcgagcagaucaaa

SEQ ID NO: 362 - RNA, 19 nt, Artificial Sequence
  Synthetic oligonucleotide siRNA.
agaagacgcccgagaguug

SEQ ID NO: 363 - RNA, 19 nt, Artificial Sequence
  Synthetic oligonucleotide siRNA.
gcaagauggucuccuucca

SEQ ID NO: 364 - RNA, 19 nt, Artificial Sequence
  Synthetic oligonucleotide siRNA.
cgagaugccacgacuauuc

SEQ ID NO: 365 - DNA, 23 bp, Artificial Sequence
  Synthetic oligonucleotide siRNA.
catgaagctgaacaccgagatcc

SEQ ID NO: 366 - DNA, 21 bp, Artificial Sequence
  Synthetic oligonucleotide siRNA.
acacaggagcctcgaacttcc

SEQ ID NO: 367 - DNA, 20 bp, Artificial Sequence
  Synthetic oligonucleotide siRNA.
agcgatgtccttaccacacc

SEQ ID NO: 368 - DNA, 20 bp, Artificial Sequence
  Synthetic oligonucleotide siRNA.
cctcaacacactcaggagca

SEQ ID NO: 369 - DNA, 20 bp, Artificial Sequence
  Synthetic oligonucleotide siRNA.
atctggtatccacccaacca

SEQ ID NO: 370 - DNA, 22 bp, Artificial Sequence
  Synthetic oligonucleotide siRNA.
ctgttgctgccactgcaatacc

SEQ ID NO: 371 - DNA, 20 bp, Artificial Sequence
  Synthetic oligonucleotide siRNA.
agtccaacctgatcgtggtc

SEQ ID NO: 372 - DNA, 21 bp, Artificial Sequence
  Synthetic oligonucleotide siRNA.
tggcatccatgaccttcagca

SEQ ID NO: 373 - DNA, 20 bp, Artificial Sequence
  Synthetic oligonucleotide siRNA.
accaaggtggctgtgaaaac

SEQ ID NO: 374 - DNA, 20 bp, Artificial Sequence
  Synthetic oligonucleotide siRNA.
accttcatcgctcttcagga

SEQ ID NO: 375 - DNA, 22 bp, Artificial Sequence
  Synthetic oligonucleotide siRNA.
ctggtgcaatggagcgagtatt

SEQ ID NO: 376 - DNA, 20 bp, Artificial Sequence
  Synthetic oligonucleotide siRNA.
agccagtgaacctcctctga

SEQ ID NO: 377 - DNA, 20 bp, Artificial Sequence
  Synthetic oligonucleotide siRNA.
acaggaccacgctgctctat

SEQ ID NO: 378 - DNA, 20 bp, Artificial Sequence
  Synthetic oligonucleotide siRNA.
gccccacttccttttctagg

SEQ ID NO: 379 - DNA, 20 bp, Artificial Sequence
  Synthetic oligonucleotide siRNA.
gcgtgtgctcctctccttac

SEQ ID NO: 380 - DNA, 20 bp, Artificial Sequence
  Synthetic oligonucleotide siRNA.
ccaagctgaactgggaagag

SEQ ID NO: 381 - DNA, 20 bp, Artificial Sequence
  Synthetic oligonucleotide siRNA.
cccaaggattcagctcgtta

SEQ ID NO: 382 - DNA, 20 bp, Artificial Sequence
  Synthetic oligonucleotide siRNA.
gcagtcaactcatccccatt

SEQ ID NO: 383 - DNA, 20 bp, Artificial Sequence
  Synthetic oligonucleotide siRNA.
aggcatcatggaaagactgg

SEQ ID NO: 384 - DNA, 20 bp, Artificial Sequence
  Synthetic oligonucleotide siRNA.
gctggctctgaaggtcaaac

SEQ ID NO: 385 - protein, 6 aa, Homo sapiens
EYYTVK

SEQ ID NO: 386 - DNA, 24 bp, Artificial Sequence
  Synthetic oligonucleotide primer.
caccacacagtggcggagaagatg

SEQ ID NO: 387 - DNA, 20 bp, Artificial Sequence
  Synthetic oligonucleotide primer.
gcctaattgtgagggcagac

SEQ ID NO: 388 - DNA, 20 bp, Artificial Sequence
  Synthetic oligonucleotide primer.
caggactacagaccccacag

SEQ ID NO: 389 - DNA, 19 bp, Artificial Sequence
  Synthetic oligonucleotide primer.
agcctgcctgtggagaaag

SEQ ID NO: 390 - DNA, 24 bp, Homo sapiens
tacctaccactaagctattggcac

SEQ ID NO: 391 - protein, 8 aa, Homo sapiens
YLPLSYWQ

SEQ ID NO: 392 - DNA, 24 bp, Homo sapiens
tacctaccactggaagctattggc

SEQ ID NO: 393 - protein, 9 aa, Homo sapiens
YLPLSYWQP

SEQ ID NO: 394 - protein, 57 aa, Homo sapiens
YLPLEAIGSSLEDRLLTPSSLDRAKLSRLLCELPYPTPTTQAPQATSPPSPSVCPHN

SEQ ID NO: 395 - protein, 8 aa, Homo sapiens
YLPLEAIG

(19) United States
(12) Patent Application Publication
(10) Pub. No.: US 2009/0312194 A1
(43) Pub. Date: Dec. 17, 2009

(54) SELECTION OF PERSONALIZED CANCER THERAPY REGIMENS USING INTERFERING RNA FUNCTIONAL SCREENING

(75) Inventors: JEFFREY W. TYNER, PORTLAND, OR (US); BRIAN J. DRUKER, PORTLAND, OR (US); MARC LORIAUX, PORTLAND, OR (US); MARY V. LUTTROPP, GRESHAM, OR (US)

Correspondence Address: KLARQUIST SPARKMAN, LLP, 121 SW SALMON STREET, SUITE 1600, PORTLAND, OR, 97204, US

(73) Assignee: OREGON HEALTH & SCIENCE UNIVERSITY

(21) Appl. No.: 12/271,629

(22) Filed: Nov. 14, 2008

Related U.S. Application Data
(60) Provisional application No. 61/061,426, filed on Jun. 13, 2008.

(51) Int. Cl. C40B 30/06

(52) U.S. Cl. 506/10

(57) ABSTRACT

Methods for screening cells obtained from a subject for aberrant kinase activity are disclosed. The methods include placing cells isolated from the subject in contact with a set of siRNAs, wherein each individual siRNA is at an addressable location on the array and specifically inhibits expression of a tyrosine kinase. The siRNA is introduced into the blood cells or bone marrow cells by electroporation. After introduction of the siRNA, the cells are then assayed for proliferation and/or viability as compared to a control. A decreased proliferation and/or viability of the cells as compared to a control identifies a siRNA that inhibits the proliferation and/or viability of the cells, thus identifying the tyrosine kinase having aberrant tyrosine kinase activity in the subject.

### CROSS REFERENCE TO RELATED APPLICATION

This application claims the benefit of U.S. Provisional Application No. 61/061,426, filed Jun. 13, 2008, which is incorporated by reference herein in its entirety.

### ACKNOWLEDGMENT OF GOVERNMENT SUPPORT

This invention was made with government support under grant no. CA101690 awarded by the National Institutes of Health. The government has certain rights in the invention.

### FIELD

This application relates to the field of cancer, specifically to methods of diagnosing cancer and selecting a cancer therapy.

### BACKGROUND

Cancer therapy that is targeted to the causative genetic abnormality has achieved superior clinical outcomes compared with conventional chemotherapeutic approaches. Broad application of this strategy will require a fast diagnosis of the principal molecular targets involved in cancer pathogenesis in each individual patient. Tyrosine kinases constitute a gene family, widely implicated in cancer pathogenesis that plays an integral role in numerous cellular processes as diverse as proliferation, apoptosis, differentiation, and cell motility.

Aberrant regulation of tyrosine kinases has been found in numerous hematologic malignancies. For example, chronic myeloid leukemia (CML) is caused by the 9:22 chromosomal translocation, resulting in the BCR-ABL fusion gene. A related disease, chronic myelomonocytic leukemia (CMML), has been shown to contain activating mutations in KIT, Janus Kinase 2 (JAK2), Platelet Derived Growth Factor Receptor (PDGFR), Fibroblast Growth Factor Receptor 1 (FGFR1), and Colony Stimulating Factor 1 Receptor (CSF1R) in 15-30% of patients, collectively. One of these mutant alleles found in CMML (JAK2^{V617F}) also contributes to the pathogenesis of a large proportion of myeloproliferative disorders including polycythemia vera, primary myelofibrosis, and essential thrombocythemia.

Approximately 70% of patients with acute myeloid leukemia (AML), blast cells exhibit phosphorylation of Signal Transducer and Activator of Transcription 5 (STAT5), a marker for tyrosine kinase activity. Known tyrosine kinase mutations, such as FMS-Like Tyrosine Kinase 3 (FLT3)-Internal Tandem Duplication (ITD) and point mutations or gene rearrangements of FLT3, K1T, PDGFR, JAK2, and JAK3 are detected in only 35% of AML cases, suggesting that unidentified mechanisms of tyrosine kinase dysregulation may be operational in the remainder of the cases. Thus, the need exist for methods of determining which tyrosine kinases are responsible for malignant transformation of cancer cells that are associated with dysregulated tyrosine kinase activity.

### SUMMARY

The recent success of monoclonal antibodies and small-molecule inhibitors of tyrosine kinases in numerous malignancies has highlighted the potential of targeted therapy for the treatment of cancer. However, broad application of this strategy involves a detailed understanding of the principal genetic targets involved in cancer pathogenesis in each individual patient. In humans, the known tyrosine kinases constitute a gene family of 91 members that have an integral role in signal transduction of mammalian cells, including critical cellular processes as diverse as proliferation, apoptosis, differentiation, and cell motility. Aberrant regulation of any of these processes may contribute to oncogenesis, and dysregulation of tyrosine kinase activity has been observed in numerous types of malignancy.

Methods are disclosed herein for screening for aberrant tyrosine kinase activity in cells, such as cancer cells, obtained from a subject, for example a subject selected with a hematological malignancy. These methods utilize individual repression of the human tyrosine kinases with inhibitory RNAs. Inhibitory RNA technology allows functional data to be obtained by selectively reducing the expression of individual tyrosine kinases, thus allowing the role of those tyrosine kinases for cancer cell viability to be assessed. A rapid screen is disclosed that can identify tyrosine kinase genes that are involved in cancer cell growth and viability regardless of their mutational status. These genes can subsequently form the basis for targeted, therapeutic intervention.

The disclosed methods include placing cells, such as white blood cells and/or bone marrow cells, isolated from a subject, such as a subject selected by virtue of being diagnosed with a hematological malignancy, in contact with a set of inhibitory RNAs that are arranged in an array, wherein the cells be identified at positions in the array. Each individual inhibitory RNA is at an addressable location on the array and specifically inhibits expression of a tyrosine kinase. The inhibitory RNA is introduced into the white blood cells or bone marrow cells by electroporation. After introduction of the inhibitory RNA, the cells are then assayed for proliferation and/or cell viability as compared to a control. A decrease in the proliferation and/or a decrease in the viability of the cells as compared to a control identifies an inhibitory RNA that inhibits the proliferation and/or viability of the cells. Thus, the tyrosine kinase targeted by the inhibitory RNA is identified as having aberrant tyrosine kinase activity in the subject. The tyrosine kinase identified as having aberrant tyrosine kinase activity and/or the pathway in which the identified tyrosine kinase acts can be a target for therapeutic intervention. This assay can be conducted in a high throughput manner. In some embodiments, a therapy is selected that targets the tyrosine kinase identified as having aberrant tyrosine kinase activity and/or the pathway in which the identified tyrosine kinase acts. In some embodiments, the selected therapy is administered to the subject.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exemplary schematic representation of an RNAi functional profiling assay. Cells were transformed by electroporation with siRNAs individually targeting each member of the tyrosine kinase family as well as N-RAS, K-RAS and two controls (CTRL). Cells were plated into culture media and subjected to a 3-(4,5-dimethylthiazol-2-yl)-5-(3-carboxymethoxyphenyl)-2-(4-sulfophenyl)-2H-tetrazolium (MTS) assay four days post-electroporation for the determination of cell viability and proliferation. All absorbance values were normalized to the absorbance values of two non-specific control siRNA molecules.

FIG. 2A-2B is a set of graphs and digital images of Western blots showing the optimization of siRNA electroporation in CMK cells. FIG. 2A is a graph of flow cytometry data showing the results of CMK cells that were incubated with a fluorescein isothiocyanate (FITC)-labeled siRNA molecule and left untreated or electroporated at 300 V, 100 μsec, 2 pulses. After 48 hours, cells were analyzed for FITC incorporation by flow cytometry. FIG. 2B is a bar graph showing cell viability of CMK cells treated described as in FIG. 2A and then stained with propidium iodide. Viability as measured by PI exclusion was determined by flow cytometry on a GUAVA TECHNOLOGIES® flow cytometer. FIG. 2C is a digital image of Western blots of CMK cells that were incubated with 0, 500, or 1000 nM siRNA targeting glyceraldehyde 3-phosphate dehydrogenase (GAPDH) and electroporated as is described in FIG. 2A. After 48 hours, cell lysates were subjected to immunoblot analysis for GAPDH and β-actin.

FIG. 3 is a bar graph showing the effect siRNAs targeting the 91 known human tyrosine kinases have on CMK cells. CMK cells (105) were suspended in SIPORT® buffer and incubated with 1 μM siRNA from a siRNA library individually targeting each member of the tyrosine kinase family as well as N-RAS, K-RAS, and single and pooled non-specific siRNA controls. Cells were electroporated on a 96-well electroporation plate at 2220 V (equivalent of 300 V), 100 μsec, 2 pulses. Cells were replated into culture media and cell viability and proliferation was determined by an MTS assay at day four post-electroporation. Values represent percent mean (normalized to non-specific control wells)±standard error in the mean (s.e.m) (n=3).

FIG. 4 is a bar graph showing the effect siRNAs targeting the 91 known human tyrosine kinases have on HMC1.1 cells. HMC1.1 cells (10⁵) were suspended in SIPORT® buffer and incubated with 1 μM siRNA from a siRNA library individually targeting each member of the tyrosine kinase family as well as N-RAS, K-RAS, and single and pooled non-specific siRNA controls. Cells were electroporated on a 96-well electroporation plate at 2220 V (equivalent of 300 V), 100 μsec, 2 pulses. Cells were replated in culture media and cell viability and proliferation was determined by an MTS assay at day four post-electroporation. Values represent percent mean (normalized to non-specific control wells)±s.e.m (n=3).

FIG. 5A-5B is a set of graphs showing that HMC1.1 cells are sensitive to inhibitors targeting JAK1, JAK3, and SRC. FIG. 5A is a graph showing that HMC1.1 and K562 control cells that were treated with increasing concentrations of the SRC family inhibitor PP2 exhibit a decrease in proliferation as a function of PP2 concentration. Seventy-two hours after contact with PP2 cells were subjected to an MTS assay for determination of total viable cells. Values represent the mean±s.e.m. (n=3). FIG. 5B is a graph showing that HMC1.1 but not K562 control cells treated with increasing concentrations of the pan-JAK inhibitor, JAK inhibitor I, alone or in combination with 1.5 μM PP2 decrease in proliferation in a dose dependent manner. Seventy-two hours after contact with the indicated inhibitors, cells were subjected to an MTS assay for determination of total viable cells. Values represent the mean±s.e.m. (n=3).

FIG. 6A-6B is a set of digital images of Western blots and bar graphs showing that RNAi targeting in HMC1.1 cells leads to effective knockdown of expression of the indicated genes. HMC1.1 cells were treated with siRNA targeting JAK1, JAK2, JAK3, Protein Tyrosine Kinase 2 (PTK2), PTK2B, PTK6, PTK9, Ephrin Receptor A4 (EPHA4), Leukocyte Tyrosine Kinase (LTK), LYN, SRC, or c-KIT and electroporated as described for FIG. 4. Forty-eight hours later, cell lysates or total RNA were harvested and subjected to (FIG. 6A) immunoblot or (FIG. 6B) quantitative PCR analysis for each targeted gene as well as β-actin or GAPDH as a loading control. Densitometric or qPCR values were normalized to their respective loading controls and percent knockdown was calculated. For determination of reciprocal off-target effects by SRC and LYN siRNA, HMC1.1 cells were transfected with SRC and LYN siRNA and immunoblotted with antibodies specific for both SRC and LYN.

FIG. 7A-7C is a set of graphs showing that HMC1.1 cells are sensitive to inhibitors targeting JAK3 and SRC. FIG. 7A is a graph showing a decrease in proliferation of HMC1.1 and K562 control cells treated with increasing concentrations of the SRC family inhibitor, SRC kinase inhibitor I. Seventy-two hours after contact with the inhibitor cells were subjected to an MTS assay for determination of total viable cells. Values represent the mean±s.e.m. (n=3). FIG. 7B is a graph showing a decrease in proliferation of HMC1.1 and K562 control cells treated with increasing concentrations of the JAK3-specific inhibitor, JAK3 inhibitor III. Seventy-two hours after contact with inhibitor, the cells were subjected to an MTS assay for determination of total viable cells. Values represent the mean±s.e.m. (n=3). FIG. 7C is a graph showing a decrease in proliferation of HMC1.1 and HEL control cells were treated with increasing concentrations of the JAK2-specific inhibitor, AG-490. Seventy-two hours after contact with the inhibitor, the cells were subjected to an MTS assay for determination of total viable cells. Values represent the mean±s.e.m. (n=6).

FIG. 8 is a table showing the CMK cell viability after siRNA knockdown of individual members of each tyrosine kinase as well as N-RAS and K-RAS. “GENE” refers to siRNA target, “VIABILITY” values represent percent mean (normalized to non-specific siRNA control wells), “S.E.” refers to standard error of the mean, “T-TEST 1” refers to p-value of t-test between individual gene viability and single non-specific siRNA viability, “T-TEST 2” refers to p-value of t-test between individual gene viability and pooled non-specific siRNA viability, and “AVG. OF T-TEST” refers to mean of T-TEST 1 and T-TEST 2 values.

FIG. 9 is a table showing the HMC1.1 cell viability after siRNA knockdown of individual members of each tyrosine kinase as well as N-RAS and K-RAS. “GENE” refers to siRNA target, “VIABILITY” values represent percent mean (normalized to non-specific siRNA control wells), “S.E.” refers to standard error of the mean, “T-TEST 1” refers to p-value of t-test between individual gene viability and single non-specific siRNA viability, “T-TEST 2” refers to p-value of t-test between individual gene viability and pooled non-specific siRNA viability, and “AVG. OF T-TEST” refers to mean of T-TEST 1 and T-TEST 2 values.

FIG. 10 is a table showing information about the status of the patients shown in Examples 6-9.

FIG. 11A-12C is a set of bar graphs confirming that the results of the siRNA using small-molecule inhibitors of tyrosine kinases. FIG. 11A is a bar graph showing the dose dependent response of cells obtained from patient 07-278 that were treated with a dose curve of imatinib and plated in a 96-well plate. After three days, cell viability was measured with an MTS assay. Values represent the percent mean (normalized to untreated control wells)±s.e.m (n=3). FIG. 11B is a bar graph showing the dose dependent response of cells obtained from patient 07-008 that were plated in methocult containing Interleukin-3 (IL-3), Granulocyte Monocyte Colony Stimulating Factor (GM-CSF), and Stem Cell Factor (SCF) as well as a dose gradient of SU11248 or PTK787. After ten days, colonies were counted using an automated colony counter. Values represent the percent mean (normalized to untreated control plates)±s.e.m (n=3). FIG. 11C is a bar graph showing the dose dependent response of cells obtained from patient 07-079 that were treated with a dose curve of AG490 and plated in a 96-well plate or in methocult containing IL-3, GM-CSF, and SCF. After three days, cell viability was measured with an MTS assay. Alternatively, colonies were counted after ten days. Values represent percent mean (normalized to untreated controls)±s.e.m (n=3). * p<0.05.

FIG. 12 is a bar graph showing siRNA functional profiling of a patient with aggressive systemic mastocytosis (ASM) with associated chronic myelomonocytic leukemia (CMML). Blood cells (2.25×10⁷) were suspended in SIPORT® buffer and incubated with 1 μM siRNA from a siRNA library individually targeting each member of the tyrosine kinase family as well as N-RAS, K-RAS, and single and pooled non-specific siRNA controls. Cells were electroporated on a 96-well electroporation plate at 1110 V (equivalent of 150 V), 200 μsec, 2 pulses. Cells were replated into culture media and cell viability was determined by an MTS assay at day 4 post-electroporation. Values represent the percent mean (normalized to the median value on the plate)±s.e.m (n=3).

FIG. 13A-13C is a digital image of a sequencing trace, a sequence alignment and a digital image of a Western blot demonstrating the identification of a novel Thrombopoietin Receptor (MPL) mutation in a patient with ASM with associated CMML. FIG. 13A is a digital image of a sequencing trace of MPL sequenced from genomic DNA obtained from Patient 07-079 showing a two base-pair insertion (1886InsGG) in exon 12 (SEQ ID NO: 390-392). Exon 12 PCR products were cloned and individual clones confirmed equal abundance of exon 12 WT and 1886InsGG in Patient 07-079. FIG. 13B is a sequence alignment of the hypothetical translation of the carboxy terminus of resultant proteins from MPL^{WT} (SEQ ID NO: 393) and MPL^{1886InsGG} (SEQ ID NO: 394). FIG. 13C is a digital image of a Western blot showing MPL^{WT} and MPL^{1886InsGG} transiently expressed in 293 T17 cells and whole cell lysates and subjected to immunoblot analysis with a MPL-specific antibody.

FIG. 14A-14C is a set of graphs and digital images of Western blots showing that MPL^{1886InsGG} is hypersensitive to thrombopoietin (TPO). FIG. 14A is a graph showing the viability of parental BA/F3 cells or those stably expressing MPL WT, 1886InsGG, or the point mutation W515L that were plated in a dose gradient of thrombopoietin. After three days, cell proliferation was assessed using an MTS assay. Values represent percent mean (normalized to 10 ng/ml TPO wells)±s.e.m (n=6). * p<0.05. FIG. 14B is set of digital images of Western blots showing parental BA/F3 cells or those stably expressing MPL WT, 1886InsGG, or W515L that were serum starved overnight and stimulated for 15 minutes with 0-10 ng/ml thrombopoietin. Whole cell lysates were subjected to immunoblotting with antibodies specific for total or phospho-STAT5 as well as β-actin. FIG. 14C is a graph showing viability of parental BA/F3 cells or those stably expressing MPL WT, 1886InsGG, or W515L that were plated in WEHI-free media. Total viable cells were counted daily for one week. Values represent the mean viable cells±s.e.m (n=3). * p<0.05.

FIG. 15A-15C is a set of graphs and digital images of Western blots showing that midostaurin is effective against JAK2-dependent hematologic malignancies. FIG. 15A is a graph showing the blood counts of patient 07-079 after treatment with midostaurin (50 mg bid), briefly in combination with hydroxyurea. White blood cell counts were monitored over 9 days. Normal white blood cell counts range from 4−12×10³ per ml. FIG. 15B is a set of digital images of Western from BA/F3 cells expressing MPL 1886InsGG that were serum-starved overnight and incubated for 1 hour in 0-1000 nM midostaurin. Cells were then stimulated for 15 minutes with thrombopoietin (10 ng/ml) and cell lysates were subjected to immunoblot analysis for phospho or total-JAK2 as well as β-actin. FIG. 15C is a set of graphs of cell viability data from HEL cells or BA/F3 cells expressing MPL 1886InsGG or W515L that were treated with a dose gradient of AG490 or midostaurin. Cell proliferation was determined after three days. Values represent the percent mean (normalized to untreated control wells)±s.e.m. (n=3).

FIG. 16 is a set of digital images of Western blots showing that MPL^{1886InsGG} is hypersensitive to thrombopoietin. Parental BA/F3 cells or those stably expressing MPL WT, 1886InsGG, or W515L were serum starved overnight and stimulated for 15 minutes with 0-10 ng/ml thrombopoietin. Whole cell lysates were subjected to immunoblotting with antibodies specific for total or phospho-JAK2, STAT3, AKT, and ERK.

FIG. 17 is a set of digital images of Western blots showing that MPL^{1886InsGG} is constitutively active. Factor-independent BA/F3 cells expressing MPL 1886InsGG or W515L as well as parental BA/F3 cells or those stably expressing MPL WT were serum starved overnight. Whole cell lysates were subjected to immunoblotting with antibodies specific for total or phospho-JAK2, STAT5, STAT3, Protein Kinase B (AKT), and ERK as well as b-actin.

FIG. 18 is a set of digital images of Western blots showing that midostaurin blocks thrombopoietin signaling. BA/F3 cells expressing MPL 1886InsGG were serum-starved overnight and incubated for 1 hour in 0-1000 nM midostaurin. Cells were then stimulated for 15 minutes with thrombopoietin (10 ng/ml) and cell lysates were subjected to immunoblot analysis for phospho or total-STAT5, STAT3, AKT, and ERK as well as β-actin.

FIG. 19 is a table showing the viability after siRNA knockdown of individual members of each tyrosine kinase as well as N-RAS and K-RAS. “GENE” refers to siRNA target, “VIABILITY” values represent percent mean (normalized to non-specific siRNA control wells), “S.E.” refers to standard error of the mean, “T-TEST 1” refers to p-value of t-test between individual gene viability and single non-specific siRNA viability, “T-TEST 2” refers to p-value of t-test between individual gene viability and pooled non-specific siRNA viability, and “AVG. OF T-TEST” refers to mean of T-TEST 1 and T-TEST 2 values.

### SEQUENCE LISTING

The nucleic and amino acid sequences listed in the accompanying sequence listing are shown using standard letter abbreviations for nucleotide bases. Only one strand of each nucleic acid sequence is shown, but the complementary strand is understood as included by any reference to the displayed strand.

SEQ ID NOs: 1-364 are exemplary nucleic acid sequences of siRNAs for 91 human tyrosine kinases.

SEQ ID NO: 365-384 are exemplary nucleic acid sequences of rtPCR primers.

SEQ ID NO: 385 amino acid sequence of the JAK1 activation loop phosphorylation site.

SEQ ID NO: 386-389 are exemplary nucleic acid sequences of PCR primers.

### DETAILED DESCRIPTION

Unless otherwise noted, technical terms are used according to conventional usage. Definitions of common terms in molecular biology can be found in Benjamin Lewin, Genes VII, published by Oxford University Press, 1999; Kendrew et al. (eds.), The Encyclopedia of Molecular Biology, published by Blackwell Science Ltd., 1994; and Robert A. Meyers (ed.), Molecular Biology and Biotechnology: a Comprehensive Desk Reference, published by VCH Publishers, Inc., 1995; and other similar references.

As used herein, the singular forms “a,” “an,” and “the,” refer to both the singular as well as plural, unless the context clearly indicates otherwise. For example, the term “a siRNA” includes single or plural siRNAs and can be considered equivalent to the phrase “at least one siRNA.”

As used herein, the term “comprises” means “includes.” Thus, “comprising a siRNA” means “including a siRNA” without excluding other elements.

Although many methods and materials similar or equivalent to those described herein can be used, particular suitable methods and materials are described below. In case of conflict, the present specification, including explanations of terms, will control. In addition, the materials, methods, and examples are illustrative only and not intended to be limiting.

To facilitate review of the various embodiments of the invention, the following explanations of terms are provided:

### I. Terms

Aberrant activity of a tyrosine kinase: Inappropriate or uncontrolled activation of a tyrosine kinase, for example by over-expression, upstream activation (for example, by upstream activation of a protein that affect a tyrosine kinase), and/or mutation (for example a truncation, deletion, insertion and/translocation which increases the activity, such as but not limited to, kinase activity of a tyrosine kinase), which can lead to uncontrolled cell growth, for example in cancer. In some examples, aberrant activity of a tyrosine kinase is an increase in kinase activity of the tyrosine kinase. In some examples, aberrant activity of a tyrosine kinase is a decrease in kinase activity of the tyrosine kinase. Other examples of aberrant activity of a tyrosine kinase include, but are not limited to, mislocalization of the tyrosine kinase, for example mislocalization in an organelle of a cell or mislocalization at the cell membrane.

Antibody: A polypeptide ligand comprising at least a light chain and/or heavy chain immunoglobulin variable region, which specifically recognizes and binds an epitope of an antigen. Antibodies are composed of a heavy and a light chain, each of which has a variable region, termed the variable heavy (VH) region and the variable light (VL) region. Together, the VH region and the VL region are responsible for binding the antigen recognized by the antibody. This includes intact immunoglobulins and the variants and portions of them well known in the art, such as Fab′ fragments, F(ab)′2 fragments, single chain Fv proteins (“scFv”), and disulfide stabilized Fv proteins (“dsFv”). The term also includes recombinant forms such as chimeric antibodies (for example, humanized murine antibodies), heteroconjugate antibodies (such as, bispecific antibodies). See also, Pierce Catalog and Handbook, 1994-1995 (Pierce Chemical Co., Rockford, Ill.); Kuby, Immunology, 3rd Ed., W.H. Freeman & Co., New York, 1997.

A “monoclonal antibody” is an antibody produced by a single clone of B-lymphocytes or by a cell into which the light and heavy chain genes of a single antibody have been transfected. Monoclonal antibodies are produced by methods known to those of skill in the art, for instance by making hybrid antibody-forming cells from a fusion of myeloma cells with immune spleen cells. These fused cells and their progeny are termed “hybridomas.” Monoclonal antibodies include humanized monoclonal antibodies. In some examples an antibody, is an antibody that specifically binds a tyrosine kinase, such as a tyrosine kinase identified as one with aberrant activity in a subject using the methods described herein.

Anti-proliferative activity: An activity of a molecule, for example an inhibitory RNA, such as a siRNA, which reduces proliferation of at least one cell type, but which may reduce the proliferation (either in absolute terms or in rate terms) of multiple different cell types (e.g., different cell lines, different species, etc.). In specific embodiments, anti-proliferative activity of an inhibitory RNA, such as a siRNA will be apparent against white blood cells or bone marrow cells obtained from a subject diagnosed with a hematological malignancy, for example using the methods disclosed herein.

Array: An arrangement of molecules, such as biological macromolecules (such as peptides or nucleic acid molecule, for example inhibitory RNAs, such as siRNAs, that inhibit the expression of tyrosine kinases, such as a human tyrosine kinases, for example the tyrosine kinases set forth in Table 1) or biological samples (such as samples obtained from a subject, such as blood or blood fractions obtained from a subject, such as a human subject), in addressable locations on or in a substrate, for example a solid substrate, such as a microtiter plate, for example a 96 well plate or a 386 well plate. Arrays are sometimes called inhibitory RNA arrays or siRNA arrays.

The array of molecules (“features”) makes it possible to carry out a very large number of analyses on a sample at one time. In certain example arrays, one or more molecules (such as 1, 2, 3, 4, or even more siRNAs) will occur on the array a plurality of times (such as twice), for instance to provide internal controls. The number of addressable locations on the array can vary, for example from at least 2, to at least 10,000, such as at least 2, at least 5, ant least 10, at least 15, at least 20, at least 30, at least 50, at least 75, at least 100, at least 150, at least 200, at least 300, at least 500, least 550, at least 600, at least 800, at least 1000, at least 10,000, or more. In particular examples, an array includes 2-100 addressable locations, such as 2-50 addressable, 10-50 addressable locations, 20-60 addressable locations, 30-70 addressable locations, 40-80 addressable locations, 50-90 addressable locations, 60-100 addressable locations, for example 91 addressable locations. In particular examples, an array contains a set of inhibitory RNAs, such as siRNAs (such as those inhibit the expression of tyrosine kinases, such as human tyrosine kinases). In particular examples, an array is a multiwell plate, such as a 96 well plate or a 384 well plate.

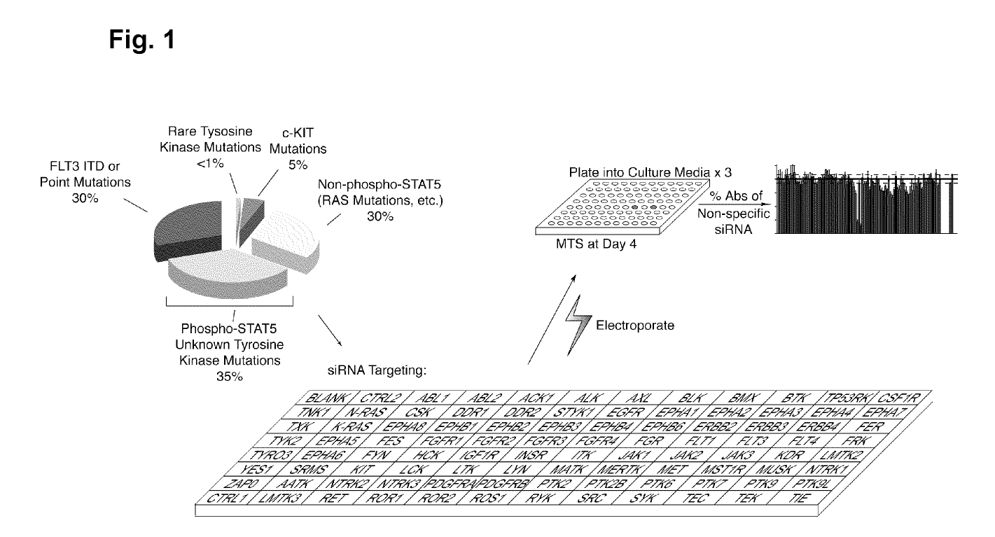

Within an array, each arrayed sample is addressable, in that its location can be reliably and consistently determined within at least two dimensions of the array. The feature application location on an array can assume different shapes. For example, the array can be regular (such as arranged in uniform rows and columns) or irregular. Thus, in ordered arrays the location of each sample is assigned to the sample at the time when it is applied to the array, and a key may be provided in order to correlate each location with the appropriate target or feature position (see for example FIG. 1). Often, ordered arrays are arranged in a symmetrical grid pattern, but samples could be arranged in other patterns (such as in radially distributed lines, spiral lines, or ordered clusters). Addressable arrays usually are computer readable, in that a computer can be programmed to correlate a particular address on the array with information about the sample at that position (such as cell growth, for example based on the presence of signal or signal intensity). In some examples of computer readable formats, the individual features in the array are arranged regularly, for instance in a Cartesian grid pattern, which can be correlated to address information by a computer.

Biological signaling pathway: A systems of proteins, such as tyrosine kinases, and other molecules that act in an orchestrated fashion to mediate the response of a cell toward internal and external signals. In some examples, biological signaling pathways include tyrosine kinase proteins, which can propagate signals in the pathway by selectively phosphorylating downstream substrates. In some examples, a biological signaling pathway is dysregulated and functions improperly, which can lead to aberrant signaling and in some instances hyper-proliferation of the cells with the aberrant signaling. In some examples, dysregulation of a biological signaling pathway can result in a malignancy, such as a hematological malignancy. Using the methods disclosed herein dysregulated biological signaling pathways that contain tyrosine kinases can be identified by virtue of aberrant signaling of the tyrosine kinase(s) in the signaling pathway.

Cell proliferation: The ability of cells to multiply, for example through rounds of cell division. There are various methods of determining cell proliferation known to those of skill in the art and non-limiting examples of such methods are described in section C.

Cancer: Malignant neoplasm that has undergone characteristic anaplasia with loss of differentiation, increase rate of growth, invasion of surrounding tissue, and is capable of metastasis.

Examples of hematological malignancies include leukemias, including acute leukemias (such as acute lymphocytic leukemia (ALL), acute myelocytic leukemia (AML) acute myelogenous leukemia and myeloblastic, promyelocytic, myelomonocytic (CMML), monocytic and erythroleukemia), chronic leukemias (such as chronic myelocytic (granulocytic) leukemia, chronic myelogenous leukemia (CML), chronic lymphocytic leukemia (CLL), chronic neutrophilic leukemia (CNL) and chronic myelomonocytic leukemia (CMML)), polycythemia vera, lymphoma, Hodgkin's disease, non-Hodgkin's lymphoma (indolent and high grade forms), multiple myeloma, Waldenstrom's macroglobulinemia, heavy chain disease, myelodysplastic syndrome, hairy cell leukemia, primary myelofibrosis, and myelodysplasia. Particular hematological malignancies associated with aberrant tyrosine kinase activity are CML, primary myelofibrosis, ALL, CNL, CMML and AML.

Chemotherapeutic agents: Any therapeutic agent with therapeutic usefulness in the treatment of diseases characterized by abnormal cell growth. Such diseases include tumors, neoplasms, and cancer as well as diseases characterized by hyperplastic growth such as psoriasis. In one embodiment, a chemotherapeutic agent is an agent of use in treating a hematological malignancy, for example a small molecule inhibitor of a tyrosine kinase or an antibody that specifically binds a tyrosine kinase. In one embodiment, a chemotherapeutic agent is a radioactive compound. The term chemotherapeutic agent also encompasses antibodies and other biological molecules such as nucleic acid and polypeptides with therapeutic usefulness in the treatment of diseases characterized by abnormal cell growth. One of skill in the art can readily identify a chemotherapeutic agent of use (see for example, Slapak and Kufe, Principles of Cancer Therapy, Chapter 86 in Harrison's Principles of Internal Medicine, 14th edition; Perry et al., Chemotherapy, Ch. 17 in Abeloff, Clinical Oncology 2nd ed., 2000 Churchill Livingstone, Inc; Baltzer and Berkery. (eds): Oncology Pocket Guide to Chemotherapy, 2nd ed. St. Louis, Mosby-Year Book, 1995; Fischer Knobf, and Durivage (eds): The Cancer Chemotherapy Handbook, 4th ed. St. Louis, Mosby-Year Book, 1993). Combination chemotherapy is the administration of more than one agent to treat cancer.

Complementary: A double-stranded DNA or RNA strand consists of two complementary strands of base pairs. Since there is one complementary base for each base found in DNA/RNA (such as A/T, and C/G), the complementary strand for any single strand can be determined. In some examples, an inhibitory RNA, such as a siRNA, is complementary to a gene, such as a gene encoding a tyrosine kinase, for example a tyrosine kinase listed in Table 1.

Contacting: Placement in direct physical association, which includes both in solid and liquid form. In some examples, contacting can occur in vitro, for example with isolated cells, such as white blood cells or bone marrow cells obtained from a subject, such as a subject diagnosed with a hematological malignancy. In some examples, contacting can occur in vivo, for example by administering an agent to a subject.

Control: A reference standard. A control can be a known value indicative basal expression of a tyrosine kinase, for example in a normal cell, or a cell not contacted with inhibitory RNA, such as a siRNA, that inhibits the expression of a tyrosine kinase. A difference between a test sample, such as white blood cell sample or bone marrow cell sample obtained from a subject, and a control can be an increase or conversely a decrease, for example an increase or decrease in cell proliferation or viability. The difference can be a qualitative difference or a quantitative difference, for example a statistically significant difference. In some examples, a difference is an increase or decrease, relative to a control, of at least about 10%, such as at least about 20%, at least about 30%, at least about 40%, at least about 50%, at least about 60%, at least about 70%, at least about 80%, at least about 90%, at least about 100%, at least about 150%, at least about 200%, at least about 250%, at least about 300%, at least about 350%, at least about 400%, at least about 500%, or greater then 500%.

Corresponding: The term “corresponding” is a relative term indicating similarity in position, purpose, or structure. For example, a position on an array can correspond to an addressable location in the array.

Diagnosis: The process of identifying a disease or a predisposition to developing a disease, such as a hematological malignancy, by its signs, symptoms, and results of various tests and methods. The conclusion reached through that process is also called “a diagnosis.” Forms of testing commonly performed include blood tests, medical imaging, urinalysis, PAP smear, and biopsy, analysis of a blood smear, or histological analysis of cells obtained from a subject. In some examples, a subject is diagnosed as having a “hematological malignancy.” In some examples, a subject who has been diagnosed as having a hematological malignancy is selected, for example to determine if the subject has aberrant tyrosine kinase activity using the methods disclosed herein.

Down-regulated or inactivated: When used in reference to the expression of a gene product such as a nucleic acid molecule, for example a gene, or a protein it refers to any process which results in a decrease in production of the gene product. A gene product can be a DNA, an RNA (such as mRNA, rRNA, tRNA, and structural RNA), or protein. Therefore, gene down-regulation or deactivation includes processes that decrease transcription of a gene or translation of mRNA.

Examples of processes that decrease transcription include those that facilitate degradation of a transcription initiation complex, those that decrease transcription initiation rate, those that decrease transcription elongation rate, those that decrease processivity of transcription, and those that increase transcriptional repression. In some examples gene downregulation is produced using an inhibitory RNA, such as siRNA, that targets the gene that is to be down-regulated, for example, the expression of a particular tyrosine kinase can be downregulated using an inhibitory RNA, such as a siRNA, that targets that particular tyrosine kinase. Similarly, all of the tyrosine kinases can be downregulated, using a set of inhibitory RNAs, such as a set of siRNAs, that target all of the individual tyrosine kinases.

Expression: The process by which the coded information of a gene is converted into an operational, non-operational, or structural part of a cell, such as the synthesis of a protein. Gene expression can be influenced by external signals. For instance, exposure of a cell to a hormone may stimulate expression of a hormone-induced gene. Different types of cells can respond differently to an identical signal. Expression of a gene also can be regulated anywhere in the pathway from DNA to RNA to protein. Regulation can include controls on transcription, translation, RNA transport and processing, degradation of intermediary molecules such as mRNA, or through activation, inactivation, compartmentalization or degradation of specific protein molecules after they are produced. In some examples, expression of a target gene, such as a tyrosine kinase, can be reduced using an inhibitory RNA that targets the target gene.

Hybridization: The ability of complementary single-stranded DNA, RNA, or DNA/RNA hybrids to form a duplex molecule (also referred to as a hybridization complex). Nucleic acid hybridization techniques can be used to form hybridization complexes between an inhibitory RNA, such as a siRNA, and the gene it is designed to target. In particular examples, the siRNAs listed in Table 1 have been optimized to target the individual tyrosine kinases listed in Table 1.

Hybridization conditions resulting in particular degrees of stringency will vary depending upon the nature of the hybridization method and the composition and length of the hybridizing nucleic acid sequences. Generally, the temperature of hybridization and the ionic strength (such as the Na+ concentration) of the hybridization buffer will determine the stringency of hybridization. Calculations regarding hybridization conditions for attaining particular degrees of stringency are discussed in Sambrook et al., (1989) Molecular Cloning, second edition, Cold Spring Harbor Laboratory, Plainview, N.Y. (chapters 9 and 11). The following is an exemplary set of hybridization conditions and is not limiting:

Very High Stringency
(detects sequences that share at least 90% identity)

| | |
|---|---|
| Hybridization: | 5x SSC at 65° C. for 16 hours |
| Wash twice: | 2x SSC at room temperature (RT) for 15 minutes each |
| Wash twice: | 0.5x SSC at 65° C. for 20 minutes each |

High Stringency
(detects sequences that share at least 80% identity)

| | |
|---|---|
| Hybridization: | 5x-6x SSC at 65° C.-70° C. for 16-20 hours |
| Wash twice: | 2x SSC at RT for 5-20 minutes each |
| Wash twice: | 1x SSC at 55° C.-70° C. for 30 minutes each |

Low Stringency
(detects sequences that share at least 50% identity)

| | |
|---|---|
| Hybridization: | 6x SSC at RT to 55° C. for 16-20 hours |
| Wash at least twice: | 2x-3x SSC at RT to 55° C. for 20-30 minutes each. |

High throughput technique: A combination of modern robotics, data processing and control software, liquid handling devices, and sensitive detectors and multiwell plates. High throughput techniques allows the rapid screening of samples, such as samples obtained from subjects, for example subjects diagnosed as having a hematological malignancy, in a short period of time. In some examples, high throughput screening is used to screen a sample containing white blood cell or bone marrow cells obtained from a subject with a set of inhibitory RNAs, such as a set of siRNAs, that target the individual tyrosine kinases by inhibiting the expression of the individual tyrosine kinases.

Interfering with or inhibiting (expression of a target gene): This phrase refers to the ability of a molecule, such as an inhibitory RNA (for example a siRNA) to measurably reduce the expression of a target gene, for example a tyrosine kinase, such as the tyrosine kinases listed in Table 1. It contemplates reduction of the end-product of the gene, for example the expression or function of the encoded protein, and thus includes reduction in the amount or longevity of the mRNA transcript. It is understood that the phrase is relative, and does not require absolute suppression of the gene. Thus, in certain embodiments, interfering with or inhibiting gene expression of a target gene requires that, following contact with an inhibitory RNA that targets the gene that the gene is expressed at least 5% less than prior to application, such as at least 10% less, at least 15% less, at least 20% less, at least 25% less, at least 30% less, at least 35% less, at least 40% less, at least 45% less, at least 50% less, at least 55% less, at least 60% less, at least 65% less, at least 70% less, at least 75% less, at least 80% less, at least 85% less, at least 90% less, at least 95% less or even more reduced. Thus, in some particular embodiments, application of an inhibitory RNA reduces expression of the target tyrosine kinase by about 30%, about 40%, about 50%, about 60%, or more. In specific examples, where the inhibitory RNA is particularly effective, expression is reduced by about 70%, about 80%, about 85%, about 90%, about 95%, or even more.

Inhibiting or treating a disease: Inhibiting the development of a disease or condition, for example, in a subject who is at risk for a disease or has been diagnosed with such as a hematological malignancy. “Treatment” includes a therapeutic intervention that ameliorates a sign or symptom of a disease or pathological condition after it has begun to develop. A “treatment” also may be used to reduce risk or incidence of metastasis. The beneficial effects or treatment can be evidenced, for example, by a delayed onset of clinical symptoms of the disease in a susceptible subject, a reduction in severity of some or all clinical symptoms of the disease, a slower progression of the disease, a reduction in the number of metastases, an improvement in the overall health or well-being of the subject, or by other parameters well known in the art that are specific to the particular disease. A “prophylactic” treatment is a treatment for the purpose of decreasing the risk of developing pathology and is typically administered to a subject who does not exhibit signs of a disease or exhibits only early signs of the disease. In some examples a subject diagnosed with a hematological malignancy is treated with an agent that inhibits a tyrosine kinase that identified as having aberrant activity in the subject using the methods disclosed herein.

Inhibitory RNA: An RNA molecule or multiple RNA molecules that can inhibit the expression of a target gene in a cell, such as when introduced in a cell, for example, a white blood cell or bone marrow cell of a subject. Generally, inhibitory RNAs hybridize to a target nucleic acid or the complement thereof and decrease of the target gene expression. Examples of inhibitory RNAs that can be used in the methods provided herein are siRNAs, miRNAs, shRNAs and ribozymes.

Introducing an inhibitory RNA into a cell by electroporation: The act of causing an inhibitory RNA, such as a siRNA, to be transported across a cell membrane from the exterior of the cell to the interior of the cell by the use of an applied electric current. In some examples, electroporation is used to transport an inhibitory RNA into isolated while blood cells or bone marrow cells obtained from a subject, for example a subject that has been diagnosed with a hematological malignancy.

Isolated: An “isolated” biological component (such as a nucleic acid (for example a siRNA), protein, cell (or plurality of cells), tissue, or organelle) has been substantially separated or purified away from other biological components of the organism in which the component naturally occurs for example other tissues, cells, other chromosomal and extra-chromosomal DNA and RNA, proteins and organelles. Nucleic acids, such as siRNAs, and proteins that have been “isolated” include nucleic acids and proteins purified by standard purification methods. The term also embraces nucleic acids, such as siRNAs, prepared by recombinant expression in a host cell as well as chemically synthesized. In addition, the term embraces cells, such as white blood cells or bone marrow cells, that have been isolated from a subject, such as subject diagnosed with a hematological malignancy. Isolated does not require absolute purity, and can include nucleic acid molecules or cells that are at least 30% isolated, such as at least 40%, 50% 60%, 70%, 80%, 90%, 95%, 98%, 99%, or even 100% isolated.

Nucleotide: The fundamental unit of nucleic acid molecules. A nucleotide includes a nitrogen-containing base attached to a pentose monosaccharide with one, two, or three phosphate groups attached by ester linkages to the saccharide moiety.

The major nucleotides of DNA are deoxyadenosine 5′-triphosphate (dATP or A), deoxyguanosine 5′-triphosphate (dGTP or G), deoxycytidine 5′-triphosphate (dCTP or C) and deoxythymidine 5′-triphosphate (dTTP or T). The major nucleotides of RNA are adenosine 5′-triphosphate (ATP or A), guanosine 5′-triphosphate (GTP or G), cytidine 5′-triphosphate (CTP or C) and uridine 5′-triphosphate (UTP or U).

Nucleotides include those nucleotides containing modified bases, modified sugar moieties and modified phosphate backbones, for example as described in U.S. Pat. No. 5,866,336 to Nazarenko et al.

Examples of modified base moieties which can be used to modify nucleotides at any position on its structure include, but are not limited to: 5-fluorouracil, 5-bromouracil, 5-chlorouracil, 5-iodouracil, hypoxanthine, xanthine, acetylcytosine, 5-(carboxyhydroxylmethyl)uracil, 5-carboxymethylaminomethyl-2-thiouridine, 5-carboxymethylaminomethyluracil, dihydrouracil, beta-D-galactosylqueosine, inosine, N˜6-sopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, methoxyaminomethyl-2-thiouracil, beta-D-mannosylqueosine, 5′-methoxycarboxymethyluracil, 5-methoxyuracil, 2-methylthio-N6-isopentenyladenine, uracil-5-oxyacetic acid, pseudouracil, queosine, 2-thiocytosine, 5-methyl-2-thiouracil, 2-thiouracil, 4-thiouracil, 5-methyluracil, uracil-5-oxyacetic acid methylester, uracil-5-oxyacetic acid, 5-methyl-2-thiouracil, 3-(3-amino-3-N-2-carboxypropyl)uracil, and 2,6-diaminopurine amongst others.

Examples of modified sugar moieties, which may be used to modify nucleotides at any position on its structure, include, but are not limited to arabinose, 2-fluoroarabinose, xylose, and hexose, or a modified component of the phosphate backbone, such as phosphorothioate, a phosphorodithioate, a phosphoramidothioate, a phosphoramidate, a phosphordiamidate, a methylphosphonate, or an alkyl phosphotriester or analog thereof.

Nucleic acid: A polymer composed of nucleotide units (ribonucleotides, deoxyribonucleotides, related naturally occurring structural variants, and synthetic non-naturally occurring analogs thereof) linked via phosphodiester bonds, related naturally occurring structural variants, and synthetic non-naturally occurring analogs thereof. Thus, the term includes nucleotide polymers in which the nucleotides and the linkages between them include non-naturally occurring synthetic analogs, such as, for example and without limitation, phosphorothioates, phosphoramidates, methyl phosphonates, chiral-methyl phosphonates, 2-O-methyl ribonucleotides, peptide-nucleic acids (PNAs), and the like. Such polynucleotides can be synthesized, for example, using an automated DNA synthesizer. The term “oligonucleotide” typically refers to short polynucleotides, generally no greater than about 100 nucleotides. It will be understood that when a nucleotide sequence is represented by a DNA sequence (i.e., A, T, G, C), this also includes an RNA sequence (i.e., A, U, G, C) in which “U” replaces “T.” An RNA/DNA hybrid can have any combination of ribonucleotides, deoxyribonucleotides, related naturally occurring structural variants, and synthetic non-naturally occurring analogs thereof.

The term polynucleotide or nucleic acid sequence refers to a polymeric form of nucleotide at least 10 bases in length. A recombinant polynucleotide includes a polynucleotide that is not immediately contiguous with both of the coding sequences with which it is immediately contiguous (one on the 5′ end and one on the 3′ end) in the naturally occurring genome of the organism from which it is derived. The term therefore includes, for example, a recombinant DNA which is incorporated into a vector; into an autonomously replicating plasmid or virus; or into the genomic DNA of a prokaryote or eukaryote, or which exists as a separate molecule (such as a cDNA) independent of other sequences. The nucleotides can be ribonucleotides, deoxyribonucleotides, or modified forms of either nucleotide. The term includes single- and double-stranded forms of DNA.

The nucleic acid molecule can be double stranded (ds) or single stranded (ss). Where single stranded, the nucleic acid molecule can be the sense strand or the antisense strand. Nucleic acid molecules can include natural nucleotides (such as A, T/U, C, and G), and can also include analogs of natural nucleotides. In some examples a nucleic acid molecule is an inhibitory RNA, such as a siRNA molecule, that has been optimized to target a tyrosine kinase gene.

Sample: Biological specimens such as samples containing biomolecules, such as nucleic acid molecules (for example genomic DNA, cDNA, RNA, or mRNA) and/or cells. Exemplary samples are those containing cells or cell lysates from a subject, such as those present in peripheral blood (or a fraction thereof such as white blood cells or serum), urine, saliva, tissue biopsy (such as a bone marrow biopsy, for example bone marrow cells), cheek swabs, surgical specimen, fine needle aspirates, amniocentesis samples and autopsy material. In some examples, a sample is one obtained from a subject having, suspected of having, or who has had, for example diagnosed with a hematological malignancy. In particular examples, a sample is a sample obtained from a subject that contains white blood cells and/or bone marrow cells.

Sequence identity/similarity: The identity/similarity between two or more nucleic acid sequences, or two or more amino acid sequences, is expressed in terms of the identity or similarity between the sequences. Sequence identity can be measured in terms of percentage identity; the higher the percentage, the more identical the sequences are. Homologs or orthologs of nucleic acid or amino acid sequences possess a relatively high degree of sequence identity/similarity when aligned using standard methods.

Methods of alignment of sequences for comparison are well known in the art. Various programs and alignment algorithms are described in: Smith & Waterman, Adv. Appl. Math. 2:482, 1981; Needleman & Wunsch, J. Mol. Biol. 48:443, 1970; Pearson & Lipman, Proc. Natl. Acad. Sci. USA 85: 2444, 1988; Higgins & Sharp, Gene, 73:237-44, 1988; Higgins & Sharp, CABIOS 5:151-3, 1989; Corpet et al., Nuc. Acids Res. 16: 10881-90, 1988; Huang et al. Computer Appls. in the Biosciences 8, 155-65, 1992; and Pearson et al., Meth. Mol. Bio. 24: 307-31, 1994. Altschul et al., J. Mol. Biol. 215: 403-10, 1990, presents a detailed consideration of sequence alignment methods and homology calculations.

The NCBI Basic Local Alignment Search Tool (BLAST) (Altschul et al., J. Mol. Biol. 215: 403-10, 1990) is available from several sources, including the National Center for Biological Information (NCBI, National Library of Medicine, Building 38A, Room 8N805, Bethesda, Md. 20894) and on the Internet, for use in connection with the sequence analysis programs blastp, blastn, blastx, tblastn, and tblastx. Additional information can be found at the NCBI web site.

BLASTN is used to compare nucleic acid sequences, while BLASTP is used to compare amino acid sequences. To compare two nucleic acid sequences, the options can be set as follows: −i is set to a file containing the first nucleic acid sequence to be compared (such as C:\seq1.txt); −j is set to a file containing the second nucleic acid sequence to be compared (such as C:\seq2.txt); −p is set to blastn; −o is set to any desired file name (such as C:\output.txt); −q is set to −l; −r is set to 2; and all other options are left at their default setting. For example, the following command can be used to generate an output file containing a comparison between two sequences: C:\B12seq −i c:\seq1.txt −j c:\seq2.txt −p blastn −o c:\output.txt −q −l −r 2.

Once aligned, the number of matches is determined by counting the number of positions where an identical nucleotide or amino acid residue is presented in both sequences. The percent sequence identity is determined by dividing the number of matches either by the length of the sequence set forth in the identified sequence, or by an articulated length (such as 100 consecutive nucleotides or amino acid residues from a sequence set forth in an identified sequence), followed by multiplying the resulting value by 100. For example, a nucleic acid sequence that has 1166 matches when aligned with a test sequence having 1554 nucleotides is 75.0 percent identical to the test sequence (1166÷1554*100=75.0). The percent sequence identity value is rounded to the nearest tenth. For example, 75.11, 75.12, 75.13, and 75.14 are rounded down to 75.1, while 75.15, 75.16, 75.17, 75.18, and 75.19 are rounded up to 75.2. The length value will always be an integer. In another example, a target sequence containing a 20-nucleotide region that aligns with 20 consecutive nucleotides from an identified sequence as follows contains a region that shares 75 percent sequence identity to that identified sequence (i.e., 15÷20*100=75).

One indication that two nucleic acid molecules are closely related is that the two molecules hybridize to each other under stringent conditions. Stringent conditions are sequence-dependent and are different under different environmental parameters. In some examples a siRNA has high sequence similarity to a target sequence, such as the nucleic acid sequence of a target tyrosine kinase, for example a sequence of between about 5 and 50 nucleotide residues of the target tyrosine kinase.

Small inhibitory RNA (siRNA): A short sequence of RNA molecule capable of RNA interference or “RNAi.” (See, for example, Bass Nature 411: 428-429, 2001; Elbashir et al., Nature 411: 494-498, 2001; and Kreutzer et al., PCT Publication No. WO 00/44895; Zernicka-Goetz et al., PCT Publication No. WO 01/36646; Fire, PCT Publication No. WO 99/32619; Plaetinck et al., PCT Publication No. WO 00/01846; Mello and Fire, PCT Publication No. WO 01/29058; Deschamps-Depaillette, PCT Publication No. WO 99/07409; and Li et al., PCT Publication No. WO 00/44914.) As used herein, siRNA molecules need not be limited to those molecules containing only RNA, but further encompasses chemically modified nucleotides and non-nucleotides having RNAi capacity or activity. In some embodiments, and siRNA is used to silence gene expression, for example the expression of tyrosine kinases, such as the tyrosine kinases listed in Table 1. In particular examples a siRNA is a siRNA listed in Table 1.

Subject: Living multi-cellular vertebrate organisms, a category that includes both human and veterinary subjects, including human and non-human mammals. In a particular example, a subject, such as a human subject, is one having or suspected of having a hematological malignancy.

Tyrosine kinase: Tyrosine kinases (TKs) are enzymes which catalyze the phosphorylation of tyrosine residues. There are two main classes of tyrosine kinases: receptor tyrosine kinases and cellular, or non-receptor, tyrosine kinases. Of the 91 protein tyrosine kinases identified thus far in humans, 59 are receptor tyrosine kinases and 32 are non-receptor tyrosine kinases. These enzymes are involved in cellular signaling pathways and regulate key cell functions such as proliferation, differentiation, anti-apoptotic signaling and neurite outgrowth. Unregulated activation of these enzymes, through mechanisms such as point mutations or over-expression, can lead to various forms of cancer as well as benign proliferative conditions. More than 70% of the known oncogenes and proto-oncogenes involved in cancer code for tyrosine kinases. The importance of tyrosine kinases in health and disease is further underscored by the existence of aberrations in tyrosine kinases signaling occurring in inflammatory diseases and diabetes. The nucleic acid sequences of the 91 known human tyrosine kinases can be found on GENBANK® at the accession numbers shown in the third column of Table 1. The nucleotide sequences of the accession numbers shown in Table 1 as available on GENBANK® Jun. 13, 2008, are incorporated by reference herein in their entirety,

Receptor tyrosine kinases possess an extracellular ligand binding domain, a transmembrane domain and an intracellular catalytic domain. The transmembrane domain anchors the receptor in the plasma membrane, while the extracellular domains bind growth factors. Characteristically, the extracellular domains are comprised of one or more identifiable structural motifs, including cysteine-rich regions, fibronectin III-like domains, immunoglobulin-like domains, Epidermal Growth Factor (EGF)-like domains, cadherin-like domains, kringle-like domains, Factor VIII-like domains, glycine-rich regions, leucine-rich regions, acidic regions and discoidin-like domains.

The intracellular kinase domains of receptor tyrosine kinases can be divided into two classes: those containing a stretch of amino acids separating the kinase domain and those in which the kinase domain is continuous. Activation of the kinase is achieved by ligand binding to the extracellular domain, which induces dimerization of the receptors. Receptors thus activated are able to autophosphorylate tyrosine residues outside the catalytic domain via cross-phosphorylation. The results of this auto-phosphorylation are stabilization of the active receptor conformation and the creation of phosphotyrosine docking sites for proteins, which transduce signals within the cell. Signaling proteins which bind to the intracellular domain of receptor tyrosine kinases in a phosphotyrosine-dependent manner include RasGAP, PI3-kinase, phospholipase C, phosphotyrosine phosphatase SHP and adaptor proteins such as Shc, Grb2 and Crk.

In contrast to receptor tyrosine kinases, non-receptor tyrosine kinases (cellular tyrosine kinases) are located in the cytoplasm, nucleus or anchored to the inner leaflet of the plasma membrane. They are grouped into eight families: SRC, JAK, ABL, FAK, FPS, CSK, SYK and BTK. Each family consists of several members. With the exception of homologous kinase domains (Src Homology 1, or SH1 domains), and some protein-protein interaction domains (SH2 and SH3 domains), they have little in common, structurally. Of those cellular tyrosine kinases whose functions are known, many, such as SRC, are involved in cell growth. In contrast, FPS tyrosine kinases are involved in differentiation, ABL tyrosine kinases are involved in growth inhibition, and FAK activity is associated with cell adhesion. Some members of the cytokine receptor pathway interact with JAKs, which phosphorylate the transcription factors, STATs. Still other tyrosine kinases activate pathways whose components and functions remain to be determined.

### II. Overview of Several Embodiments.

Tyrosine kinases have been shown to play a role in the pathogenesis of numerous cancers, such as hematologic malignancies, and there remain a large numbers of diagnosed of cases of cancer that exhibit abnormal tyrosine kinase activity due to mechanisms that have yet to be discovered. Hence, a rapid but comprehensive functional screen that identifies individual tyrosine kinases required for survival of malignant cells from subjects, such as subjects diagnosed with hematological malignancies, will be a useful tool for both research and diagnostic purposes.

Disclosed herein is a method of identifying aberrant tyrosine kinase signaling in a subject. In some examples, the disclosed method uses a library of inhibitory RNAs (such as siRNAs) that targets the entire tyrosine kinase gene family (tyrosine kinome). Thus in some examples, the entire tyrosine kinome of a subject can be screened in a single assay to determine if the subject has aberrant kinase activity, for example aberrant tyrosine kinase that may be associated with a disease, such as cancer, for example a hematological malignancy. By measuring the proliferation and/or viability of cells obtained from a subject (such as cancer cells, for example cancer cells obtained from the blood or bone marrow of a subject) after contact with inhibitory RNAs that target the individual tyrosine kinases, the methods disclosed herein can identify tyrosine kinases with aberrant kinase activity that may be critical for the proliferation and/or viability of these cells. Identifying tyrosine kinase targets with aberrant kinase activity indentifies these tyrosine kinases with aberrant kinase activity (and/or the biological pathways in which they function) as potential targets of therapeutic intervention, for example with kinase inhibitors specific for the tyrosine kinases identified by the method.

The disclosed methods offer unexpectedly superior results over traditional methods of identifying specific targets for therapeutic intervention, such as sequencing methods, because the methods can identify aberrant kinase activity that is not caused by activating mutations of the tyrosine kinases themselves. For example, mutations can occur in phosphatases that exhibit negative control of tyrosine kinase activation that would never be identified from analysis of the sequences of the tyrosine kinases alone. Furthermore, such sequencing strategies to identify mutations cannot identify other alterations that may give rise to aberrant tyrosine kinase activity, such as over-expression of the tyrosine kinase.

### A. Assay for Aberrant Tyrosine Kinase Activity

The current disclosure relates to methods for detecting aberrant activity of a tyrosine kinase, such as a human tyrosine kinase, in a subject, such as a human subject, diagnosed with a hematological malignancy. In some embodiments the disclosed methods include selecting a subject diagnosed with a hematological malignancy, for example chronic myeloid leukemia (CML), primary myelofibrosis, acute lymphocytic leukemia (ALL), chronic neutrophilic leukemia (CNL), chronic myelomonocytic leukemia (CMML), or acute myelocytic leukemia (AML).

In the disclosed methods a sample of cells obtained from the subject, for example a sample of white blood cells, such peripheral white blood cells, or bone marrow cells, isolated from the subject, such as a human subject, is contacted with a set of inhibitory RNAs, such as siRNAs, that specifically inhibits expression of the tyrosine kinases, such as a receptor tyrosine kinases and/or a non-receptor tyrosine kinases.

The set of inhibitory RNAs, such as a set of siRNAs, is located in an array, in which individual inhibitory RNAs of the set of inhibitory RNAs, such as individual siRNAs, are located at addressable locations on the array. Electroporation can be used to introduce the set of inhibitory RNAs into the cells obtained from a subject. In some embodiments, the set of inhibitory RNAs, such as a set of siRNAs, targeting tyrosine kinases are introduced into the cells by subjecting the cells located at the individual addressable locations to two electrical pulses of a range from about 150 to about 250 μsec duration, such as from about 150 to about 175 μsec duration, from about 165 to about 190 μsec duration, from about 175 to about 200 μsec duration from about 190 to about 220 μsec duration, from about 200 to about 235 μsec duration or from about 210 to about 250 μsec duration at a voltage range from about 125 V to about 175 V, such as about 125 V to about 145 V, about 135 V to about 155 V, about 145 V to about 165 V, or about 155 V to about 175 V.

In some examples the cells at each addressable location in the array are subjected to two electrical pulses of about 150 μsec, about 155 μsec, about 160 μsec, about 165 μsec, about 170 μsec, about 175 μsec, about 180 μsec, about 185 μsec, about 190 μsec, about 195 μsec, about 200 μsec, about 205 μsec, about 210 μsec, about 215 μsec, about 220 μsec, 225 μsec about 230 μsec, about 235 μsec, 240 μsec, about 245 μsec, or about 250 μsec duration, for example one electrical pulse of about 150 μsec, about 155 μsec, about 160 μsec, about 165 μsec, about 170 μsec, about 175 μsec, about 180 μsec, about 185 μsec, about 190 μsec, about 195 μsec, about 200 μsec, about 205 μsec, about 210 μsec, about 215 μsec, about 220 μsec, 225 μsec about 230 μsec, about 235 μsec, 240 μsec, about 245 μsec, or about 250 μsec duration and a second electrical pulse of about 150 μsec, about 155 μsec, about 160 μsec, about 165 μsec, about 170 μsec, about 175 μsec, about 180 μsec, about 185 μsec, about 190 μsec, about 195 μsec, about 200 μsec, about 205 μsec, about 210 μsec, about 215 μsec, about 220 μsec, 225 μsec about 230 μsec, about 235 μsec, 240 μsec, about 245 μsec, or about 250 μsec duration.

In some examples the cells at each addressable location in the array are subjected to two electrical pulses at a voltage of about 125 V, such as about 130V, about 135 V, about 140V, about 145 V, about 150 V, about 155 V, about 160 V, about 165 V, about 170 V, or about 175 V.

In some embodiments, the cells are present in a 96 well microtiter plate and the plate is subjected to two electrical pulses of a range from about 150 to about 250 μsec duration (such as about 200 μsec duration) at a range from about 1000V to about 1200V (such as about 1000 V, about 1010 V, about 1020 V, about 1030 V, about 1040 V, about 1050 V, about 1060 V, about 1070 V, about 1080 V, about 1090 V, about 1110 V, about 1120 V, about 1130 V, about 1140 V, about 1150 V, about 1160 V, about 1170 V, about 1180 V, about 1190 V, or about 1200 V). Thus the cells in the individual wells of the plate are subjected to two electrical pulses of about 150 to about 250 μsec duration (such as about 200 μsec duration) at about 125 to about 175 V (such as about 150 V). One of ordinary skill in the art will appreciate that the number of wells or individual samples of cells can be varied to be any number, so long as the individual wells individual samples of cells are subjected to two electrical pulses of a range from about 150 to about 250 μsec duration at a range from about 125 V to about 175 V. Exemplary inhibitory RNAs for use in the disclosed methods are given in section B below.

After the cells are electroporated to introduce the set of inhibitory RNAs that specifically inhibits expression of the tyrosine kinase, the ability of the cells to proliferate and/or cell viability is determined. In some embodiments, cellular proliferation and/or viability is determined between about 1 hour and about 240 hours or longer after the cells are electroporated with the set of inhibitory RNAs. For example proliferation and/or viability of the cells can be determined at about 1 hour, about 2 hours, about 3 hours, about 4 hours, about 5 hours, about 6 hours, about 12 hours, about 18 hours, about 24 hours, about 48 hours, about 72 hours, about 96 hours, about 120 hours, about 144 hours, about 168 hours, about 192 hours, about 216 hours, and about 240 hours, for example between about 1 hour and 12 hours, between about 5 hours and about 18 hours, between about 12 hours and about 72 hours, between about 48 hours and 168 hours after electroporation. Exemplary methods of detecting cellular proliferation and/or viability, and conversely decreases in cellular proliferation and/or viability are given below in section C.

An inhibitory RNA, such as a siRNA, the that inhibits proliferation and/or viability of the cells, as compared to a control is identified as a inhibitory RNA that targets a tyrosine kinase with aberrant tyrosine kinase activity, thereby identifying the target tyrosine kinase as a possible therapeutic target, for example with an inhibitor of the identified tyrosine kinase. Conversely, if the electroporation of an inhibitory RNA into the cells of a subject results in an increase or maintenance of cell proliferation and cell viability relative to a control, the tyrosine kinase is identified as one that does not have aberrant activity in the subject, and would not be a target of therapeutic intervention. Examples of controls that can be used with the disclosed methods include statistical controls or cellular controls, such as white blood cells or bone marrow cells, obtained from the subject diagnosed with the hematological malignancy that are not contacted with an inhibitory RNA that targets a tyrosine kinase, or samples obtained from a second subject, such as subject that does not have a hematological malignancy. In particular examples, a control includes white blood cells or bone marrow cells, obtained from the subject diagnosed with the hematological malignancy that are not contacted with an inhibitory RNA. In some examples, the control cells are subjected to the same electroporation conditions as the cells obtained from the subject that are contacted with an inhibitory RNA that inhibits the expression of a tyrosine kinase. Examples of statistical controls are values that are indicative of basal proliferation or cell viability.

In some embodiments, the difference between the proliferation and/or viability of the cells contacted with an inhibitory RNA, such as a siRNA, that targets a tyrosine kinase relative to a control is a decrease in proliferation and/or viability of at least about 10%, such as at least about 20%, at least about 30%, at least about 40%, at least about 50%, at least about 60%, at least about 70%, at least about 80%, at least about 90%, at least about 100%, at least about 150%, at least about 200%, at least about 250%, at least about 300%, at least about 350%, at least about 400%, at least about 500%, or greater then 500%, for example between about 10% and about 60%, between about 30% and about 90%, between about 60% and about 200%, between about 150% and about 400%, or between about 300% and about 500% reduced. In some embodiments, the difference between the proliferation and/or viability of the cells contacted with an inhibitory RNA, such as a siRNA, that targets a tyrosine kinase relative to a control is a statistically significant difference. Thus, an inhibitory RNA, such as a siRNA, that targets a tyrosine kinase can induce a statistically significant difference in the amount of proliferation and/or viability of cells contacted with the inhibitory RNA relative to a control, such as cells not contacted with the inhibitory RNA.

By identifying an inhibitory that that specifically inhibits expression of a tyrosine kinase in the cells obtained from the subject, the tyrosine kinase targeted by that inhibitory RNA, such as a siRNA, (and/or the biological pathway in which that tyrosine kinase functions) is identified as a target for therapy, such therapy that inhibits the kinase activity of the identified tyrosine kinase.

In some embodiments, a therapeutic agent is selected that affects a biological pathway that includes the tyrosine kinase identified as having aberrant tyrosine kinase activity. In some embodiments, the selected therapeutic agent is administered to the subject from whom the cells were obtained. In some examples, the selected therapeutic agent is a small molecule or antibody that inhibits the activity of the tyrosine kinase identified as having aberrant tyrosine kinase activity.

### B. Inhibitory RNA Targeting the Human Tyrosine Kinases

The method disclosed herein use inhibitory RNAs that target the tyrosine kinases and reduce the expression of the tyrosine kinases in cells contacted with the inhibitory RNAs. Generally, the principle behind inhibitory RNA technology is that an inhibitory RNA hybridizes to a target nucleic acid and effects the modulation of gene expression activity, or function, such as transcription, translation or splicing. The modulation of gene expression can be achieved by, for example, target RNA degradation or occupancy-based inhibition. An example of modulation of target RNA function by degradation is RNase H-based degradation of the target RNA upon hybridization with a DNA-like inhibitory RNA. Inhibitory RNA can also be used to modulate gene expression, such as splicing, by occupancy-based inhibition, such as by blocking access to splice sites.

Another example of inhibitory RNA modulation of gene expression by target degradation is RNA interference (RNAi) using small interfering RNAs (siRNAs). RNAi is a form of antisense-mediated gene silencing involving the introduction of RNA-like oligonucleotides leading to the sequence-specific reduction of targeted endogenous mRNA levels. Another type of inhibitory RNA that utilizes the RNAi pathway is a microRNA. MicroRNAs are naturally occurring RNAs involved in the regulation of gene expression. However, these compounds can be synthesized to regulate gene expression via the RNAi pathway. Similarly, shRNAs are RNA molecules that form a tight hairpin turn and can be used to silence gene expression via the RNAi pathway. The shRNA hairpin structure is cleaved by the cellular machinery into siRNA.

Other compounds that are often classified as inhibitory RNAs are ribozymes. Ribozymes are catalytic RNA molecules that can bind to specific sites on other RNA molecules and catalyze the hydrolysis of phosphodiester bonds in the RNA molecules. Ribozymes modulate gene expression by direct cleavage of a target nucleic acid, such as a messenger RNA.

Each of the above-described inhibitory RNAs provides sequence-specific target gene regulation. This sequence-specificity makes inhibitory RNAs effective tools for the selective modulation of a target nucleic acid of interest, such as human tyrosine kinases and can be used in the disclosed methods. To target the human tyrosine kinases any type of inhibitory RNAs that specifically target and regulate expression of the human tyrosine kinases are contemplated for use with the disclosed methods. Such inhibitory RNAs include siRNAs, miRNAs, shRNAs and ribozymes. Methods of designing, preparing and using inhibitory RNAs that specifically target the human tyrosine kinases are within the abilities of one of skill in the art. In some embodiments of the methods disclosed herein, the subject is human and the each of the inhibitory RNAs in the set of inhibitory RNAs inhibits a human tyrosine kinase. Inhibitory RNAs specifically targeting the tyrosine kinases can be prepared by designing compounds that are complementary to the tyrosine kinase nucleotide sequences, for example the nucleic acid sequences given by the GENBANK® accession nos. set forth in Table 1, all of which are incorporated herein by reference in their entirety as available Jun. 13, 2008.

Inhibitory RNAs targeting the tyrosine kinases need not be 100% complementary to the tyrosine kinases to specifically hybridize and regulate expression the target gene. For example, the inhibitory RNA, or antisense strand of the compound If a double-stranded compound, can be at least 75%, at least 80%, at least 85%, at least 90%, at least 95%, at least 99%, or 100% complementary to the selected tyrosine kinases nucleic acid sequence are a portion thereof, such as at least 75%, at least 80%, at least 85%, at least 90%, at least 95%, at least 99%, or 100% identical to the nucleic acid sequences or a portion thereof, such as between about 10 and about 100 nucleotides, given by the GENBANK® accession nos. set forth in Table 1, all of which are incorporated herein by reference in their entirety.

In some examples, the inhibitory RNAs are between about 10 and about 100 nucleotides in length for example, such as about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, or about 100 nucleotides in length, for example about 10 to about 30, about 20 to about 50, about 40 to about 70, about 50 to about 90, or about 70 to about 100 nucleotides in length. In specific examples, the inhibitory RNAs used in the disclosed methods comprise a set of siRNAs that are at least 75%, at least 80%, at least 85%, at least 90%, at least 95%, at least 99%, or 100% identical to siRNAs selected from the siRNAs set forth in Table 1.

In other examples, the inhibitory RNAs used in the disclosed methods consist of a set of siRNAs that are at least 75%, at least 80%, at least 85%, at least 90%, at least 95%, at least 99%, or 100% identical to siRNAs from the siRNAs set forth in Table 1.

TABLE 1
exemplary siRNAs for 91 human tyrosine kinases.

| | | | | | |
|---|---|---|---|---|---|
| | | GENBANK ® | | | |
| | | Accession No. | | | |
| | | All of witch are | | | |
| | | incorporated herein by | | | |
| Gene | Gene | reference in their entirety | GI | | SEQ |
| Name | ID | as available Jun. 13, 2008 | Number | Sequence | ID NO: |

| | | | | | |
|---|---|---|---|---|---|
| EPHA6 | 285220 | XM_496653 | 51464076 | GGAAUAUACUGGUCAAUAG | 1 |
| EPHA6 | 285220 | XM_496653 | 51464076 | AAACAUCAUUCGCCUAGAA | 2 |
| EPHA6 | 285220 | XM_496653 | 51464076 | CCACAUGGAUCGGCAAAGA | 3 |
| EPHA6 | 285220 | XM_496653 | 51464076 | GAUCCCAGUUGCCAUUAAA | 4 |
| ABL1 | 25 | NM_007313 | 6382057 | GGAAAUCAGUGACAUAGUG | 5 |
| ABL1 | 25 | NM_007313 | 6382057 | GGUCCACACUGCAAUGUUU | 6 |
| ABL1 | 25 | NM_007313 | 6382057 | GAAGGAAAUCAGUGACAUA | 7 |
| ABL1 | 25 | NM_007313 | 6382057 | UCACUGAGUUCAUGACCUA | 8 |
| ABL2 | 27 | NM_005158 | 6382059 | GAAAUGGAGCGAACAGAUA | 9 |
| ABL2 | 27 | NM_005158 | 6382059 | GAGCCAAAUUUCCUAUUAA | 10 |
| ABL2 | 27 | NM_005158 | 6382059 | GUAAUAAGCCUACAGUCUA | 11 |
| ABL2 | 27 | NM_005158 | 6382059 | GGAGUGAAGUUCGCUCUAA | 12 |
| TNK2 | 10188 | NM_005781 | 58331192 | GCAAGUCGUGGAUGAGUAA | 13 |
| TNK2 | 10188 | NM_005781 | 58331192 | GAAAGCGACUGGAGGCUGA | 14 |
| TNK2 | 10188 | NM_005781 | 58331192 | CAUCCUACCUGGAGCGCUA | 15 |
| TNK2 | 10188 | NM_005781 | 58331192 | GCAGGAACAUCGCAAGGUG | 16 |
| ALK | 238 | NM_004304 | 29029631 | GACAAGAUCCUGCAGAAUA | 17 |
| ALK | 238 | NM_004304 | 29029631 | GGAAGAGUCUGGCAGUUGA | 18 |
| ALK | 238 | NM_004304 | 29029631 | GCACGUGGCUCGGGACAUU | 19 |
| ALK | 238 | NM_004304 | 29029631 | GGUCAUAGCUCCUUGGAAU | 20 |
| AXL | 558 | NM_001699 | 21536467 | GAAAGAAGGAGACCCGUUA | 21 |
| AXL | 558 | NM_001699 | 21536467 | CCAAGAAGAUCUACAAUGG | 22 |
| AXL | 558 | NM_001699 | 21536467 | GGAACUGCAUGCUGAAUGA | 23 |
| AXL | 558 | NM_001699 | 21536467 | GAAGGAGACCCGUUAUGGA | 24 |
| BLK | 640 | NM_001715 | 33469981 | GGUCAGCGCCCAAGACAAG | 25 |
| BLK | 640 | NM_001715 | 33469981 | GAAACUCGGGUCUGGACAA | 26 |
| BLK | 640 | NM_001715 | 33469981 | CGAAUCAUCGACAGUGAAU | 27 |
| BLK | 640 | NM_001715 | 33469981 | GAGCUGAUCAAGCACUAUA | 28 |
| BMX | 660 | NM_001721 | 42544180 | GAGAAGAGAUUACCUUGUU | 29 |
| BMX | 660 | NM_001721 | 42544180 | GUAAGGCUGUGAAUGAUAA | 30 |
| BMX | 660 | NM_001721 | 42544180 | GAAGAGAGCCGAAGUCAGU | 31 |
| BMX | 660 | NM_001721 | 42544180 | GUACCACUCUAGCCCAAUA | 32 |
| BTK | 695 | NM_000061 | 4557376 | GAACAGGAAUGGAAGCUUA | 33 |
| BTK | 695 | NM_000061 | 4557376 | GCUAUGGGCUGCCAAAUUU | 34 |
| BTK | 695 | NM_000061 | 4557376 | GAAAGCAACUUACCAUGGU | 35 |
| BTK | 695 | NM_000061 | 4557376 | GGUAAACGAUCAAGGAGUU | 36 |
| TP53RK | 112858 | NM_033550 | 19923655 | CAACUUAGCCAAGACAAUU | 37 |
| TP53RK | 112858 | NM_033550 | 19923655 | GAAAUUGAAGGCUCAGUGA | 38 |
| TP53RK | 112858 | NM_033550 | 19923655 | UGGAACAGCUGAACAUUGU | 39 |
| TP53RK | 112858 | NM_033550 | 19923655 | GCUUCCAACUGCUUAUAUA | 40 |
| CSF1R | 1436 | NM_005211 | 27262658 | GGAGAGCUCUGACGUUUGA | 41 |
| CSF1R | 1436 | NM_005211 | 27262658 | CAACAACGCUACCUUCCAA | 42 |
| CSF1R | 1436 | NM_005211 | 27262658 | CCACGCAGCUGCCUUACAA | 43 |
| CSF1R | 1436 | NM_005211 | 27262658 | GGAGAGAGCGGGACUAUAC | 44 |
| CSK | 1445 | NM_004383 | 4758077 | GAACAAAGUCGCCGUCAAG | 45 |
| CSK | 1445 | NM_004383 | 4758077 | GCGAGUGCCUUAUCCAAGA | 46 |
| CSK | 1445 | NM_004383 | 4758077 | GGAGAAGGGCUACAAGAUG | 47 |
| CSK | 1445 | NM_004383 | 4758077 | GGAACAAAGUCGCCGUCAA | 48 |
| DDR1 | 780 | NM_001954 | 38327631 | UGAAAGAGGUGAAGAUCAU | 49 |
| DDR1 | 780 | NM_001954 | 38327631 | GGGACACCCUUUGCUGGUA | 50 |
| DDR1 | 780 | NM_001954 | 38327631 | GAAUGUCGCUUCCGGCGUG | 51 |
| DDR1 | 780 | NM_001954 | 38327631 | GAGCGUCUGUCUGCGGGUA | 52 |
| DDR2 | 4921 | NM_006182 | 5453813 | GGUAAGAACUACACAAUCA | 53 |
| DDR2 | 4921 | NM_006182 | 5453813 | GAACGAGAGUGCCACCAAU | 54 |
| DDR2 | 4921 | NM_006182 | 5453813 | GACUUACGAUCGCAUCUUU | 55 |
| DDR2 | 4921 | NM_006182 | 5453813 | UGUCUGGCCUGGACGAUUU | 56 |
| STYK1 | 55359 | NM_018423 | 8922178 | CCUAGAAGCUGCCAUUAAA | 57 |
| STYK1 | 55359 | NM_018423 | 8922178 | GAUUAGGCCUGGCUUAUGA | 58 |
| STYK1 | 55359 | NM_018423 | 8922178 | CCCAGUAGCUGCACACAUA | 59 |
| STYK1 | 55359 | NM_018423 | 8922178 | GGUGGUACCUGAACUGUAU | 60 |
| EGFR | 1956 | NM_005228 | 29725608 | GAAGGAAACUGAAUUCAAA | 61 |
| EGFR | 1956 | NM_005228 | 29725608 | GGAAAUAUGUACUACGAAA | 62 |
| EGFR | 1956 | NM_005228 | 29725608 | CCACAAAGCAGUGAAUUUA | 63 |
| EGFR | 1956 | NM_005228 | 29725608 | GUAACAAGCUCACGCAGUU | 64 |
| EPHA1 | 2041 | NM_005232 | 32967308 | AGGAAGUUACUCUGAUGGA | 65 |
| EPHA1 | 2041 | NM_005232 | 32967308 | AGAAAGAACCGAGGCAACU | 66 |
| EPHA1 | 2041 | NM_005232 | 32967308 | AGACUGUGGCCAUUAAGAC | 67 |
| EPHA1 | 2041 | NM_005232 | 32967308 | GCGCAUUCUUUGCAGUAUU | 68 |
| EPHA2 | 1969 | NM_004431 | 32967310 | GGAGGGAUCUGGCAACUUG | 69 |
| EPHA2 | 1969 | NM_004431 | 32967310 | GCAGCAAGGUGCACGAAUU | 70 |
| EPHA2 | 1969 | NM_004431 | 32967310 | GGAGAAGGAUGGCGAGUUC | 71 |
| EPHA2 | 1969 | NM_004431 | 32967310 | GAAGUUCACUACCGAGAUC | 72 |
| EPHA3 | 2042 | NM_005233 | 32967312 | GAUCGGACCUCCAGAAAUA | 73 |
| EPHA3 | 2042 | NM_005233 | 32967312 | GAACUCAGCUCAGAAGAUU | 74 |
| EPHA3 | 2042 | NM_005233 | 32967312 | GAGCAUCAGUUUACAAAGA | 75 |
| EPHA3 | 2042 | NM_005233 | 32967312 | AAAUGUGGGUGGAAUAUAA | 76 |
| EPHA4 | 2043 | NM_004438 | 32967315 | GGUCUGGGAUGAAGUAUUU | 77 |
| EPHA4 | 2043 | NM_004438 | 32967315 | GAAUGAAGUUACCUUAUUG | 78 |
| EPHA4 | 2043 | NM_004438 | 32967315 | GAACUUGGGUGGAUAGCAA | 79 |
| EPHA4 | 2043 | NM_004438 | 32967315 | GAGAUUAAAUUCACCUUGA | 80 |
| EPHA7 | 2045 | NM_004440 | 32967320 | GAAAAGAGAUGUUGCAGUA | 81 |
| EPHA7 | 2045 | NM_004440 | 32967320 | CUAGAUGCCUCCUGUAUUA | 82 |
| EPHA7 | 2045 | NM_004440 | 32967320 | AGAAGAAGGUUAUCGUUUA | 83 |
| EPHA7 | 2045 | NM_004440 | 32967320 | UAGCAAAGCUGACCAAGAA | 84 |
| EPHA8 | 2046 | NM_020526 | 18201903 | GAAGAUGCACUAUCAGAAU | 85 |
| EPHA8 | 2046 | NM_020526 | 18201903 | GAGAAGAUGCACUAUCAGA | 86 |
| EPHA8 | 2046 | NM_020526 | 18201903 | UCUCAGACCUGGGCUAUGU | 87 |
| EPHA8 | 2046 | NM_020526 | 18201903 | GCGCGUCUAUGCUGAGAUC | 88 |
| EPHB1 | 2047 | NM_004441 | 21396502 | GCGAUAAGCUCCAGCAUUA | 89 |
| EPHB1 | 2047 | NM_004441 | 21396502 | GAAACGGGCUUAUAGCAAA | 90 |
| EPHB1 | 2047 | NM_004441 | 21396502 | GGAUGAAGAUCUACAUUGA | 91 |
| EPHB1 | 2047 | NM_004441 | 21396502 | GCACGUCUCUGUCAACAUC | 92 |
| EPHB2 | 2048 | NM_004442 | 24797104 | ACUAUGAGCUGCAGUACUA | 93 |
| EPHB2 | 2048 | NM_004442 | 24797104 | GUACAACGCCACAGCCAUA | 94 |
| EPHB2 | 2048 | NM_004442 | 24797104 | GGAAAGCAAUGACUGUUCU | 95 |
| EPHB2 | 2048 | NM_004442 | 24797104 | CGGACAAGCUGCAACACUA | 96 |
| EPHB3 | 2049 | NM_004443 | 33598961 | GGAAUGAAGGUUUAUAUUG | 97 |
| EPHB3 | 2049 | NM_004443 | 33598961 | GAUCCUACCUACACCAGUU | 98 |
| EPHB3 | 2049 | NM_004443 | 33598961 | GAAGACCUGCUCCGUAUUG | 99 |
| EPHB3 | 2049 | NM_004443 | 33598961 | CACAAUAACUUCUACCGUG | 100 |
| EPHB4 | 2050 | NM_004444 | 32528300 | GGACAAACACGGACAGUAU | 101 |
| EPHB4 | 2050 | NM_004444 | 32528300 | GUACUAAGGUCUACAUCGA | 102 |
| EPHB4 | 2050 | NM_004444 | 32528300 | GGAGAGAAGCAGAAUAUUC | 103 |
| EPHB4 | 2050 | NM_004444 | 32528300 | GCCAAUAGCCACUCUAACA | 104 |
| EPHB6 | 2051 | NM_004445 | 4758291 | GGAAGUCGAUCCUGCUUAU | 105 |
| EPHB6 | 2051 | NM_004445 | 4758291 | GGACCAAGGUGGACACAAU | 106 |
| EPHB6 | 2051 | NM_004445 | 4758291 | UGUGGGAAGUGAUGAGUUA | 107 |
| EPHB6 | 2051 | NM_004445 | 4758291 | CGGGAGACCUUCACCCUUU | 108 |
| ERBB2 | 2064 | NM_004448 | 4758297 | GGACGAAUUCUGCACAAUG | 109 |
| ERBB2 | 2064 | NM_004448 | 4758297 | GACGAAUUCUGCACAAUGG | 110 |
| ERBB2 | 2064 | NM_004448 | 4758297 | CUACAACACAGACACGUUU | 111 |
| ERBB2 | 2064 | NM_004448 | 4758297 | AGACGAAGCAUACGUGAUG | 112 |
| ERBB3 | 2065 | NM_001982 | 4503596 | AAGAGGAUGUCAACGGUUA | 113 |
| ERBB3 | 2065 | NM_001982 | 4503596 | GAAGACUGCCAGACAUUGA | 114 |
| ERBB3 | 2065 | NM_001982 | 4503596 | GCAGUGGAUUCGAGAAGUG | 115 |
| ERBB3 | 2065 | NM_001982 | 4503596 | GGACCGAGAUGCUGAGAUA | 116 |
| ERBB4 | 2066 | NM_005235 | 4885214 | GCAGGAAACAUCUAUAUUA | 117 |
| ERBB4 | 2066 | NM_005235 | 4885214 | GAUCACAACUGCUGCUUAA | 118 |
| ERBB4 | 2066 | NM_005235 | 4885214 | CCUCAAAGAUACCUAGUUA | 119 |
| ERBB4 | 2066 | NM_005235 | 4885214 | GCUCUGGAGUGUAUACAUU | 120 |
| FER | 2241 | NM_005246 | 4885230 | GGAGUGACCUGAAGAAUUC | 121 |
| FER | 2241 | NM_005246 | 4885230 | UAAAGCAGAUUCCCAUUAA | 122 |
| FER | 2241 | NM_005246 | 4885230 | GGAAAGUACUGUCCAAAUG | 123 |
| FER | 2241 | NM_005246 | 4885230 | GAACAACGGCUGCUAAAGA | 124 |
| FES | 2242 | NM_002005 | 13376997 | CGAGGAUCCUGAAGCAGUA | 125 |
| FES | 2242 | NM_002005 | 13376997 | AGGAAUACCUGGAGAUUAG | 126 |
| FES | 2242 | NM_002005 | 13376997 | CAACAGGAGCUCCGGAAUG | 127 |
| FES | 2242 | NM_002005 | 13376997 | GGUGUUGGGUGAGCAGAUU | 128 |
| FGFR1 | 2260 | NM_000604 | 13186232 | UAAGAAAUGUCUCCUUUGA | 129 |
| FGFR1 | 2260 | NM_000604 | 13186232 | GAUGGUCCCUUGUAUGUCA | 130 |
| FGFR1 | 2260 | NM_000604 | 13186232 | CUUAAGAAAUGUCUCCUUU | 131 |
| FGFR1 | 2260 | NM_000604 | 13186232 | AUUCAAACCUGACCACAGA | 132 |
| FGFR2 | 2263 | NM_000141 | 13186239 | CCAAAUCUCUCAACCAGAA | 133 |
| FGFR2 | 2263 | NM_000141 | 13186239 | GAACAGUAUUCACCUAGUU | 134 |
| FGFR2 | 2263 | NM_000141 | 13186239 | GGCCAACACUGUCAAGUUU | 135 |
| FGFR2 | 2263 | NM_000141 | 13186239 | GUGAAGAUGUUGAAAGAUG | 136 |
| FGFR3 | 2261 | NM_000142 | 13112046 | UGUCGGACCUGGUGUCUGA | 137 |
| FGFR3 | 2261 | NM_000142 | 13112046 | GCAUCAAGCUGCGGCAUCA | 138 |
| FGFR3 | 2261 | NM_000142 | 13112046 | GGACGGCACACCCUACGUU | 139 |
| FGFR3 | 2261 | NM_000142 | 13112046 | UGCACAACCUCGACUACUA | 140 |
| FGFR4 | 2264 | NM_002011 | 13112051 | GCACUGGAGUCUCGUGAUG | 141 |
| FGFR4 | 2264 | NM_002011 | 47524172 | CCUCGAAUAGGCACAGUUA | 142 |
| FGFR4 | 2264 | NM_002011 | 47524172 | AUAACUACCUGCUAGAUGU | 143 |
| FGFR4 | 2264 | NM_002011 | 47524172 | GCAUUCGGCUGCGCCAUCA | 144 |
| FGR | 2268 | NM_005248 | 4885234 | GCGAUCAUGUGAAGCAUUA | 145 |
| FGR | 2268 | NM_005248 | 4885234 | UCACUGAGCUCAUCACCAA | 146 |
| FGR | 2268 | NM_005248 | 4885234 | CCCAGAAGCUGCCCUCUUU | 147 |
| FGR | 2268 | NM_005248 | 4885234 | GAAUAAACGGGAAGUGUUG | 148 |
| FLT1 | 2321 | NM_002019 | 32306519 | GAGCAAACGUGACUUAUUU | 149 |
| FLT1 | 2321 | NM_002019 | 32306519 | CCAAAUGGGUUUCAUGUUA | 150 |
| FLT1 | 2321 | NM_002019 | 32306519 | CAACAAGGAUGCAGCACUA | 151 |
| FLT1 | 2321 | NM_002019 | 32306519 | GCCGGAAGUUGUAUGGUUA | 152 |
| FLT3 | 2322 | NM_004119 | 4758395 | GAAGGCAUCUACACCAUUA | 153 |
| FLT3 | 2322 | NM_004119 | 4758395 | GAAGGAGUCUGGAAUAGAA | 154 |
| FLT3 | 2322 | NM_004119 | 4758395 | GAAUUUAAGUCGUGUGUUC | 155 |
| FLT3 | 2322 | NM_004119 | 4758395 | GGAAUUCAUUUCACUCUGA | 156 |
| FLT4 | 2324 | NM_002020 | 4503752 | GCAAGAACGUGCAUCUGUU | 157 |
| FLT4 | 2324 | NM_002020 | 4503752 | GCGAAUACCUGUCCUACGA | 158 |
| FLT4 | 2324 | NM_002020 | 4503752 | GAAGACAUUUGAGGAAUUC | 159 |
| FLT4 | 2324 | NM_002020 | 4503752 | GAGCAGCCAUUCAUCAACA | 160 |
| FRK | 2444 | NM_002031 | 31657133 | GAAACAGACUCUUCAUAUU | 161 |
| FRK | 2444 | NM_002031 | 31657133 | GAACAAUACCACUCCAGUA | 162 |
| FRK | 2444 | NM_002031 | 31657133 | CAAGACCGGUUCCUUUCUA | 163 |
| FRK | 2444 | NM_002031 | 31657133 | GCAAGAAUAUCUCCAAAAU | 164 |
| FYN | 2534 | NM_002037 | 23510344 | GGAAUGGACUCAUAUGCAA | 165 |
| FYN | 2534 | NM_002037 | 23510344 | CAAAGGAAGUUUACUGGAU | 166 |
| FYN | 2534 | NM_002037 | 23510344 | GCUCUGAAAUUACCAAAUC | 167 |
| FYN | 2534 | NM_002037 | 23510344 | CGCAUGAAUUAUAUCCAUA | 168 |
| HCK | 3055 | NM_002110 | 30795228 | CGGGAUAGCGAGACCACUA | 169 |
| HCK | 3055 | NM_002110 | 30795228 | GGUCAAACUUCAUGCGGUG | 170 |
| HCK | 3055 | NM_002110 | 30795228 | GAGGAGCUCUACAACAUCA | 171 |
| HCK | 3055 | NM_002110 | 30795228 | UGGUUGCCCUGUAUGAUUA | 172 |
| IGF1R | 3480 | NM_000875 | 11068002 | GGCCAGAAAUGGAGAAUAA | 173 |
| IGF1R | 3480 | NM_000875 | 11068002 | GCAGACACCUACAACAUCA | 174 |
| IGF1R | 3480 | NM_000875 | 11068002 | GGACUCAGUACGCCGUUUA | 175 |
| IGF1R | 3480 | NM_000875 | 11068002 | GUGGGAGGGUUGGUGAUUA | 176 |
| INSR | 3643 | NM_000208 | 4557883 | GGAAGACGUUUGAGGAUUA | 177 |
| INSR | 3643 | NM_000208 | 4557883 | GAACAAGGCUCCCGAGAGU | 178 |
| INSR | 3643 | NM_000208 | 4557883 | GGAGAGACCUUGGAAAUUG | 179 |
| INSR | 3643 | NM_000208 | 4557883 | GGACGGAACCCACCUAUUU | 180 |
| ITK | 3702 | NM_005546 | 21614549 | GAACAAUCCCUGUAUAAAG | 181 |
| ITK | 3702 | NM_005546 | 21614549 | GAAAUUGUUUGGUGGGAGA | 182 |
| ITK | 3702 | NM_005546 | 21614549 | GCAGUUAUCUGGUGGAAAA | 183 |
| ITK | 3702 | NM_005546 | 21614549 | ACAGUUUGGUGCCUAAAUA | 184 |
| JAK1 | 3716 | NM_002227 | 4504802 | CCACAUAGCUGAUCUGAAA | 185 |
| JAK1 | 3716 | NM_002227 | 4504802 | UGAAAUCACUCACAUUGUA | 186 |
| JAK1 | 3716 | NM_002227 | 4504802 | UAAGGAACCUCUAUCAUGA | 187 |
| JAK1 | 3716 | NM_002227 | 4504802 | GCAGGUGGCUGUUAAAUCU | 188 |
| JAK2 | 3717 | NM_004972 | 13325062 | GAGCAAAGAUCCAAGACUA | 189 |
| JAK2 | 3717 | NM_004972 | 13325062 | GCCAGAAACUUGAAACUUA | 190 |
| JAK2 | 3717 | NM_004972 | 13325062 | GAUCCUGGCAUUAGUAUUA | 191 |
| JAK2 | 3717 | NM_004972 | 13325062 | ACAGAAUGCUGGAACAAUA | 192 |
| JAK3 | 3718 | NM_000215 | 4557680 | GCGCCUAUCUUUCUCCUUU | 193 |
| JAK3 | 3718 | NM_000215 | 4557680 | CCAGAAAUCGUAGACAUUA | 194 |
| JAK3 | 3718 | NM_000215 | 4557680 | CCUCAUCUCUUCAGACUAU | 195 |
| JAK3 | 3718 | NM_000215 | 4557680 | UGUACGAGCUCUUCACCUA | 196 |
| KDR | 3791 | NM_002253 | 11321596 | GGAAAUCUCUUGCAAGCUA | 197 |
| KDR | 3791 | NM_002253 | 11321596 | GAUUACAGAUCUCCAUUUA | 198 |
| KDR | 3791 | NM_002253 | 11321596 | GCAGACAGAUCUACGUUUG | 199 |
| KDR | 3791 | NM_002253 | 11321596 | GCGAUGGCCUCUUCUGUAA | 200 |
| KIT | 3815 | NM_000222 | 4557694 | AAACACGGCUUAAGCAAUU | 201 |
| KIT | 3815 | NM_000222 | 4557694 | GAACAGAACCUUCACUGAU | 202 |
| KIT | 3815 | NM_000222 | 4557694 | GGGAAGCCCUCAUGUCUGA | 203 |
| KIT | 3815 | NM_000222 | 4557694 | GCAAUUCCAUUUAUGUGUU | 204 |
| LMTK2 | 22853 | NM_014916 | 38016936 | GAAAUUCUCUCAACUGAUG | 205 |
| LMTK2 | 22853 | NM_014916 | 38016936 | GCAGAGGUCUUCACACUUU | 206 |
| LMTK2 | 22853 | NM_014916 | 38016936 | UAAAUGAUCUUCAGACAGA | 207 |
| LMTK2 | 22853 | NM_014916 | 38016936 | GAGCAGCCCUACUCUGAUA | 208 |
| LCK | 3932 | NM_005356 | 20428651 | GAACUGCCAUUAUCCCAUA | 209 |
| LCK | 3932 | NM_005356 | 20428651 | GAGAGGUGGUGAAACAUUA | 210 |
| LCK | 3932 | NM_005356 | 20428651 | GGGCCAAGUUUCCCAUUAA | 211 |
| LCK | 3932 | NM_005356 | 20428651 | GCACGCUGCUCAUCCGAAA | 212 |
| LTK | 4058 | NM_002344 | 4505044 | UGAAUUCACUCCUGCCAAU | 213 |
| LTK | 4058 | NM_002344 | 4505044 | GUGGCAACCUCAACACUGA | 214 |
| LTK | 4058 | NM_002344 | 4505044 | GGAGCUAGCUGUGGAUAAC | 215 |
| LTK | 4058 | NM_002344 | 4505044 | GCAAGUUUCGCCAUCAGAA | 216 |
| LYN | 4067 | NM_002350 | 4505054 | AGACUCAACCAGUACGUAA | 217 |
| LYN | 4067 | NM_002350 | 4505054 | AGAUUGGAGAAGGCUUGUA | 218 |
| LYN | 4067 | NM_002350 | 4505054 | GCGACAUGAUUAAACAUUA | 219 |
| LYN | 4067 | NM_002350 | 4505054 | GAUCCAACGUCCAAUAAAC | 220 |
| MATK | 4145 | NM_002378 | 21450841 | GCAUUACAGCAAGGACAAG | 221 |
| MATK | 4145 | NM_002378 | 21450841 | UACUGAACCUGCAGCAUUU | 222 |
| MATK | 4145 | NM_002378 | 21450841 | UGGGAGGUCUUCUCAUAUG | 223 |
| MATK | 4145 | NM_002378 | 21450841 | UGACGAAGAUGCAACACGA | 224 |
| MERTK | 10461 | NM_006343 | 5453737 | GAACUUACCUUACAUAGCU | 225 |
| MERTK | 10461 | NM_006343 | 5453737 | GGACCUGCAUACUUACUUA | 226 |
| MERTK | 10461 | NM_006343 | 5453737 | UGACAGGAAUCUUCUAAUU | 227 |
| MERTK | 10461 | NM_006343 | 5453737 | GGUAAUGGCUCAGUCAUGA | 228 |
| MET | 4233 | NM_000245 | 42741654 | GAAGAUCAGUUUCCUAAUU | 229 |
| MET | 4233 | NM_000245 | 42741654 | CCAGAGACAUGUAUGAUAA | 230 |
| MET | 4233 | NM_000245 | 42741654 | GAACAGAAUCACUGACAUA | 231 |
| MET | 4233 | NM_000245 | 42741654 | GAAACUGUAUGCUGGAUGA | 232 |
| MST1R | 4486 | NM_002447 | 4505264 | GUGGAGCGCUGUUGUGAAU | 233 |
| MST1R | 4486 | NM_002447 | 4505264 | GACAGGGAGUACUAUAGUG | 234 |
| MST1R | 4486 | NM_002447 | 4505264 | CGACCCACCUUCAGAGUAC | 235 |
| MST1R | 4486 | NM_002447 | 4505264 | UAGAGGAGUUUGAGUGUGA | 236 |
| MUSK | 4593 | NM_005592 | 5031926 | GAAGAAGCCUCGGCAGAUA | 237 |
| MUSK | 4593 | NM_005592 | 5031926 | GUAAUAAUCUCCAUCAUGU | 238 |
| MUSK | 4593 | NM_005592 | 5031926 | GGAAUGAACUGAAAGUAGU | 239 |
| MUSK | 4593 | NM_005592 | 5031926 | GAGAUUUCCUGGACUAGAA | 240 |
| NTRK1 | 4914 | NM_002529 | 4585711 | GGACAACCCUUUCGAGUUC | 241 |
| NTRK1 | 4914 | NM_002529 | 4585711 | CCAGUGACCUCAACAGGAA | 242 |
| NTRK1 | 4914 | NM_002529 | 4585711 | CCACAAUACUUCAGUGAUG | 243 |
| NTRK1 | 4914 | NM_002529 | 4585711 | GAAGAGUGGUCUCCGUUUC | 244 |
| NTRK2 | 4915 | NM_006180 | 21361305 | GAACAGAAGUAAUGAAAUC | 245 |
| NTRK2 | 4915 | NM_006180 | 21361305 | GUAAUGCUGUUUCUGCUUA | 246 |
| NTRK2 | 4915 | NM_006180 | 21361305 | GCAAGACACUCCAAGUUUG | 247 |
| NTRK2 | 4915 | NM_006180 | 21361305 | GAAAGUCUAUCACAUUAUC | 248 |
| NTRK3 | 4916 | NM_002530 | 4505474 | GAGCGAAUCUGCUAGUGAA | 249 |
| NTRK3 | 4916 | NM_002530 | 4505474 | GAAGUUCACUACAGAGAGU | 250 |
| NTRK3 | 4916 | NM_002530 | 4505474 | GGUCGACGGUCCAAAUUUG | 251 |
| NTRK3 | 4916 | NM_002530 | 4505474 | GAAUAUCACUUCCAUACAC | 252 |
| PDGFRA | 5156 | NM_006206 | 15451787 | GCACGCCGCUUCCUGAUAU | 253 |
| PDGFRA | 5156 | NM_006206 | 15451787 | CAUCAGAGCUGGAUCUAGA | 254 |
| PDGFRA | 5156 | NM_006206 | 15451787 | GGCCUUACUUUAUUGGAUU | 255 |
| PDGFRA | 5156 | NM_006206 | 15451787 | GAGCUUCACCUAUCAAGUU | 256 |
| PDGFRB | 5159 | NM_002609 | 15451788 | GAAAGGAGACGUCAAAUAU | 257 |
| PDGFRB | 5159 | NM_002609 | 15451788 | GGAAUGAGGUGGUCAACUU | 258 |
| PDGFRB | 5159 | NM_002609 | 15451788 | CAACGAGUCUCCAGUGCUA | 259 |
| PDGFRB | 5159 | NM_002609 | 15451788 | UGACAACGACUAUAUCAUC | 260 |
| PTK2 | 5747 | NM_005607 | 27886592 | GAAGUUGGGUUGUCUAGAA | 261 |
| PTK2 | 5747 | NM_005607 | 27886592 | GGAAAUUGCUUUGAAGUUG | 262 |
| PTK2 | 5747 | NM_005607 | 27886592 | GGUUCAAGCUGGAUUAUUU | 263 |
| PTK2 | 5747 | NM_005607 | 27886592 | GCGAUUAUAUGUUAGAGAU | 264 |
| PTK2B | 2185 | NM_004103 | 27886583 | GAACAUGGCUGACCUCAUA | 265 |
| PTK2B | 2185 | NM_004103 | 27886583 | GGACCACGCUGCUCUAUUU | 266 |
| PTK2B | 2185 | NM_004103 | 27886583 | GGACGAGGACUAUUACAAA | 267 |
| PTK2B | 2185 | NM_004103 | 27886583 | GAGGAAUGCUCGCUACCGA | 268 |
| PTK6 | 5753 | NM_005975 | 27886594 | GAGAAAGUCCUGCCCGUUU | 269 |
| PTK6 | 5753 | NM_005975 | 27886594 | UGAAGAAGCUGCGGCACAA | 270 |
| PTK6 | 5753 | NM_005975 | 27886594 | CCGCGACUCUGAUGAGAAA | 271 |
| PTK6 | 5753 | NM_005975 | 27886594 | UGCCCGAGCUUGUGAACUA | 272 |
| PTK7 | 5754 | NM_002821 | 27886610 | GAGCAUAGUGGGCUGUAUU | 273 |
| PTK7 | 5754 | NM_002821 | 27886610 | ACACUUCGUUGCCACAUUG | 274 |
| PTK7 | 5754 | NM_002821 | 27886610 | GCGCGUAACUGCCUGGUCA | 275 |
| PTK7 | 5754 | NM_002821 | 27886610 | CCGCAGAGCCACAGUGUUU | 276 |
| PTK9 | 5756 | NM_002822 | 40068474 | GAAGAACUACGACAGAUUA | 277 |
| PTK9 | 5756 | NM_002822 | 40068474 | GAAGGAGACUAUUUAGAGU | 278 |
| PTK9 | 5756 | NM_002822 | 40068474 | GAGCGGAUGCUGUAUUCUA | 279 |
| PTK9 | 5756 | NM_002822 | 40068474 | AGAGGAAUUCGAAGACUAA | 280 |
| PTK9L | 11344 | NM_007284 | 40068460 | AGAGAGAGCUCCAGCAGAU | 281 |
| PTK9L | 11344 | NM_007284 | 40068460 | UUAACGAGGUGAAGACAGA | 282 |
| PTK9L | 11344 | NM_007284 | 40068460 | ACACAGAGCCCACGGAUGU | 283 |
| PTK9L | 11344 | NM_007284 | 40068460 | GCUGGGAUCAGGACUAUGA | 284 |
| RET | 5979 | NM_000323 | 21536316 | GCAAAGACCUGGAGAAGAU | 285 |
| RET | 5979 | NM_000323 | 21536316 | GCACACGGCUGCAUGAGAA | 286 |
| RET | 5979 | NM_000323 | 21536316 | GAACUGGCCUGGAGAGAGU | 287 |
| RET | 5979 | NM_000323 | 21536316 | UUAAAUGGAUGGCAAUUGA | 288 |
| ROR1 | 4919 | NM_005012 | 4826867 | GCAAGCAUCUUUACUAGGA | 289 |
| ROR1 | 4919 | NM_005012 | 4826867 | GAGCAAGGCUAAAGAGCUA | 290 |
| ROR1 | 4919 | NM_005012 | 4826867 | GAGAGCAACUUCAUGUAAA | 291 |
| ROR1 | 4919 | NM_005012 | 4826867 | GAGAAUGUCCUGUGUCAAA | 292 |
| ROR2 | 4920 | NM_004560 | 19743897 | GGAACUCGCUGCUGCCUAU | 293 |
| ROR2 | 4920 | NM_004560 | 19743897 | GCAGGUGCCUCCUCAGAUG | 294 |
| ROR2 | 4920 | NM_004560 | 19743897 | GCAAUGUGCUAGUGUACGA | 295 |
| ROR2 | 4920 | NM_004560 | 19743897 | GAAGACAGAAUAUGGUUCA | 296 |
| ROS1 | 6098 | NM_002944 | 19924164 | GAGGAGACCUUCUUACUUA | 297 |
| ROS1 | 6098 | NM_002944 | 19924164 | UUACAGAGGUUCAGGAUUA | 298 |
| ROS1 | 6098 | NM_002944 | 19924164 | GAACAAACCUAAGCAUGAA | 299 |
| ROS1 | 6098 | NM_002944 | 19924164 | GAAAGAGCACUUCAAAUAA | 300 |
| RYK | 6259 | NM_002958 | 11863158 | GAAAGAUGGUUACCGAAUA | 301 |
| RYK | 6259 | NM_002958 | 11863158 | UCACUACGCUCUAUCCUUU | 302 |
| RYK | 6259 | NM_002958 | 11863158 | GGUGAAGGAUAUAGCAAUA | 303 |
| RYK | 6259 | NM_002958 | 11863158 | CGAAGUCCAAGGUUGAAUA | 304 |
| SRC | 6714 | NM_005417 | 38202215 | GAGAACCUGGUGUGCAAAG | 305 |
| SRC | 6714 | NM_005417 | 38202215 | CGUCCAAGCCGCAGACUCA | 306 |
| SRC | 6714 | NM_005417 | 38202215 | CCUCAGGCAUGGCGUACGU | 307 |
| SRC | 6714 | NM_005417 | 38202215 | CCAAGGGCCUCAACGUGAA | 308 |
| SYK | 6850 | NM_003177 | 34147655 | AAUGCCUUGGUUCCAUGGA | 309 |
| SYK | 6850 | NM_003177 | 34147655 | GGAAUAAUCUCAAGAAUCA | 310 |
| SYK | 6850 | NM_003177 | 34147655 | GAACUGGGCUCUGGUAAUU | 311 |
| SYK | 6850 | NM_003177 | 34147655 | GAACAGACAUGUCAAGGAU | 312 |
| TEC | 7006 | NM_003215 | 4507428 | CACCUGAAGUGUUUAAUUA | 313 |
| TEC | 7006 | NM_003215 | 4507428 | GUACAAAGUCGCAAUCAAA | 314 |
| TEC | 7006 | NM_003215 | 4507428 | UGGAGGAGAUUCUUAUUAA | 315 |
| TEC | 7006 | NM_003215 | 4507428 | GUAAUUACGUAACGGGAAA | 316 |
| TEK | 7010 | NM_000459 | 4557868 | GAAAGAAUAUGCCUCCAAA | 317 |
| TEK | 7010 | NM_000459 | 4557868 | UGAAGUACCUGAUAUUCUA | 318 |
| TEK | 7010 | NM_000459 | 4557868 | CGAAAGACCUACGUGAAUA | 319 |
| TEK | 7010 | NM_000459 | 4557868 | GUGCAGAACUCUACGAGAA | 320 |
| TIE | 7075 | NM_005424 | 31543809 | GAGAGGAGGUUUAUGUGAA | 321 |
| TIE | 7075 | NM_005424 | 31543809 | GGGACAGCCUCUACCCUUA | 322 |
| TIE | 7075 | NM_005424 | 31543809 | GAAGUUCUGUGCAAAUUGG | 323 |
| TIE | 7075 | NM_005424 | 31543809 | CAACAUGGCCUCAGAACUG | 324 |
| TNK1 | 8711 | NM_003985 | 4507610 | GAACUGGGUCUACAAGAUC | 325 |
| TNK1 | 8711 | NM_003985 | 4507610 | CGAGAGGUAUCGGUCAUGA | 326 |
| TNK1 | 8711 | NM_003985 | 4507610 | GGCGCAUCCUGGAGCAUUA | 327 |
| TNK1 | 8711 | NM_003985 | 4507610 | GGUCGCACCUUCAAAGUGG | 328 |
| TXK | 7294 | NM_003328 | 4507742 | GAACAUCUAUUGAGACAAG | 329 |
| TXK | 7294 | NM_003328 | 4507742 | UCAAGGCACUUUAUGAUUU | 330 |
| TXK | 7294 | NM_003328 | 4507742 | GGAGAGGAAUGGCUAUAUU | 331 |
| TXK | 7294 | NM_003328 | 4507742 | GGAUAUAUGUGAAGGAAUG | 332 |
| TYK2 | 7297 | NM_003331 | 34222294 | GAGGAGAUCCACCACUUUA | 333 |
| TYK2 | 7297 | NM_003331 | 34222294 | GCAUCCACAUUGCACAUAA | 334 |
| TYK2 | 7297 | NM_003331 | 34222294 | UCAAAUACCUAGCCACACU | 335 |
| TYK2 | 7297 | NM_003331 | 34222294 | CAAUCUUGCUGACGUCUUG | 336 |
| TYRO3 | 7301 | NM_006293 | 27597077 | ACGCUGAGAUUUACAACUA | 337 |
| TYRO3 | 7301 | NM_006293 | 27597077 | GGAUGGCUCCUUUGUGAAA | 338 |
| TYRO3 | 7301 | NM_006293 | 27597077 | GAGAGGAACUACGAAGAUC | 339 |
| TYRO3 | 7301 | NM_006293 | 27597077 | GCGCAUCGAGGCCACAUUG | 340 |
| YES1 | 7525 | NM_005433 | 21071041 | GAAGGACCCUGAUGAAAGA | 341 |
| YES1 | 7525 | NM_005433 | 21071041 | UCAAGAAGCUCAGAUAAUG | 342 |
| YES1 | 7525 | NM_005433 | 21071041 | CAGAAUCCCUCCAUGAAUU | 343 |
| YES1 | 7525 | NM_005433 | 21071041 | GCGACUAGAGGUUAAACUA | 344 |
| EPHA5 | 2044 | NM_004439 | 32967316 | GGAAAGACGUGUCAUAUUA | 345 |
| EPHA5 | 2044 | NM_004439 | 32967316 | GAGAAUGGCUCUUUAGAUA | 346 |
| EPHA5 | 2044 | NM_004439 | 32967316 | GAACAGCCUUCAAGAAAUG | 347 |
| EPHA5 | 2044 | NM_004439 | 32967316 | CCAGAAACAUCUUAAUCAA | 348 |
| SRMS | 6725 | NM_080823 | 22507413 | UCACUGACCUCGCCAAGGA | 349 |
| SRMS | 6725 | NM_080823 | 22507413 | GCAGAAGGGACGGCUCUUU | 350 |
| SRMS | 6725 | NM_080823 | 22507413 | GCUCCAAGAUCCCGGUCAA | 351 |
| SRMS | 6725 | NM_080823 | 22507413 | GAUCAAGGUCAUCAAGUCA | 352 |
| ZAP70 | 7535 | NM_001079 | 46488942 | GACGACAGCUACUACACUG | 353 |
| ZAP70 | 7535 | NM_001079 | 46488942 | GCAAGAAGCAGAUCGACGU | 354 |
| ZAP70 | 7535 | NM_001079 | 46488942 | AGGCAGACACGGAAGAGAU | 355 |
| ZAP70 | 7535 | NM_001079 | 46488942 | GCGAUAACCUCCUCAUAGC | 356 |
| AATK | 9625 | XM_001128317 | 113427081 | GUACAGAGAGGACUACUUC | 357 |
| AATK | 9625 | XM_001128317 | 113427081 | GGUACGAGGUGAUGCAGUU | 358 |
| AATK | 9625 | XM_001128317 | 113427081 | UCAGUGGCCUCAACGAGAA | 359 |
| AATK | 9625 | XM_001128317 | 113427081 | GCAAGUACAGAGAGGACUA | 360 |
| LMTK3 | 114783 | XM_055866 | 37551979 | GAACAGCGAGCAGAUCAAA | 361 |
| LMTK3 | 114783 | XM_055866 | 37551979 | AGAAGACGCCCGAGAGUUG | 362 |
| LMTK3 | 114783 | XM_055866 | 37551979 | GCAAGAUGGUCUCCUUCCA | 363 |
| LMTK3 | 114783 | XM 055866 | 37551979 | CGAGAUGCCACGACUAUUC | 364 |

In some embodiments of disclosed methods, the set of inhibitory RNAs, such as siRNAs, inhibits a subset of the tyrosine kinases set forth in Table 1, such as at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least 40, at least 41, at least 42, at least 43, at least 44, at least 45, at least 46, at least 47, at least 48, at least 49, at least 50, at least 51, at least 52, at least 53, at least 54, at least 55, at least 56, at least 57, at least 58, at least 59, at least 60, at least 61, at least 62, at least 63, at least 64, at least 65, at least 66, at least 67, at least 68, at least 69, at least 70, at least 71, at least 72, at least 73, at least 74, at least 75, at least 76, at least 77, at least 78, at least 79, at least 80, at least 81, at least 82, at least 83, at least 84, at least 85, at least 86, at least 87, at least 88, at least 89, at least 90, or all 91 of the tyrosine kinases listed in Table 1, for example 2-91, 5-91, 10-91, 15-91, 20-91, 25-91, 30-91, 35-91, 40-91, 45-91, 50-91, 55-91, 60-91, 65-91, 70-91, 75-91, or 80-91 of the tyrosine kinases listed in Table 1.

In specific examples, the set of inhibitory RNAs is a set of siRNAs, that inhibit the expression of a subset of the 91 tyrosine kinases listed in Table 1. In some examples, the set of siRNAs comprises 91 siRNAs such that each of the 91 siRNAs inhibits a different one of the 91 human tyrosine kinases listed in Table 1, thus the set of siRNAs can be used to inhibit all of the human tyrosine kinases. In some examples, the set of siRNAs that inhibit the 91 human tyrosine kinases are selected from the nucleic acid sequences set forth in Table 1. In some examples, the set of siRNAs that inhibit the 91 human tyrosine kinases are 91 sets of two, three or four or more siRNAs, wherein each set of two, three or four or more siRNAs inhibit a different one of the 91 human tyrosine kinases. In other words, each of the human tyrosine kinases is targeted by two, three or four or more different siRNAs. In some examples, the 91 sets of four siRNAs comprise siRNAs that are at least set at least 75%, at least 80%, at least 85%, at least 90%, at least 95%, at least 99%, or 100% identical siRNAs set forth in Table 1. In other examples, the inhibitory RNAs used in the disclosed methods consist of a set of siRNAs that are at least 75%, at least 80%, at least 85%, at least 90%, at least 95%, at least 99%, or 100% identical to the siRNAs set forth in Table 1. In a specific example, the 91 sets of at least two, such at least 3, at least four of more siRNAs comprise the siRNAs set forth in Table 1. In another specific example, the 91 sets of four siRNAs consist of the siRNAs set forth in Table 1.

In some examples, the inhibitory RNAs described herein contain one or more modifications to enhance nuclease resistance and/or increase activity of the compound. Modified inhibitory RNAs include those comprising modified backbones or non-natural internucleoside linkages.

Examples of modified oligonucleotide backbones include, but are not limited to, phosphorothioates, chiral phosphorothioates, phosphorodithioates, phosphotriesters, aminoalkylphosphotriesters, methyl and other alkyl phosphonates including 3′-alkylene phosphonates and chiral phosphonates, phosphinates, phosphoramidates including 3′-amino phosphoramidate and aminoalkylphosphoramidates, thionophosphoramidates, thionoalkyl-phosphonates, thionoalkylphosphotriesters, and boranophosphates having normal 3′-5′ linkages, 2′-5′ linked analogs of these, and those having inverted polarity wherein the adjacent pairs of the nucleoside units are linked 3′-5′ to 5′-3′ or 2′-5′ to 5′-2′. Representative U.S. patents that teach the preparation of the above phosphorus-containing linkages include, but are not limited to, U.S. Pat. Nos. 3,687,808; 4,469,863; 4,476,301; 5,023,243; 5,177,196; 5,188,897; 5,264,423; 5,276,019; 5,278,302; 5,286,717; 5,321,131; 5,399,676; 5,405,939; 5,453,496; 5,455,233; 5,466,677; 5,476,925; 5,519,126; 5,536,821; 5,541,306; 5,550,111; 5,563,253; 5,571,799; 5,587,361; and 5,625,050.

Examples of modified oligonucleotide backbones that do not include a phosphorus atom therein have backbones that are formed by short chain alkyl or cycloalkyl internucleoside linkages, mixed heteroatom and alkyl or cycloalkyl internucleoside linkages, or one or more short chain heteroatomic or heterocyclic internucleoside linkages. These include those having morpholino linkages (formed in part from the sugar portion of a nucleoside); siloxane backbones; sulfide, sulfoxide and sulfone backbones; formacetyl and thioformacetyl backbones; methylene formacetyl and thioformacetyl backbones; alkene containing backbones; sulfamate backbones; methyleneimino and methylenehydrazino backbones; sulfonate and sulfonamide backbones; amide backbones; and others having mixed N, O, S and CH₂ component parts. Representative U.S. patents that teach the preparation of the above oligonucleosides include, but are not limited to, U.S. Pat. Nos. 5,034,506; 5,166,315; 5,185,444; 5,214,134; 5,216,141; 5,235,033; 5,264,562; 5,264,564; 5,405,938; 5,434,257; 5,466,677; 5,470,967; 5,489,677; 5,541,307; 5,561,225; 5,596,086; 5,602,240; 5,610,289; 5,602,240; 5,608,046; 5,610,289; 5,618,704; 5,623,070; 5,663,312; 5,633,360; 5,677,437; and 5,677,439.

In some embodiments, both the sugar and the internucleoside linkage of the nucleotide units of the inhibitory RNA are replaced with novel groups. One such modified compound is an oligonucleotide mimetic referred to as a peptide nucleic acid (PNA). In PNA compounds, the sugar-backbone of an oligonucleotide is replaced with an amide containing backbone, in particular an aminoethylglycine backbone. The bases are retained and are bound directly or indirectly to aza nitrogen atoms of the amide portion of the backbone. Representative U.S. patents that teach the preparation of PNA compounds include, but are not limited to, U.S. Pat. Nos. 5,539,082; 5,714,331; and 5,719,262, each of which is herein incorporated by reference. Further teaching of PNA compounds can be found in Nielsen et al. (Science 254, 1497-1500, 1991).

Modified inhibitory RNAs can also contain one or more substituted sugar moieties. In some examples, the inhibitory RNAs can comprise one of the following at the 2′ position: OH; F; O-, S-, or N-alkyl; O-, S-, or N-alkenyl; O-, S- or N-alkynyl; or O-alkyl-O-alkyl, wherein the alkyl, alkenyl and alkynyl may be substituted or unsubstituted C₁ to C₁₀ alkyl or C₂ to C₁₀ alkenyl and alkynyl. In other embodiments, the inhibitory RNAs comprise one of the following at the 2′ position: C₁ to C₁₀ lower alkyl, substituted lower alkyl, alkaryl, aralkyl, O-alkaryl or O-aralkyl, SH, SCH₃, OCN, Cl, Br, CN, CF₃, OCF₃, SOCH₃, SO₂CH₃, ONO₂, NO₂, N₃, NH₂, heterocycloalkyl, heterocycloalkaryl, aminoalkylamino, polyalkylamino, substituted silyl, an RNA cleaving group, a reporter group, an intercalator, a group for improving the pharmacokinetic properties of an oligonucleotide, or a group for improving the pharmacodynamic properties of an oligonucleotide, and other substituents having similar properties. In one example, the modification includes 2′-methoxyethoxy (also known as 2′-O-(2-methoxyethyl) or 2′-MOE) (Martin et al., Helv. Chim. Acta., 78, 486-504, 1995). In other examples, the modification includes 2′-dimethylaminooxyethoxy (also known as 2′-DMAOE) or 2′-dimethylaminoethoxyethoxy (also known in the art as 2′-O-dimethylaminoethoxyethyl or 2′-DMAEOE).

Similar modifications can also be made at other positions of the compound. Inhibitory RNAs can also have sugar mimetics such as cyclobutyl moieties in place of the pentofuranosyl sugar. Representative United States patents that teach the preparation of modified sugar structures include, but are not limited to, U.S. Pat. Nos. 4,981,957; 5,118,800; 5,319,080; 5,359,044; 5,393,878; 5,446,137; 5,466,786; 5,514,785; 5,519,134; 5,567,811; 5,576,427; 5,591,722; 5,597,909; 5,610,300; 5,627,053; 5,639,873; 5,646,265; 5,658,873; 5,670,633; and 5,700,920.

Inhibitory RNAs can also include base modifications or substitutions. As used herein, “unmodified” or “natural” bases include the purine bases adenine (A) and guanine (G), and the pyrimidine bases thymine (T), cytosine (C) and uracil (U). Modified bases include other synthetic and natural bases, such as 5-methylcytosine (5-me-C), 5-hydroxymethyl cytosine, xanthine, hypoxanthine, 2-aminoadenine, 6-methyl and other alkyl derivatives of adenine and guanine, 2-propyl and other alkyl derivatives of adenine and guanine, 2-thiouracil, 2-thiothymine and 2-thiocytosine, 5-halouracil and cytosine, 5-propynyl uracil and cytosine, 6-azo uracil, cytosine and thymine, 5-uracil (pseudouracil), 4-thiouracil, 8-halo, 8-amino, 8-thiol, 8-thioalkyl, 8-hydroxyl and other 8-substituted adenines and guanines, 5-halo particularly 5-bromo, 5-trifluoromethyl and other 5-substituted uracils and cytosines, 7-methylguanine and 7-methyladenine, 8-azaguanine and 8-azaadenine, 7-deazaguanine and 7-deazaadenine and 3-deazaguanine and 3-deazaadenine. Further modified bases have been described (see, for example, U.S. Pat. No. 3,687,808; and Sanghvi, Y. S., Chapter 15, Antisense Research and Applications, pages 289-302, Crooke, S. T. and Lebleu, B., ed., CRC Press, 1993). Certain of these modified bases are useful for increasing the binding affinity of inhibitory RNAs. These include 5-substituted pyrimidines, 6-azapyrimidines and N-2, N-6 and O-6 substituted purines, including 2-aminopropyladenine, 5-propynyluracil and 5-propynylcytosine. 5-methylcytosine substitutions have been shown to increase nucleic acid duplex stability by 0.6-1.2° C. Representative U.S. patents that teach the preparation of modified bases include, but are not limited to, U.S. Pat. Nos. 4,845,205; 5,130,302; 5,134,066; 5,175,273; 5,367,066; 5,432,272; 5,457,187; 5,459,255; 5,484,908; 5,502,177; 5,525,711; 5,552,540; 5,587,469; 5,594,121, 5,596,091; 5,614,617; 5,681,941; and 5,750,692.

### C. Detection of Cellular Proliferation and Viability

The methods provided herein further involve determining if proliferation and/or viability of cells obtained from a subject (such as white blood cells and/or bone marrow cells) is inhibited by the introduction of inhibitory RNAs, such as siRNAs, that specifically inhibit the expression of tyrosine kinases (such as human tyrosine kinases) into the cells. Following introduction of the inhibitory RNAs into the cells, the cells are assayed proliferation and/or viability, for example by assaying one or more of growth, apoptosis and necrosis.

In one example for instance florescent microscopy following labeling with acridine orange and ethidium bromide is used. An increase in apoptosis or decrease in viability of cells contacted with an inhibitory RNA relative to a control identifies the tyrosine kinase targeted by the inhibitory RNA as one that has aberrant kinase activity. Similarly, a reduction in cellular growth and/or proliferation of cells contacted with an inhibitory RNA relative to a control, such as a sample of cells not contacted with an inhibitory RNA, identifies the tyrosine kinase targeted by the siRNA as one that has aberrant kinase activity. Many methods for measuring cellular proliferation and/or viability are known to those of ordinary skill in the art.

For example, floating cells can be collected by trypsinization and washed three times in PBS. Aliquots of cells are then centrifuged. The pellet is resuspended in media and a dye mixture containing acridine orange and ethidium bromide prepared in PBS and mixed gently. The mixture then can be placed on a microscope slide and examined for morphological features of apoptosis. An increase in apoptosis relative to a control, such as a sample of cells not contacted with an inhibitory RNA, identifies the tyrosine kinase targeted as one that has aberrant kinase activity. An increase in apoptosis relative to a control can be at least about 10%, such as at least about 20%, at least about 30%, at least about 40%, at least about 50%, at least about 60%, at least about 70%, at least about 80%, at least about 90%, at least about 100%, at least about 150%, at least about 200%, at least about 250%, at least about 300%, at least about 350%, at least about 400%, at least about 500%, or greater then 500%, for example between about 10% and about 60%, between about 30% and about 90%, between about 60% and about 200%, between about 150% and about 400%, or between about 300% and about 500%.

Apoptosis also can be quantified by measuring an increase in DNA fragmentation in cells that have been treated with test compounds. Commercial photometric enzyme immunoassays (EIA) for the quantitative in vitro determination of cytoplasmic histone-associated-DNA-fragments (mono- and oligo-nucleosomes) are available (for example, Cell Death Detection ELISA, Boehringer Mannheim). The Boehringer Mannheim assay is based on a sandwich-enzyme-immunoassay principle, using mouse monoclonal antibodies directed against DNA and histones, respectively. This allows the specific determination of mono- and oligo-nucleosomes in the cytoplasmic fraction of cell lysates. According to the vendor, apoptosis is measured as follows: The sample (cell-lysate) is placed into a streptavidin-coated microtiter plate (“MTP”). Subsequently, a mixture of anti-histone-biotin and anti-DNA peroxidase conjugates is added and incubated for two hours. During the incubation period, the anti-histone antibody binds to the histone-component of the nucleosomes and simultaneously fixes the immunocomplex to the streptavidin-coated MTP via its biotinylation. Additionally, the anti-DNA peroxidase antibody reacts with the DNA component of the nucleosomes. After removal of unbound antibodies by a washing step, the amount of nucleosomes is quantified by the peroxidase retained in the immunocomplex. Peroxidase is determined photometrically with ABTS7 (2,2′-Azido-[3-ethylbenzthiazolin-sulfonate]) as substrate. An increase in apoptosis relative to a control, such as a sample of cells not contacted with an inhibitory RNA, identifies the tyrosine kinase targeted as one that has aberrant kinase activity. An increase in apoptosis relative to a control can be at least about 10%, such as at least about 20%, at least about 30%, at least about 40%, at least about 50%, at least about 60%, at least about 70%, at least about 80%, at least about 90%, at least about 100%, at least about 150%, at least about 200%, at least about 250%, at least about 300%, at least about 350%, at least about 400%, at least about 500%, or greater then 500%, for example between about 10% and about 60%, between about 30% and about 90%, between about 60% and about 200%, between about 150% and about 400%, or between about 300% and about 500%.

In another example, proliferation and/or cell viability is measured by incorporation of radioactive tritium into proliferating cells. In contrast radioactive tritium is not incorporated into non-viable cells. For example, cells obtained from a subject, such as blood cells and/or bone marrow cells are cultured for a period of time (such as from at least about 2 hours to at least about 4 days, for example at least about 18 hours), with 0.25 μCi of [³H] thymidine, harvested onto glass filters, and radionucleotide incorporation measured with a liquid scintillation counter. The amount of [³H] thymidine incorporated into the cells is proportional to the proliferation of the cells. A decrease in proliferation relative to a control, such as a sample of cells not contacted with an inhibitory RNA, identifies the tyrosine kinase targeted as one that has aberrant kinase activity. A decrease in cell proliferation relative to a control can be at least about 10%, such as at least about 20%, at least about 30%, at least about 40%, at least about 50%, at least about 60%, at least about 70%, at least about 80%, at least about 90%, at least about 100%, at least about 150%, at least about 200%, at least about 250%, at least about 300%, at least about 350%, at least about 400%, at least about 500%, or greater then 500%, for example between about 10% and about 60%, between about 30% and about 90%, between about 60% and about 200%, between about 150% and about 400%, or between about 300% and about 500%.

Another example of a method of measuring cell viability and/or proliferation by the incorporation of bromodeoxyuridine (BrdU), a thymidine analog, into newly synthesized DNA strands of actively proliferating cells. In contrast BrdU is not incorporated into non-viable cells. BrdU is detected immunochemically allowing the assessment of the population of cells, which are actively synthesizing DNA, for example using the CALBIOCHEM® BrdU Cell Proliferation Assay. According to the manufacturer, BrdU is added to cells and will be incorporated into the DNA of dividing cells. The cells are fixed and permeabilized and the DNA denatured to enable an anti-BrdU monoclonal antibody to bind the BrdU containing DNA. In some examples, an anti-BrdU monoclonal antibody is allowed to incubate with the cells for 1 hour, during which time it binds to any incorporated BrdU. Unbound antibody is washed away and horseradish peroxidase-conjugated goat anti-mouse is added, which binds to the detector antibody. The horseradish peroxidase catalyzes the conversion of the chromogenic substrate tetra-methylbenzidine (TMB) from a colorless solution to a blue solution (or yellow after the addition of stopping reagent), the intensity of which is proportional to the amount of incorporated BrdU in the cells. The colored reaction product is quantified using a spectrophotometer. A decrease in the amount of BrdU incorporated relative to a control, such as a sample of cells not contacted with an inhibitory RNA, identifies the tyrosine kinase targeted as one that has aberrant kinase activity. A decrease in the amount of BrdU incorporated relative to a control can be at least about 10%, such as at least about 20%, at least about 30%, at least about 40%, at least about 50%, at least about 60%, at least about 70%, at least about 80%, at least about 90%, at least about 100%, at least about 150%, at least about 200%, at least about 250%, at least about 300%, at least about 350%, at least about 400%, at least about 500%, or greater then 500%, for example between about 10% and about 60%, between about 30% and about 90%, between about 60% and about 200%, between about 150% and about 400%, or between about 300% and about 500%.

Another method of measuring cell viability is the ability of cells to exclude propidium iodide (PI). The integrity of the plasma membrane and hence the viability of cell can be assessed by determining the ability of cells to exclude PI from the interior of the cells. Typically, cells are collected by centrifugation, washed once with PBS, and resuspended in PBS containing 1 μg of PI/ml. The level of PI incorporation into cells can be quantified by flow cytometry, for example on a FACSCAN® flow cytometer GUAVA TECHNOLOGIES® flow cytometer. A decrease in the number of cells that can exclude PI relative to a control, such as a sample of cells not contacted with an inhibitory RNA, identifies the tyrosine kinase targeted as one that has aberrant kinase activity. A decrease in the number of cells that can exclude relative to a control can be at least about 10%, such as at least about 20%, at least about 30%, at least about 40%, at least about 50%, at least about 60%, at least about 70%, at least about 80%, at least about 90%, at least about 100%, at least about 150%, at least about 200%, at least about 250%, at least about 300%, at least about 350%, at least about 400%, at least about 500%, or greater then 500%, for example between about 10% and about 60%, between about 30% and about 90%, between about 60% and about 200%, between about 150% and about 400%, or between about 300% and about 500%.

In other examples, cell proliferation is measured with a 3-(4,5-dimethylthiazol-2-yl)-5-(3-carboxymethoxyphenyl)-2-(4-sulfophenyl)-2H-tetrazolium (MTS) cell proliferation assay. An MTS cell proliferation assay is a calorimetric method to identify the cytotoxic potential of a test item. After contacting a sample containing cells with MTS, the formation of a soluble formazan (which is a product MTS) is measured after a period of time. Methods for measuring formazan, such as spectroscopic methods, are well known in the art. The amount of soluble formazan is directly proportional to the number of live cells in the sample. Thus, if the amount of soluble formazan increases as function of time the cell are proliferating. Conversely, if the amount of soluble formazan decreases as function of time the cell are proliferating. The rate of cell proliferation can be calculated by determining the change in the amount of formazan a first time point to the amount of at a second later time point. Furthermore, A decrease in the formation of formazan relative to a control, such as a sample of cells not contacted with an inhibitory RNA, identifies the tyrosine kinase targeted as one that has aberrant kinase activity. A decrease in the amount of formazan relative to a control can be at least about 10%, such as at least about 20%, at least about 30%, at least about 40%, at least about 50%, at least about 60%, at least about 70%, at least about 80%, at least about 90%, at least about 100%, at least about 150%, at least about 200%, at least about 250%, at least about 300%, at least about 350%, at least about 400%, at least about 500%, or greater then 500%, for example between about 10% and about 60%, between about 30% and about 90%, between about 60% and about 200%, between about 150% and about 400%, or between about 300% and about 500%.

### EXAMPLES

### Example 1

### Materials and Methods

This example describes exemplary procedures and reagents used in the Examples 2-5.

### Cell Culture:

K562 cells were obtained from American Type Culture Collection (Manassas, Va.). CMK and HEL cells were obtained from the German National Resource Centre for Biological Material (DSMZ). All cells were maintained in RPMI-1640 medium supplemented with 10% FBS (ATLANTA BIOLOGICALS®, Lawrenceville, Ga.), L-glutamine, and penicillin/streptomycin (INVITROGEN®, Carlsbad, Calif.). For proliferation assays, cells were incubated for 72 hours in the presence of JAK Inhibitor I, JAK3 inhibitor III, AG-490, PP2, or Src Kinase Inhibitor I (EMD BIOSCIENCES®, San Diego, Calif.), and the number of viable cells was determined with the CELLTITER 96® AQᵤₑₒᵤₛ One solution cell proliferation assay (PROMEGA®, Madison, Wis.). For HMC1.1 cell stimulation, cells were serum starved overnight in RPMI supplemented with 0.1% bovine serum albumin, L-glutamine, and penicillin/streptomycin. The following day, cells were stimulated for five minutes with 100 ng/ml recombinant stem cell factor (Peprotech, Rocky Hill, N.J.).

### Optimization of Electroporation Conditions:

CMK cells (1.5×10⁵) were washed one time in OPTIMEM® (INVITROGEN®) and resuspended in 75 μl of SIPORT® buffer (AMBION®, Austin, Tex.). Cells were incubated with BLOCK-IT® Fluorescent Oligo (INVITROGEN®) at a 1 to 100 dilution and transferred to a 1 mm cuvette (Bio-Rad, Hercules, Calif.). Electroporation was carried out at 0 V, 100 V, 200 V, 300 V, and 400 V (all 100 μsec, 1 pulse) for determination of optimal voltage. This procedure was repeated at the optimal voltage for 100 μsec, 150 μsec, 200 μsec, and 250 μsec for 1 pulse or 2 pulses for determination of optimal pulse length. All samples were washed in PBS, stained with propidium iodide (PI) (Guava viability reagent) for viability analysis (GUAVA TECHNOLOGIES®, Hayward, Calif.), and analyzed by flow cytometry for fluorescent shift induced by the FITC-labeled oligo (FACSARIA®, BD BIOSCIENCES, San Jose, Calif.). For evaluation of gene knockdown, the above procedure was repeated at the optimal conditions using siRNA targeting GAPDH (DHARMACOM®, Lafayette, Colo.) at 500 or 1000 nM. GAPDH gene silencing was determined at 48 hours post-electroporation by immunoblot analysis for GAPDH and β-actin as a loading control.

siRNA Knockdown using Tyrosine Kinase Library:

CMK or HMC1.1 cells (10⁷) were washed one time in OPTIMEM (INVITROGEN®) and resuspended in 4.2 ml of SIPORT buffer (AMBION®). Cells were aliquoted at 42 μl per well onto a 96-well electroporator (AMBION®) and 2 μl of siRNA at 20 μM was added to each well. The tyrosine kinase library used in this study contains 4 siRNA targeting constructs per well (purchased from DHARMACOM®), were manually added single and pooled non-specific siRNA as well as siRNA pools (4 constructs per target) against ephrin type-A receptor (EPHA)5, EPHA6, src-related kinase lacking C-terminal regulatory tyrosine and N-terminal myristylation (SRMS), apoptosis-associated tyrosine kinase (AATK), lemur tyrosine kinase (LMTK)₃, N-RAS, K-RAS (all from DHARMACOM®). These were added separately because they are not included in the standard tyrosine kinase library. Cells were electroporated at 2220 V (equivalent of 300 V per well), 100 μsec, 2 pulses and 15,000 cells per well were replated using a Hydra 96-channel automated pipettor (Matrix Technologies, Hudson, N.H.) into triplicate plates containing 100 μl per well of standard culture media. For determination of cell viability and proliferation, cells were subjected to the CELLTITER® 96 AQᵤₑₒᵤₛ One solution cell proliferation assay (MTS) (PROMEGA®) All values were normalized to the mean of the two non-specific siRNA control wells.

### Confirmation of RNAi Silencing:

For confirmation of efficient knockdown in HMC1.1 cells, siRNA targeting JAK1, JAK2, JAK3, EPHA4, PTK2, PTK2B, PTK6, PTK9, LTK, LYN, SRC, and c-KIT, was transfected at 300 V, 100 μsec, 2 pulses and whole cell lysates (as below) or total cellular RNA (QIAGEN®, Valencia, Calif.) were harvested after 48 hours using standard procedures. Total RNA was used to synthesize cDNA (INVITROGEN® SUPERSCRIPT III®) and quantitative PCR against each respective gene as well as GAPDH (see Table 3) was performed on each sample using SYBR® Green qPCR SuperMix (INVITROGEN®) and a DNA Engine Opticon 2 system for real-time PCR (Bio-Rad).

TABLE 3
Primers for qPCR

SEQ ID NO:

| | | |
|---|---|---|
| EPHA4QPCRF1 | CATGAAGCTGAACACCGAGATCC | 365 |
| EPHA4QPCRR1 | ACACAGGAGCCTCGAACTTCC | 366 |
| JAK1QPCRF1 | AGCGATGTCCTTACCACACC | 367 |
| JAK1QPCRR1 | CCTCAACACACTCAGGAGCA | 368 |
| JAK2QPCRF2 | ATCTGGTATCCACCCAACCA | 369 |
| JAK2QPCRR2 | CTGTTGCTGCCACTGCAATACC | 370 |
| JAK3QPCRF1 | AGTCCAACCTGATCGTGGTC | 371 |
| JAK3QPCRR1 | TGGCATCCATGACCTTCAGCA | 372 |
| LYNQPCRF1 | ACCAAGGTGGCTGTGAAAAC | 373 |
| LYNQPCRR1 | ACCTTCATCGCTCTTCAGGA | 374 |
| PTK2QPCRF1 | CTGGTGCAATGGAGCGAGTATT | 375 |
| PTK2QPCRR1 | AGCCAGTGAACCTCCTCTGA | 376 |
| PTK2BQPCRF2 | ACAGGACCACGCTGCTCTAT | 377 |
| PTK2BQPCRR2 | GCCCCACTTCCTTTTCTAGG | 378 |
| PTK6QPCRF1 | GCGTGTGCTCCTCTCCTTAC | 379 |
| PTK6QPCRR1 | CCAAGCTGAACTGGGAAGAG | 380 |
| PTK9QPCRF1 | CCCAAGGATTCAGCTCGTTA | 381 |
| PTK9QPCRR1 | GCAGTCAACTCATCCCCATT | 382 |
| SRCQPCRF2 | AGGCATCATGGAAAGACTGG | 383 |
| SRCQPCRR2 | GCTGGCTCTGAAGGTCAAAC | 384 |

Quantitative PCR cycle values were converted to arbitrary qPCR units based on a standard curve for each gene or GAPDH, each value was normalized to its respective GAPDH value, and percent knockdown was calculated based on the following formula: (non-specific—gene-specific)/non-specific×100. Whole cell lysates were separated by SDS-PAGE and analyzed by immunoblotting using antibodies against JAK1 (BD BIOSCIENCES), JAK2, EPHA4, LYN, SRC (Millipore, Billerica, Mass.), JAK3, PTK6, LTK (SANTA CRUZ BIOTECHNOLOGY®, Santa Cruz, Calif.), PTK2, PTK2B (CELL SIGNALING TECHNOLOGY®, Danvers, Mass.), and β-actin (Millipore). Densitometry was performed and the value for each band was normalized to its respective β-actin loading control and the above formula was used to calculate percent knockdown.

### Immunoblotting:

For direct immunoblots, cells were lysed in sample buffer (75 mM Tris pH 6.8, 3% SDS, 15% glycerol, 8% β-mercaptoethanol, 0.1% bromophenol blue). For immunoprecipitation, cells were lysed in 1×cell lysis buffer (CELL SIGNALING TECHNOLOGY®) supplemented with tyrosine phosphatase inhibitor cocktail, Aprotinin, and 4-(2-aminoethyl)benzene-sulfonyl fluoride hydrochloride (AEBSF) (Sigma, St Louis, Mo.) and incubated overnight with antibodies specific for c-KIT (EMD BIOSCIENCES®), JAK1 (BD BIOSCIENCES®), or JAK3 (SANTA CRUZ BIOTECHNOLOGY®). Immune complexes were precipitated with protein A-sepharose beads (Amersham Biosciences, Piscataway, N.J.), washed three times in lysis buffer, resuspended in sample buffer, and immunoprecipitations as well as whole cell lysates were separated by SDS-PAGE. Proteins were transferred to PVDF membranes (Millipore) and subjected to immunoblot analysis with the above antibodies specific for c-KIT, JAK1, JAK3, as well as phospho-JAK1 (CELL SIGNALING TECHNOLOGY®), GAPDH (SANTA CRUZ BIOTECHNOLOGY®), or β-actin (EMD BIOSCIENCES®)

### Sequencing Analysis:

JAK1 and JAK3 pseudokinase and activation loop domains were sequenced according to protocols described in Walters et al., Cancer Cell 10:65-75, 2006 and Levine et al., Cancer Cell 7:387-397, 2005.

### Statistical Analyses:

For tyrosine kinase siRNA library knockdown experiments, a Student's t test was carried out for each well in comparison to both single and pooled non-specific siRNA controls. The mean of the two-tailed p-value was determined for consideration of significance and data points with p-value less than 0.05 and mean value less than 70% of non-specific controls were considered significant. For cell proliferation assays, a Student's t test was carried out for each dose point comparing HMC1.1 to K562 cell viability.

### Example 2

### Electroporation of CMK Cells with siRNA

This example describes the optimization of electroporation conditions for the delivery of siRNA molecules into CMK cells.

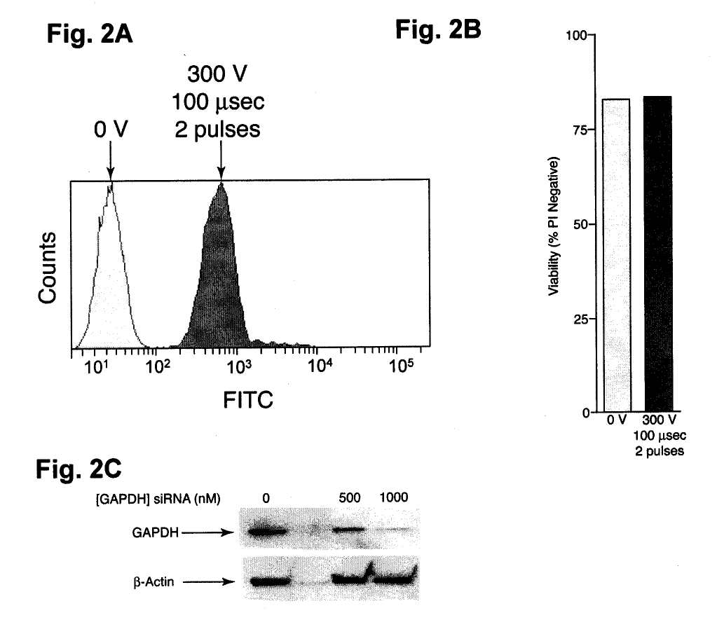

FITC-labeled siRNA molecules were incubated with CMK cells and delivered over an increasing range of voltage to the cells in single pulses and at constant pulse duration. Two days following electroporation, cells were analyzed for viability by propidium iodide exclusion. Incorporation of the FITC-labeled siRNA was determined by flow cytometry. The voltage at which cells exhibited maximal incorporation of FITC-labeled siRNA and still exhibited minimal decrease in cell viability was chosen for the second step of optimization. Using this voltage (300 V in the case of CMK cells) cells were again incubated with FITC-labeled siRNA and exposed to single and double pulses of an increasing range of pulse duration. Cells were again analyzed by flow cytometry for viability and FITC incorporation. It was determined that optimal conditions for siRNA delivery into CMK cells was 300 V, 100 μsec, 2 pulses (FIGS. 2A and 2B). For final confirmation of efficient siRNA delivery and target reduction, the above electroporation conditions were used to deliver 500 or 1000 nM GAPDH-targeting siRNA into CMK cells. Immunoblot analysis was performed at 48 hours post-electroporation for GAPDH and β-actin and demonstrated 93% knockdown of GAPDH in CMK cells using 1000 nM siRNA at these parameters (FIG. 2C).

### Example 3

### Functional Profiling of CMK Cells Using a Tyrosine Kinase siRNA Library

This example describes trials to determine that a library of siRNAs introduced by electroporation can be used to screen for activating mutations in tyrosine kinases in CMK cells.

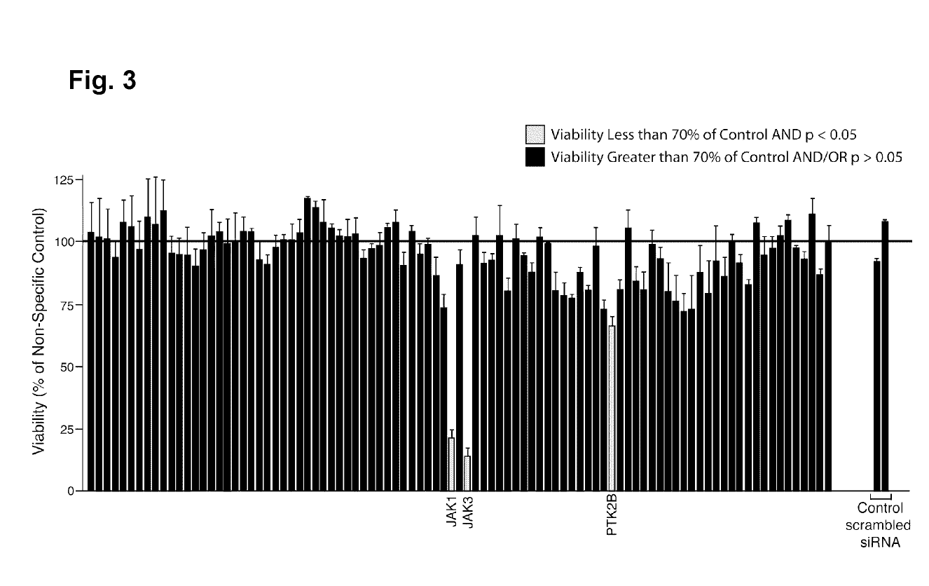

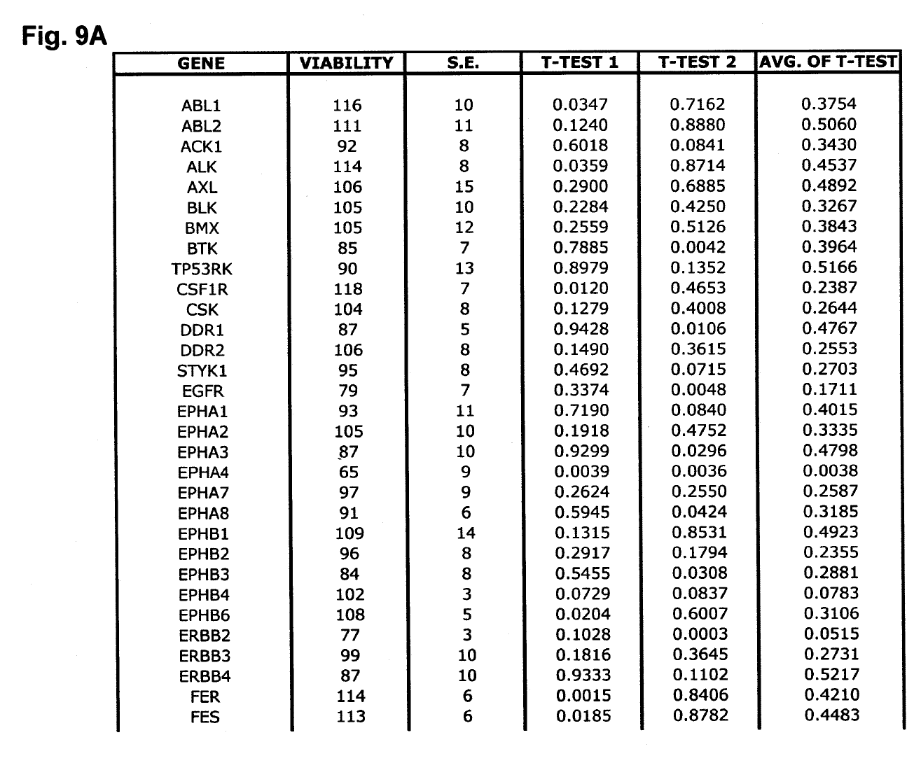

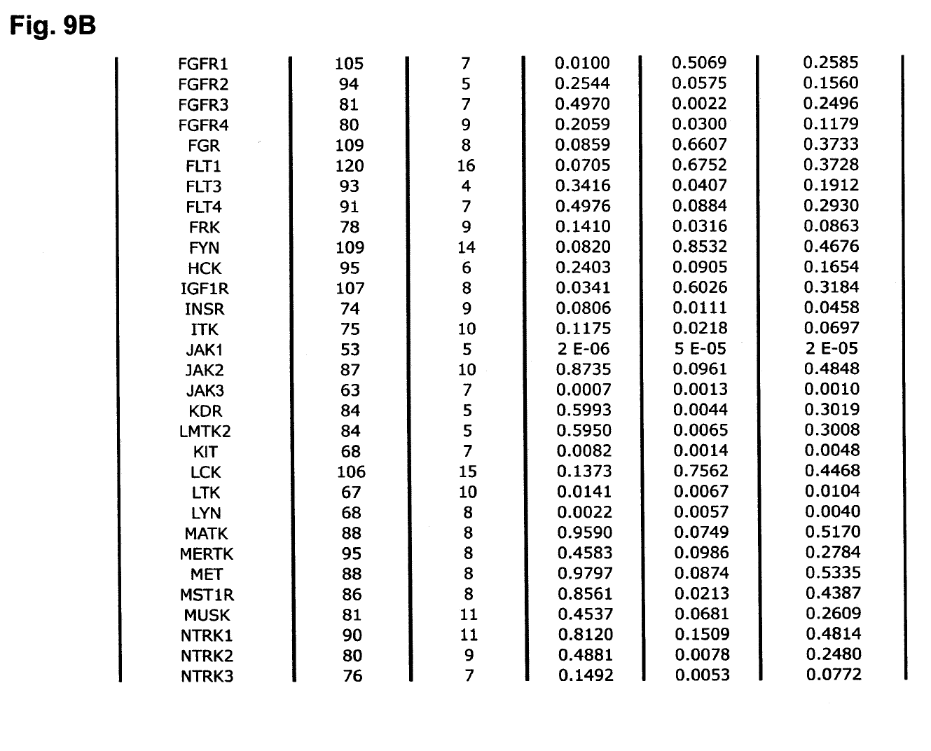

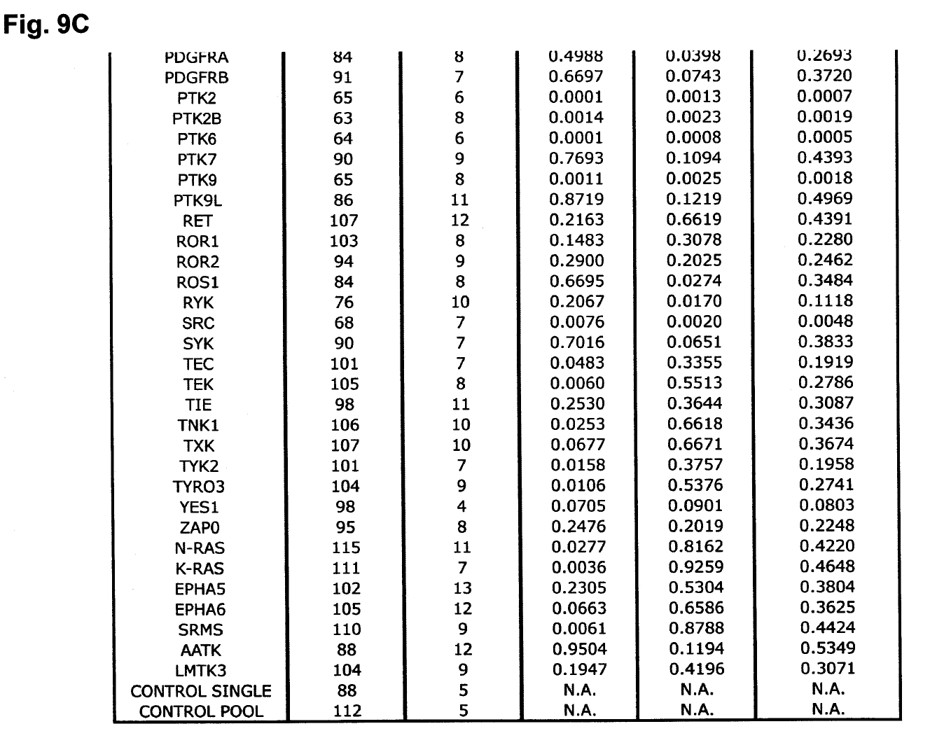

CMK cells harbor an activating mutation in the tyrosine kinase JAK3 (A572V mutation) (see Walters et al., Cancer Cell 10: 65-75, 2006). To determine whether functional profiling with a tyrosine kinase siRNA library could be an effective tool for target identification in malignant cells, CMK cells were tested using this tyrosine kinase siRNA library with the expectation that knockdown of JAK3, as well as any other critical components in the JAK3 signaling cascade, would reduce the viability and proliferation of CMK cells. Using the transfection conditions as optimized in Example 3, siRNAs were introduced that individually target each member of the tyrosine kinase family. In addition, siRNAs targeting the N-RAS and K-RAS oncogenes, and two non-specific siRNA controls into CMK cells. Each siRNA well in this library contained a pool of four individual siRNA molecules that were each designed against a different region of the target transcript (i.e. each tyrosine kinase was the target of four siRNAs). Cell viability and proliferation was assessed four days after electroporation (FIG. 1). As expected, siRNA directed against JAK3 significantly reduced the viability of CMK cells (FIG. 3). This was consistent with earlier findings that CMK cells depend on JAK3^{A572V} function and activity for viability and proliferation (see Walters et al., Cancer Cell 10: 65-75, 2006). Surprisingly, it was also observed that siRNA targeting JAK1 yielded an equally significant reduction in the viability and proliferation of CMK cells (FIG. 3), given that JAK1 had not been detected by phospho-proteomic profiling and did not contain any activating mutations as assessed by sequencing. The sequence of the predicted tryptic phosphopeptide containing the JAK1 activation loop phosphorylation site is EY*YTVK (SEQ ID NO: 384). This six amino acid peptide is almost certainly too hydrophilic to bind to the C18 resin that had previously used for peptide purification and analysis. Thus, it was unexpected to have detected this phosphopeptide in previous mass spectrophotometric analysis of the CMK cell lysates. Thus, the screen was capable of identifying potential therapeutic target that other methods of detection cannot. However, the current siRNA profiling data suggested that the oncogenic signaling from JAK3^{A572V} in CMK cells depends on JAK1, a finding that is consistent with the known association of JAK1 and JAK3 downstream of numerous cytokine receptors. While JAK3 and JAK1-specific siRNA reduced the growth and viability of CMK cells far more significantly than any other siRNA molecules, a few other targets did modulate CMK cell growth to a more subtle extent (a complete list of viability values and significance calculations can be found in the table shown in FIG. 9).

### Example 4

### Functional Profiling of HMC1.1 Cells Using a Tyrosine Kinase siRNA Library

This example demonstrates that a library of siRNAs introduced by electroporation can be used to screen for activating mutations in tyrosine kinases in HMC1.1 cells.

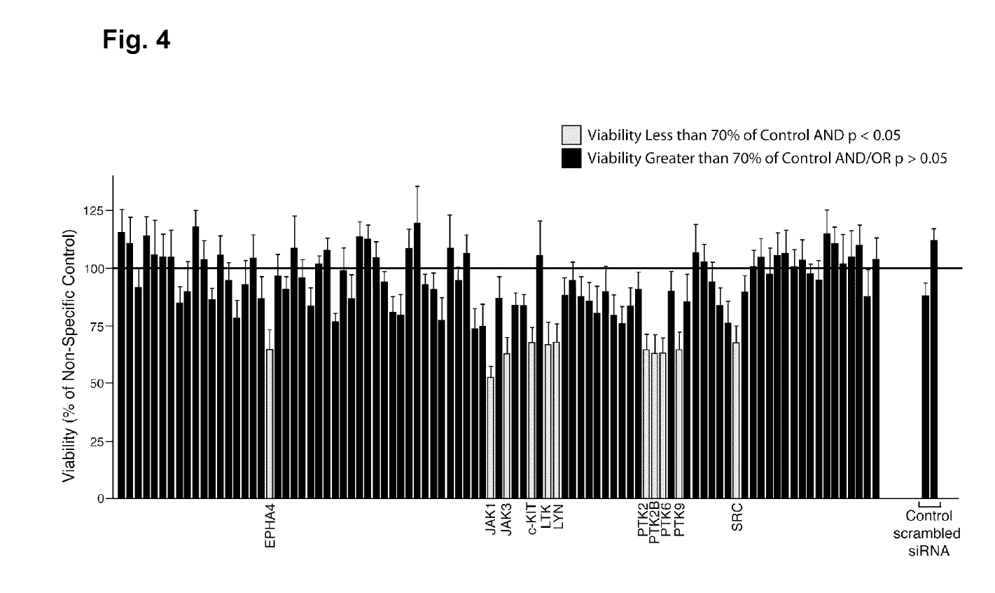

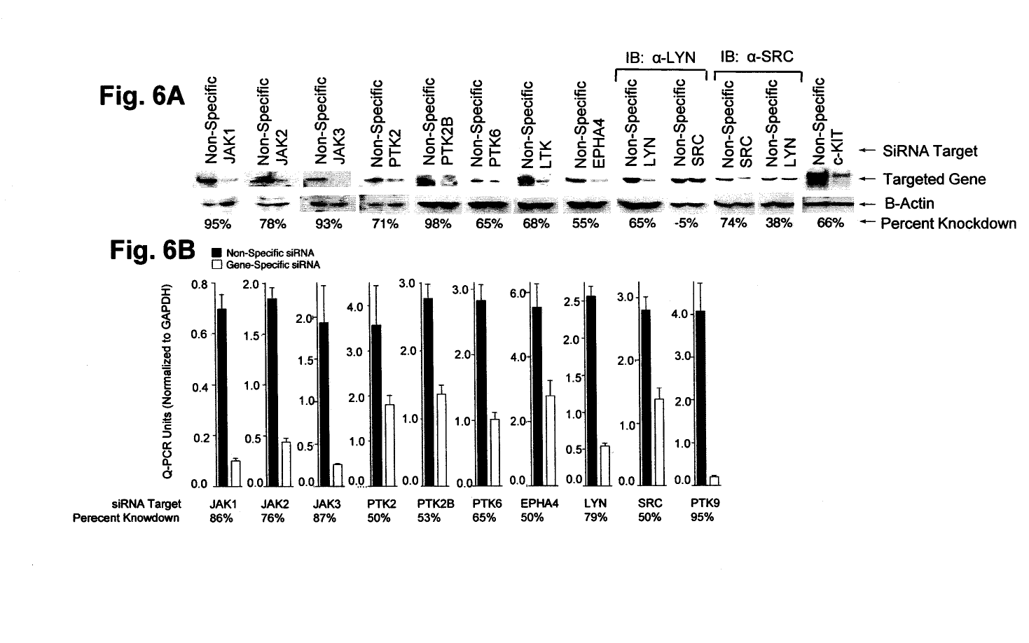

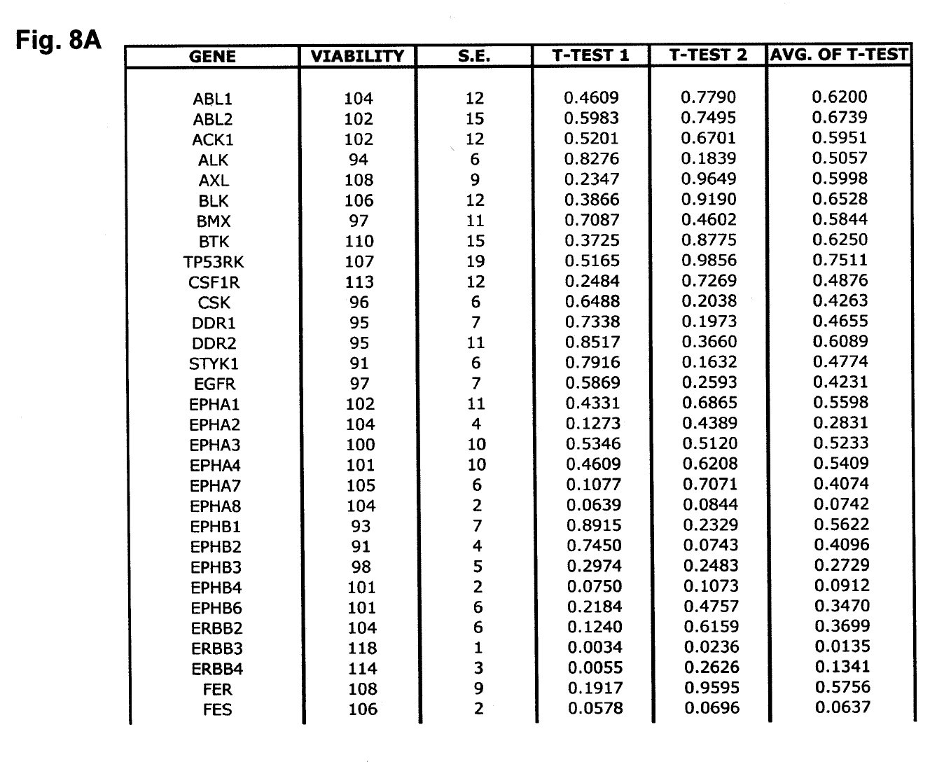

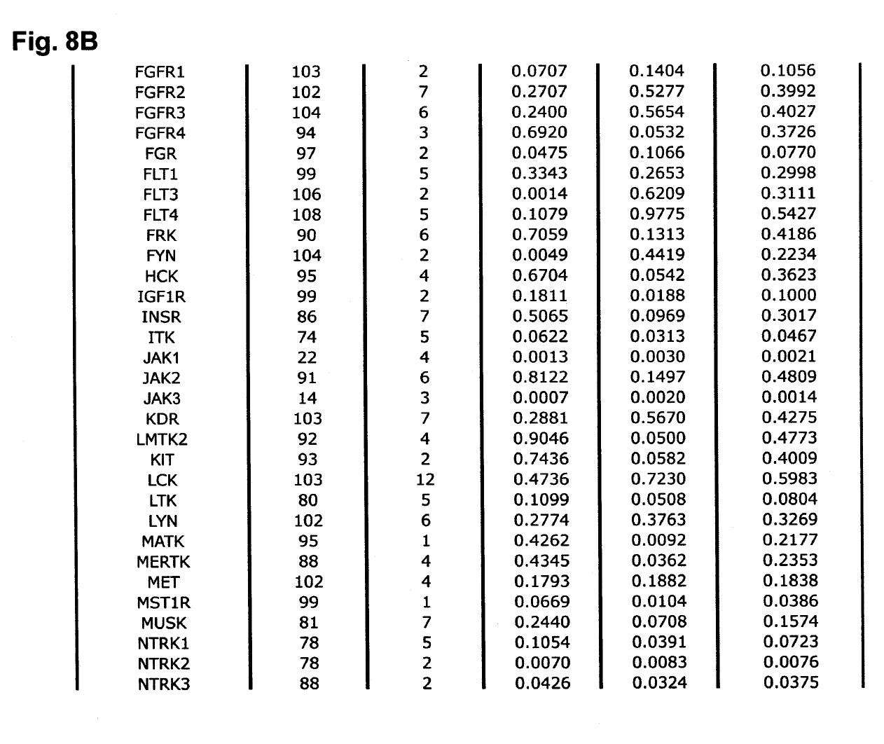

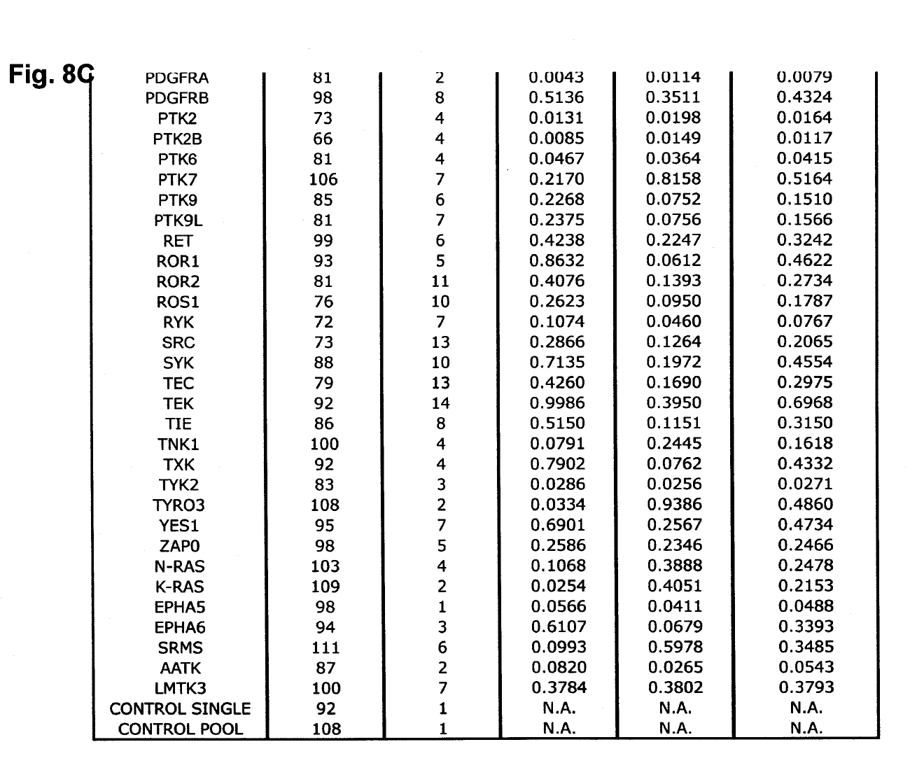

The siRNA functional profiling approach described in Example 3 was tested using a cell line with a known mutation in a receptor tyrosine kinase to determine whether the breadth of targets and extent of functional knockdown is different than in cells with an activating mutation in a cytosolic protein such as JAK3. HMC1.1 cells were chosen, as they harbor an activating mutation in the stem cell factor (SCF) receptor, c-KIT (V560G) Furitsu et al., J Clin Invest. 92: 1736-1744, 1993. Immunoblot analysis confirmed that c-KIT expression could be effectively reduced in HMC1.1 cells using the electroporation parameters described in Example 1 (FIG. 6). Significant reduction in viability and proliferation of HMC1.1 cells was observed following siRNA targeting of c-KIT (FIG. 4). In addition to reduction of HMC1.1 viability following c-KIT knockdown, equivalent reductions was observed in the viability of cells after targeting of 10 other genes EPHA4, JAK1, JAK3, leukocyte tyrosine kinase (LTK), LYN, protein tyrosine kinase (PTK)₂ (FAK), PTK2B (FAK2), PTK6 (BRK), PTK9, and SRC (a complete list of viability values and significance calculations can be found in table shown in FIG. 8). To confirm expression and efficient target reduction with the siRNA library, quantitative PCR and immunoblot analysis were performed after transfection of each of these 10 siRNAs into HMC1.1 cells. Significant target reduction at both the mRNA and protein levels was seen with each of these siRNAs (FIG. 6). With the exception of EPHA4 and LTK, these proteins are all cytosolic tyrosine kinases that are widely implicated in various signaling pathways. In particular, SRC and its family member LYN have been extensively documented as downstream signaling partners of c-KIT. The rest of these secondary targets, however, have not been previously documented as critical components of c-KIT signaling.

### Example 5

### Confirmation of Secondary Targets Using Small-Molecule Kinase Inhibitors

This example describes the confirmation of the targets identified in Example 4, are susceptible to kinase inhibition and growth inhibition of HMC1.1 cells.

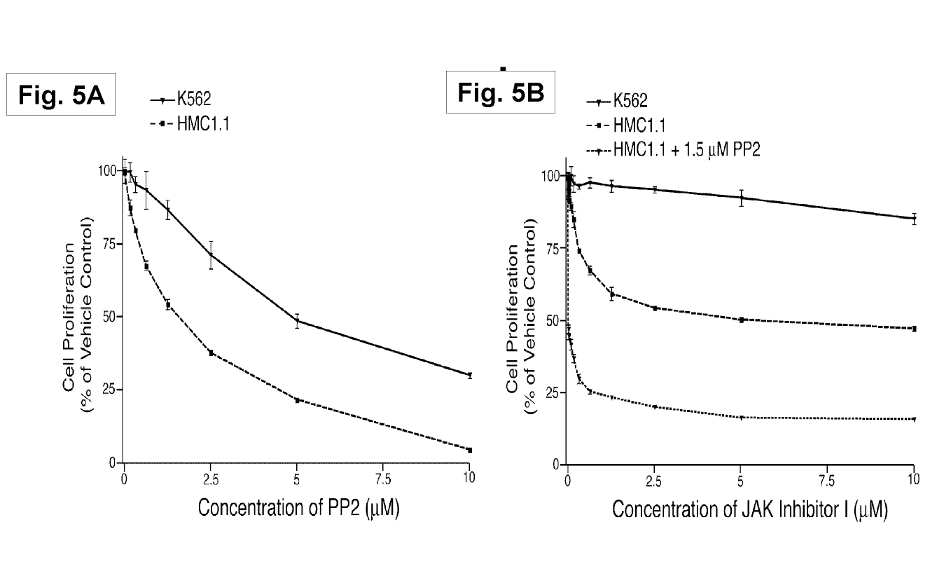

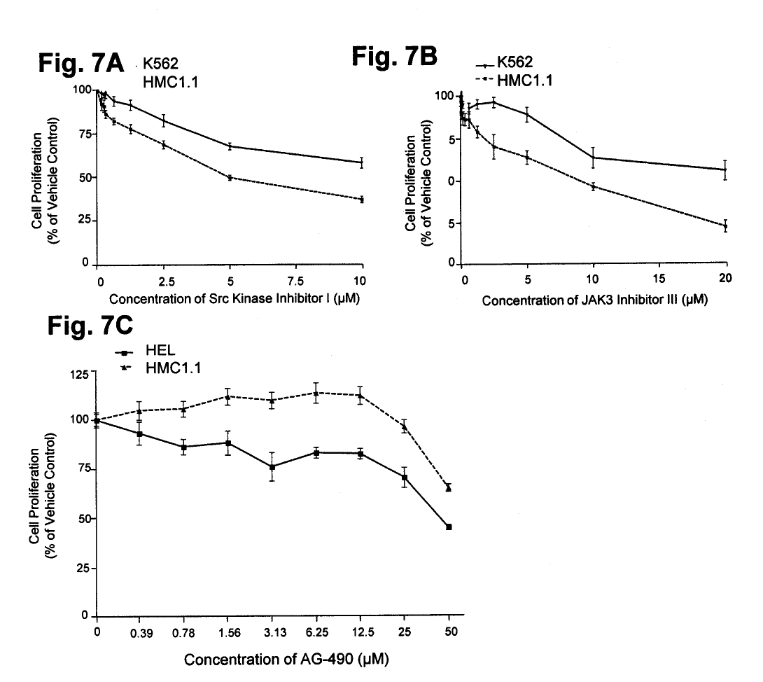

Small-molecule kinase inhibitors exist for several of the secondary targets observed in HMC1.1 cells, notably SRC, LYN, JAK1, and JAK3. To determine whether these targets are important for HMC1.1 growth and viability, as implied by the siRNA library data, proliferation assays were performed with HMC1.1 cells treated with a gradient of concentrations of PP2, SRC Kinase Inhibitor I, JAK Inhibitor I, AG-490, and JAK3 Inhibitor III. PP2 and SRC Kinase Inhibitor I are both small-molecules that exhibit broad activity against the SRC family of tyrosine kinases, with little specificity to any individual SRC family kinase. JAK Inhibitor I inhibits all members of the JAK family, while JAK3 Inhibitor III specifically inhibits JAK3. AG-490 has specificity for JAK2 at concentrations below 50 μM, however, it has been shown to inhibit JAK3 at 50 μM and above. K562 cells that are transformed by the BCR-ABL fusion oncogene were used as a control. HMC1.1 cells treated under the same conditions exhibited sensitivity to PP2, with an IC₅₀ of 1.5 μM (FIG. 5A). Parallel studies with SRC inhibitor I showed equivalent findings with HMC1.1 cells exhibiting greater sensitivity to the inhibitor than K562 cells with an IC₅₀ of 5 μM (FIG. 7A). To assess whether JAK1 and JAK3 were viable targets in HMC1.1 cells, the effect of JAK inhibitor I was tested on these cells. K562 cells are resistant to JAK inhibitor I at concentrations up to and including 10 μM; however, HMC1.1 cells exhibited sensitivity to this pan-JAK inhibitor, reaching an IC₅₀ at 5 μM (FIG. 5B). Because this inhibitor also has activity against JAK2 and TYK2, tested the JAK3-specific, JAK3 Inhibitor III, was also tested on HMC1.1 cells. An IC₅₀ of 8.5 μM (predicted IC₅₀ of 11 μM) was observed in HMC1.1 cells while the K562 cells did not reach an IC₅₀ by 20 μM (FIG. 7B). As an additional control, HMC1.1 and HEL cells were treated with the JAK2 inhibitor, AG-490. HEL cells depend on a mutated allele of JAK2 (V617F) for viability and, thus, exhibited sensitivity to AG-490 with an IC₅₀ of 45 μM. HMC1.1 cells showed significantly less sensitivity to AG-490, not reaching an IC₅₀ by 50 μM (FIG. 7C).

The reduction of viability and proliferation of HMC1.1 cells induced by JAK inhibitor I did not exceed much beyond 50% despite increasing concentrations of the drug. This suggests that alternate signaling pathways might be able to rescue these cells in the absence of functional JAK1 and JAK3 signaling. Since this data was consistent with the siRNA library findings, where no single well exhibited less than 50% reduction in viability, it was tested whether combining a SRC inhibitor with this JAK kinase inhibitor could achieve an additive effect on reduction of HMC1.1 cell growth and viability. As such, HMC1.1 cells were incubated over the same drug concentrations of JAK inhibitor I, but in combination with an IC₅₀ (1.5 μM) of PP2. The combination yielded lower viability readings at all dose points compared with the JAK inhibitor alone (FIG. 5B). These data indicate that HMC1.1 cells depend on JAK and SRC family members for growth and viability and that these two signaling pathways may be partially redundant. To further clarify which specific JAK and SRC family members were functioning in this redundant fashion, HMC1.1 cells were transfected with all possible combinations of siRNA targeting JAK1, JAK3, LYN, and SRC. No further decrease in cell viability was observed with any of these combinations than with individual knockdown of these genes. This indicates that the additive effect observed with JAK and SRC family inhibition may rely either on off-target effects of these inhibitors or on the functions of other gene family members in addition to JAK1, JAK3, LYN, and SRC.

### Example 6

### Materials and Methods

This example describes exemplary procedures and reagents used in the Examples 7-9.

### Collection of Patient Samples and Cell Culture:

All clinical samples were obtained with informed consent with approval by the Institutional Review Boards of Stanford University and Oregon Health & Science University. Blood or bone marrow from patients was separated on a Ficoll gradient and mononuclear cells were treated with ACK lysis buffer. Alternatively, certain samples were treated directly with ACK lysis buffer. Following electroporation with the siRNA library, cells were cultured in R10 (RPMI-1640 medium supplemented with 10% FBS (ATLANTA BIOLOGICALS®, Lawrenceville, Ga.), L-glutamine, penicillin/streptomycin (INVITROGEN®), and fungizone (INVITROGEN®)) supplemented with 10⁻⁴ M 2-mercaptoethanol (Sigma). 293 T17 and BA/F3 cells were obtained from American Type Culture Collection (Manassas, Va.). HEL cells were obtained from the German National Resource Centre for Biological Material (DSMZ). 293 T17 cells were maintained in DMEM medium supplemented with 10% FBS (ATLANTA BIOLOGICALS®, Lawrenceville, Ga.), L-glutamine, penicillin/streptomycin (INVITROGEN®), and fungizone (INVITROGEN®). HEL and BA/F3 cells were maintained in R10, with BA/F3 cells also requiring the addition of WEHI-conditioned media.

### Cell Viability, Proliferation, and Colony Assays:

For proliferation and viability assays, cells were incubated for 72 hours (density per well of 4,000 for cell lines and 50,000 for primary cells) in the presence of dose gradients of thrombopoietin (Peprotech), imatinib (NOVARTIS®), AG490 (EMD BIOSCIENCES®, San Diego, Calif.), or midostaurin (PKC412) (LC Laboratories, Woburn, Mass.), and the number of viable cells was determined with the CELLTITER 96 AQᵤₑₒᵤₛ One solution cell proliferation assay (PROMEGA®). For determination of factor-independent growth, parental BA/F3 cells as well as BA/F3 cells expressing MPL WT, 1886InsGG, or W515L were washed three times and 1 million cells were seeded into triplicate wells of a 6-well plate in R10. Total viable cells were determined every day for 1 week using PI exclusion on a Guava cell counter (GUAVA TECHNOLOGIES®). For colony assays, 200,000 primary cells from patient samples were incubated in the presence of dose gradients of AG490, SU11248, or PTK787 in methocult containing IL-3, GM-CSF, and SCF (STEMCELL TECHNOLOGIES®). Ten days later, colonies were counted manually or using a GELCOUNT® automated colony counter (OXFORD OPTRONIX®, Oxford, UK).

siRNA Knockdown using Tyrosine Kinase Library:

Patient blood or bone marrow was prepared as above and cells (2.25×10⁷) were washed one time in OPTIMEM® (INVITROGEN®) and resuspended in 4.2 ml of SIPORT buffer (AMBION®). Cells were aliquoted at 42 μl per well onto a 96-well electroporator (AMBION®) and 2 μl of siRNA at 20 μM was added to each well (tyrosine kinase library (purchased from DHARMACOM+) with single and pooled non-specific siRNA as well as siRNA against ephrin type-A receptor (EPHA)₅, EPHA6, src-related kinase lacking C-terminal regulatory tyrosine and N-terminal myristylation (SRMS), apoptosis-associated tyrosine kinase (AATK), lemur tyrosine kinase (LMTK)3, N-RAS, K-RAS (all from DHARMACOM®) added separately because they are not included in the tyrosine kinase library). Cells were electroporated at 1110 V (equivalent of 150 V per well), 200 μsec, 2 pulses and 50,000 cells per well were replated using a Hydra 96-channel automated pipettor (Matrix Technologies, Hudson, N.H.) into triplicate plates containing 100 μl per well of culture media. For determination of cell viability, cells were subjected to the CELLTITER® 96 AQᵤₑₒᵤₛ One solution cell proliferation assay (MTS) (PROMEGA®). All values were normalized to the median value on the plate.

### Immunoblotting:

For BA/F3 cell stimulation and western blotting, cells were serum starved overnight in RPMI supplemented with 0.1% bovine serum albumin, L-glutamine, and penicillin/streptomycin. The following day, cells were stimulated for 15 minutes with 0-10 ng/ml recombinant thrombopoietin (Peprotech). Cells were lysed in sample buffer (75 mM Tris pH 6.8, 3% SDS, 15% glycerol, 8% β-mercaptoethanol, 0.1% bromophenol blue) and separated by SDS-PAGE. Proteins were transferred to PVDF membranes (Millipore) and subjected to immunoblot analysis with antibodies specific for MPL (SANTA CRUZ BIOTECHNOLOGIES®), total or phospho-STAT5 (BD BIOSCIENCES®), total or phospho JAK2, STAT3, ERK1/2, AKT (CELL SIGNALING TECHNOLOGIES®), or β-actin (Millipore).

### Cloning and Creation of Stable Cell Lines:

For cloning of MPL, RNA was extracted from HEL cells (QIAGEN®) and reverse-transcribed into cDNA (INVITROGEN® SUPERSCRIPT III®) using random hexamer primers. MPL was PCR amplified using the forward primer, 5′ CACCACACAGTGGCGGAGAAGATG 3′ (SEQ ID NO: 386), and the reverse primer, 5′ GCCTAATTGTGAGGGCAGAC 3′ (SEQ ID NO: 387), and cloned into the Gateway vector, pENTR/D-TOPO (INVITROGEN®). MPL was then cloned into a Gateway compatible version of MSCV-IRES-GFP (MIG) by performing an LR recombination reaction. Introduction of the two base-pair GG insertion (1886InsGG) was carried out using the QUIKCHANGE® XL-II mutagenesis kit (Stratagene), and MPL W515L. Retrovirus expressing MIG-MPL WT, 1886InsGG, or W515L was propagated in 293 T17 cells by co-transfection of each respective MIG-MPL construct with the ECOPACK® plasmid using FUGENE® (Roche, Indianapolis, Ind.). One milliliter of viral supernatant was mixed with polybrene (5 mg/ml), HEPES (7.5 mM), and 10⁶ BA/F3 cells and placed in a centrifuge at 2500 RPM for 90 minutes at 30° C. GFP positive cells were sorted on a BD FACSARIA® (BD BIOSCIENCES®) after 48 hours.

### Sequencing Analyses:

Genomic DNA from patient samples (QIAGEN®) was used to sequence JAK2, K-RAS, and MPL using primers described in Sjoblom et al., Science 314, 268-74, 2006. For MPL exon 12, individual copies of the PCR product were cloned and sequenced. Total RNA (QIAGEN®) from Patient 07-079 was used to synthesize cDNA (INVITROGEN® SUPERSCRIPT III®) with random hexamer primers and MPL was amplified using the forward primer, 5′CAGGACTACAGACCCCACAG 3′ (SEQ ID NO: 388), and the reverse primer, 5′ AGCCTGCCTGTGGAGAAAG 3′ (SEQ ID NO: 389). Individual copies were cloned and sequenced.

### Allele-Specific PCR:

For MPL^{1886InsGG}, quantitative PCR was performed on genomic DNA using SYBR® Green qPCR SuperMix (INVITROGEN®) and a DNA Engine Opticon 2 system for real-time PCR (Bio-Rad).

### Statistical Analyses:

For siRNA functional screens on patient samples, a Student's t test was carried out for each well in comparison to both single and pooled non-specific siRNA controls. The mean of the two-tailed p-value was determined for consideration of significance. Data points with value greater than two standard deviations of the mean below the mean value on the plate and p-value less than 0.05 were considered significant. For cell proliferation, cell viability, and colony assays, a Student's t test was carried out for each dose or time point compared with the relevant control cell line or the no drug control.

### Example 7

### SiRNA Functional Screening of Patients with Hematologic Malignancies

This example describes the results of samples screened for activating tyrosine kinase mutations in samples obtained from patients diagnosed with hematologic malignancies.

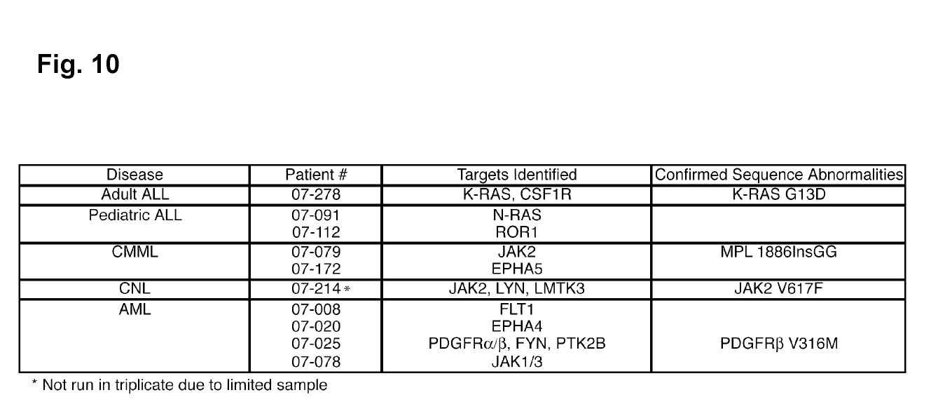

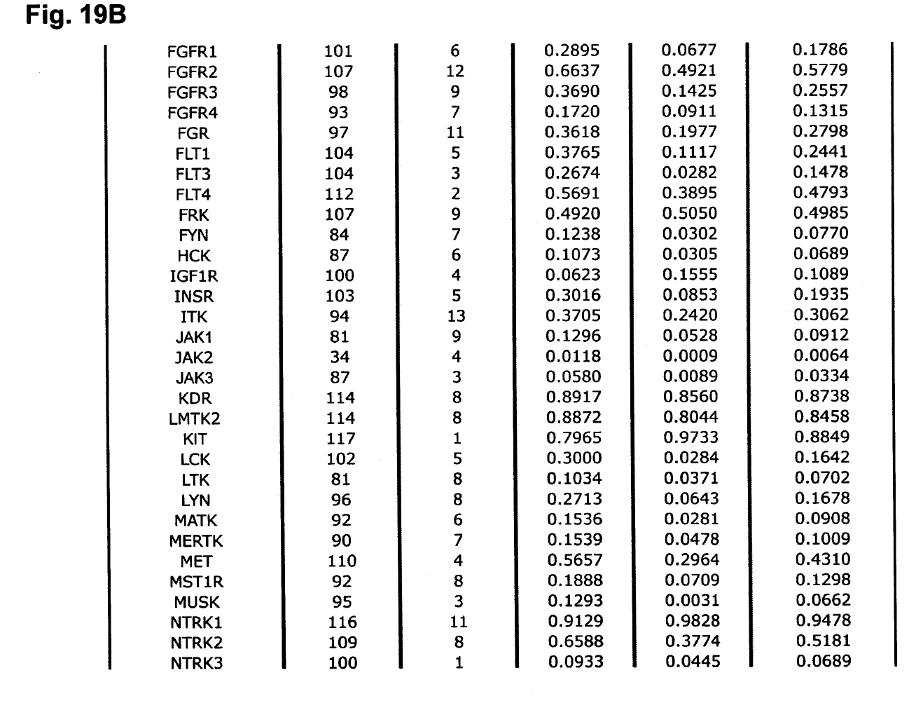

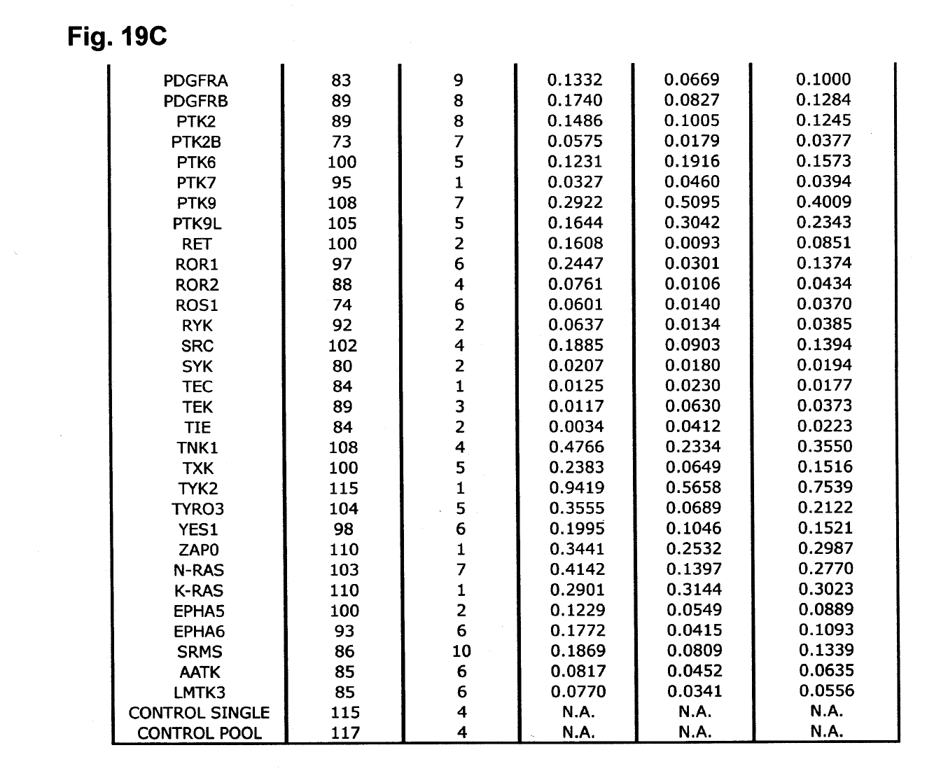

To assess the contribution of tyrosine kinases in hematologic malignancies, siRNA functional screening for all the human tyrosine kinases was performed on samples obtained from 27 patients with CML-myeloid blast crisis, primary myelofibrosis, ALL, chronic neutrophilic leukemia (CNL), CMML, or AML (see table in FIG. 10). All members of the tyrosine kinase family as well as N-RAS and K-RAS were individually silenced with siRNA and cell viability was evaluated after four days in culture. Of the 27 samples, nine showed evidence for sensitivity to one or more tyrosine kinases and two showed evidence for sensitivity to N-RAS or K-RAS inhibition (see the table shown in FIG. 19). In particular, sensitivity was detected to siRNA targeting of JAK2 as well as LYN and LMTK3 in a sample obtained from a patient diagnosed with JAK2^{V617F}-positive CNL. Additionally, sensitivity to K-RAS inhibition was observed in a sample obtained from a patient diagnosed with ALL. Subsequent sequence analysis revealed the presence of the activating allele, K-RAS^{G13D}, in this patient. Other targets identified by siRNA screening with the complete kinase library were ROR1 and N-RAS in pediatric patients with ALL, CSF1R in a patient with biphenotypic ALL with an MLL gene rearrangement, JAK2 and EPHA5 in patients with CMML, and FLT1, EPHA4, PDGFRa/b, PTK2B, FYN, and JAK1/3 in patients with AML.

### Example 8

### Confirmation of Identification Tyrosine Kinase Target of Therapeutic Intervention Small-Molecule Inhibitors of Tyrosine Kinases

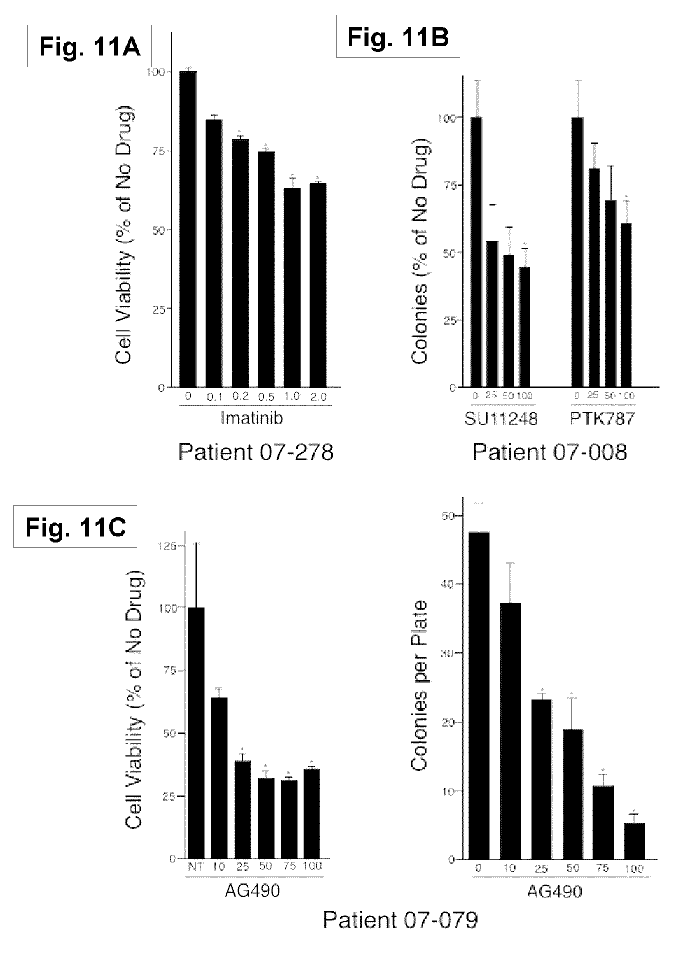

The known, activating mutations, JAK2^{V617F} and K-RAS^{G13D}, were found in two of the patient samples analyzed by the siRNA functional screening described in Example 7. However, several targets identified by siRNA screen did not contain evident mutations in subsequent sequence analyses (see the table shown in FIG. 19). To confirm that these results represented viable targets, three patient samples were tested for sensitivity to small-molecule inhibitors with activity against the identified targets. An adult ALL patient (07-278) exhibited sensitivity to knockdown of CSF1R by siRNA. Analysis of CSF1R revealed wild-type sequence, however CSF1R is a target of imatinib (IC50 of 1.26 μM), thus cells from this patient were tested for response to an imatinib dose gradient. Cells from this patient exhibited sensitivity equivalent to that seen with CSF1R siRNA at imatinib doses of 1-2 μM (FIG. 11A). These results reveal that CSF1R may represent a previously unrecognized, therapeutic target in Patient 07-278, despite absence of a mutation in CSF1R itself. This result was unexpectedly surprising because mutations were not identified. An adult AML patient (07-008) showed sensitivity to FLT1, a target to which there are several small-molecule inhibitors available, namely SU11248 (also known as sunitinib) and PTK787. Treatment of cells from this patient with each of these drugs in a colony assay to assess proliferative status showed colony formation was blocked by each drug at low nanomolar concentrations (FIG. 11B). Although sequence analysis failed to detect any point mutations, these data predict leukemia cell dependence on FLT1 and suggest that inhibiting FLT1 may be a viable therapeutic strategy in this patient. Sensitivity to JAK2 inhibition was observed in a CMML patient (07-079), thus cells from this patient were assayed for sensitive to a selective JAK2 inhibitor, AG490. A cell viability assays was performed as well as colony assays in the presence of a dose gradient of AG490. Strong sensitivity to this JAK2-specific inhibitor was observed in both settings (FIG. 11C). These results demonstrate that the disclosed methods can be used to identify previously unknown therapeutic targets that cannot be identified by common methods such as gene sequencing.

### Example 9

### Detection of JAK2 Dependence in a Case of Aggressive Systemic Mastocytosis with Associated CMML

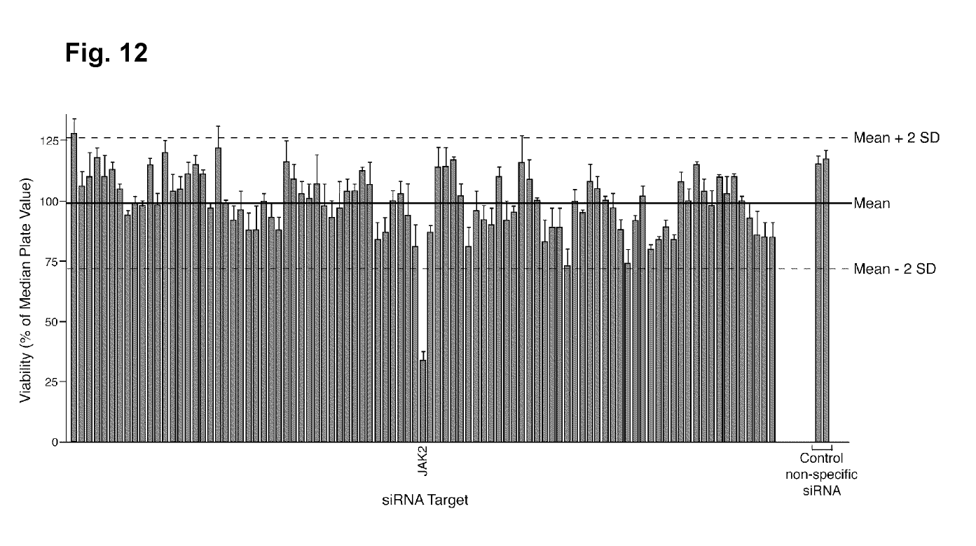

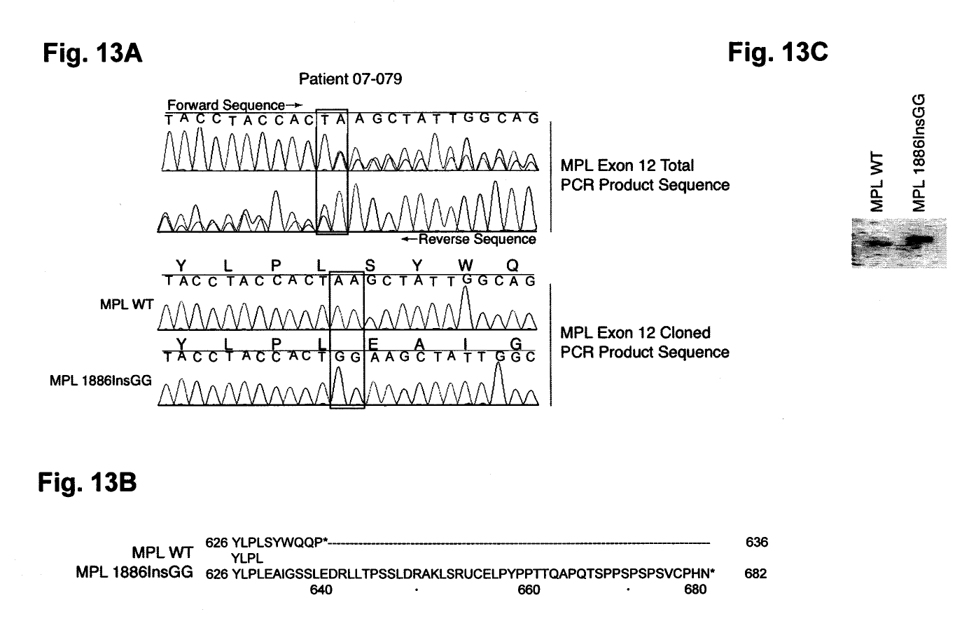

Patient 07-079 presented with a diagnosis of aggressive systemic mastocytosis (ASM) with CMML as an associated hematologic, clonal, non-mast cell lineage disease. This patient was enrolled on a phase II trial of midostaurin (PKC412) for patients with ASM and mast cell leukemia. Midostaurin is a broad-spectrum tyrosine kinase inhibitor with in vitro activity against the imatinib-resistant allele of KIT^{D816V} with an IC₅₀ of 30-40 nM. This patient was treated for twelve 28-day cycles, achieving a partial clinical response. Four months later, treatment with midostaurin was re-initiated on an extension protocol. Three months into this extension protocol, this patient presented with pneumonia/sepsis in the setting of relapse of the CMML component of her myeloproliferative disorder. A siRNA screen of tyrosine kinases and analysis was performed on cells from the peripheral blood from patient 07-079 and it was observed that siRNA targeting JAK2 resulted in significantly reduced viability of the leukemic cells compared with non-specific controls, while no other siRNA constructs induced a significant decrease in viability (FIG. 12; a complete list of viability values and significance calculations can be found in the table shown in FIG. 19). Sequencing of JAK2 failed to reveal any mutations; however, as recent studies of myeloproliferative disorders have identified an activating mutation in the thrombopoietin receptor, MPLW^{515L}, that signals upstream of and depends on JAK2, a screen was conducted for MPL mutations. Sequence analysis of MPL revealed wild-type sequence at position W515, however a two base pair guanine insertion (hereafter termed MPL^{1886InsGG}) was observed in exon 12 near the end of the open reading frame (FIG. 13A). This insertional mutation was observed at an equal incidence with wild-type sequence in PCR products from genomic DNA as well as cDNA from this patient indicating heterozygous expression from this locus (FIG. 13A). The predicted effect of this two base pair insertion is a frameshift that alters the final six amino acids of the coding region and extends the open reading frame by 46 amino acids, thus producing a higher molecular weight protein with unique C-terminal tail sequence (FIG. 13B). This was confirmed by MPL-specific antibody immunoblotting of lysates from 293 T17 cells expressing either MPL^{WT} or MPL^{1886InsGG} (FIG. 13C). The MPL^{1886InsGG} insertion was not seen in sequence traces of 75 normal individuals, thus it was determined whether this novel genetic abnormality was involved in the pathogenesis of the ASM with associated CMML in this patient. Of note, a pre-trial sample from the patient was screened for MPL^{1886InsGG} as well as KIT^{D816V} by allele-specific quantitative PCR, and only the MPL^{1886InsGG} mutation was detected, suggesting that this mutant allele may have been driving both the ASM and CMML components of the disease. Indeed, thrombopoietin signaling through MPL has been previously shown to support the growth of human mast cells in culture. These results demonstrate that the disclosed siRNA functional screen can be used to identify potential targets that are otherwise silent from sequence analysis.

### Example 10

### Functional Characterization of a novel MPL Mutant Allele

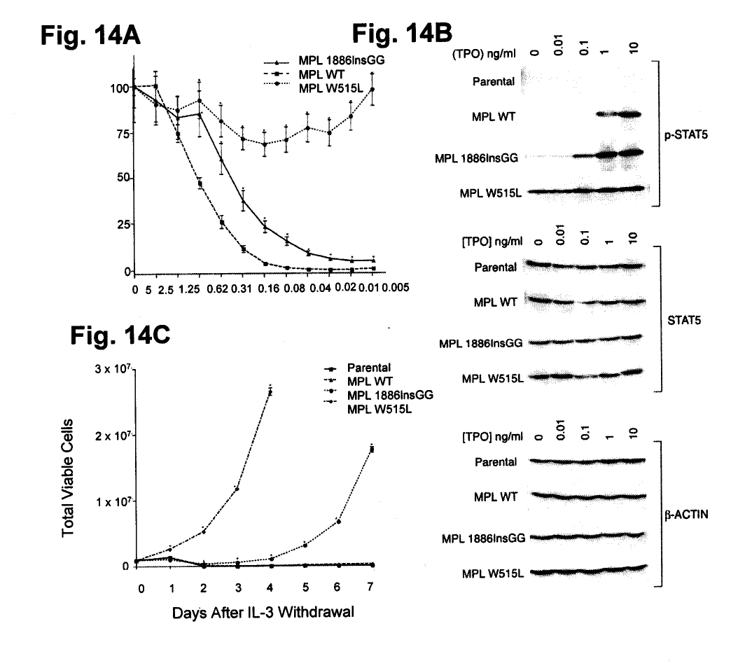

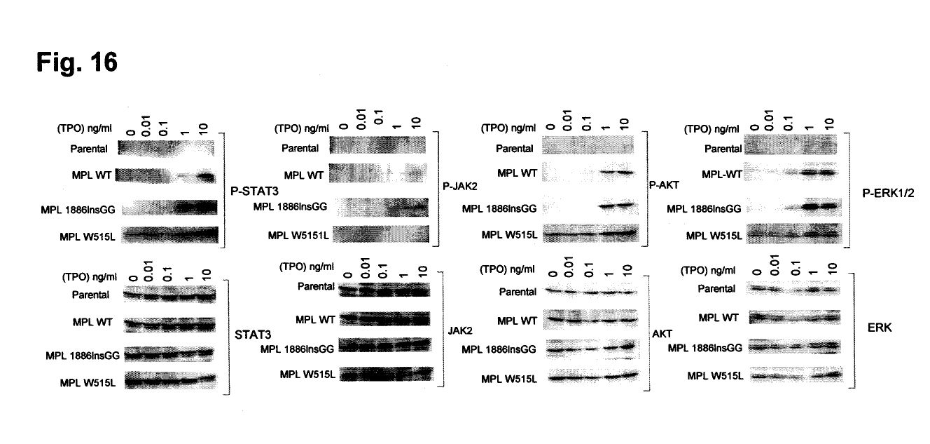

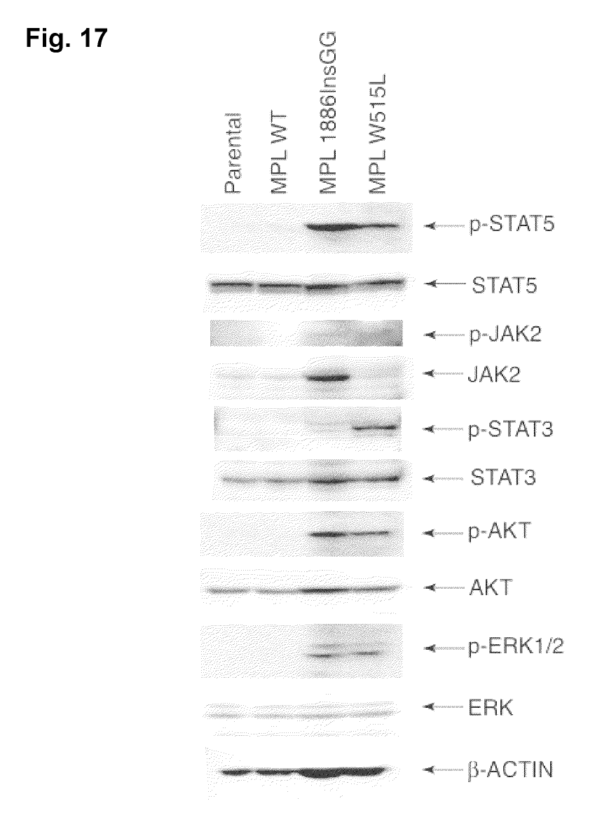

To assess the capacity of MPL^{1886InSGG} for leukemogenesis, this insertion was introduced into the retroviral expression construct, MIG-MPL, to create stable BA/F3 cells expressing both MPL^{WT} as well as MPL^{1886InsGG}. To determine whether the 1886InsGG mutation confers increased activity on MPL, these BA/F3 cells were tested in several ways. First, proliferation assays were conducted in the presence of a dose gradient of thrombopoietin. Results showed increased growth and viability at low doses of thrombopoietin in MPL^{1886InsGG} compared with MPL^{WT}, indicating that MPL^{1886InsGG} is hypersensitive to its ligand (FIG. 14A). MPL^{1886InsGG} also conferred an intermediate phenotype compared with the strongly activating MPL^{W515L} allele. Immunoblotting of BA/F3 cells that were stimulated with recombinant thrombopoietin confirmed that MPL^{1886InsGG} is hypersensitive to its ligand. Specifically, parental BA/F3 cells that do not express human MPL failed to show any signaling response to thrombopoietin stimulation. BA/F3 cells expressing MPL^{WT} exhibited phosphorylation of the downstream signaling molecules JAK2, STAT3, STAT5, ERK, and AKT at high doses of ligand. Consistent with data from proliferation assays, BA/F3 cells expressing MPL^{1886InsGG} exhibited stronger phosphorylation of each of these signaling cascades at approximately 10-fold lower doses of thrombopoietin compared with MPL^{WT} (FIG. 14B and FIG. 16). Again, MPL^{1886InsGG} seemed to confer an intermediate phenotype compared with MPL^{W515L} expression, which showed phosphorylation of each of these signaling pathways even in the absence of ligand stimulation. Finally, complete deprivation of growth factor showed that both MPL^{1886InsGG} and MPL^{W515L} could confer factor-independent growth on BA/F3 cells. MPL^{1886InsGG} exhibited a three-day delay in outgrowth compared with MPL^{W515L}, again indicating a more subtle phenotype (FIG. 14C). Immunoblotting of these factor-independent BA/F3 cells, in the absence of ligand stimulation, demonstrated that both MPL^{1886InsGG} and MPL^{W515L} constitutively induce activation of JAK2, STAT5, STAT3, ERK, and AKT. The factor independent MPL^{1886InsGG} cell line expressed highly elevated levels of JAK2 compared with parental, MPL^{WT}, or MPL^{W515L} BA/F3 cells suggesting that factor independent growth in the context of MPL^{1886InsGG} necessitates selection for cells that express JAK2 at high levels (FIG. 17). This may be one variable accounting for the delayed outgrowth and intermediate phenotype of MPL^{1886InsGG} compared with MPL^{W515L}.

### Example 11

### Confirmation that RAPID Results Predict Targeted Therapy Efficacy

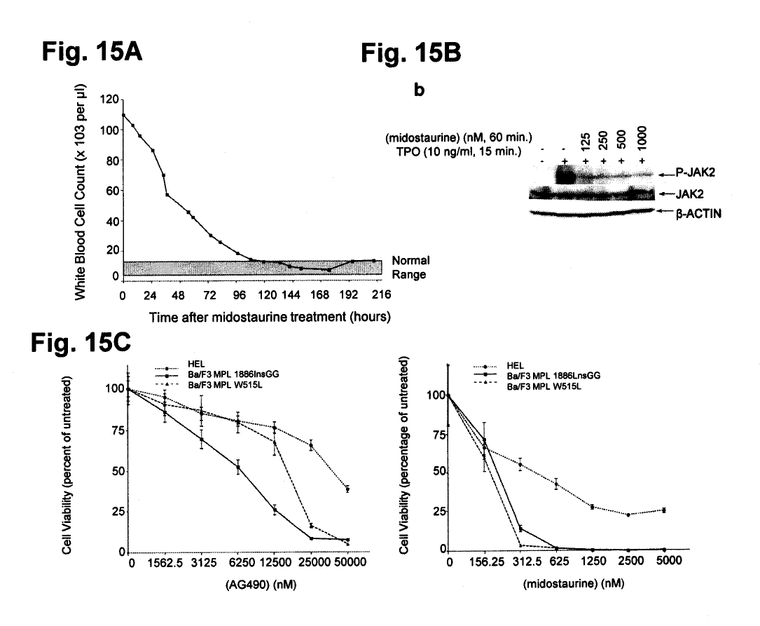

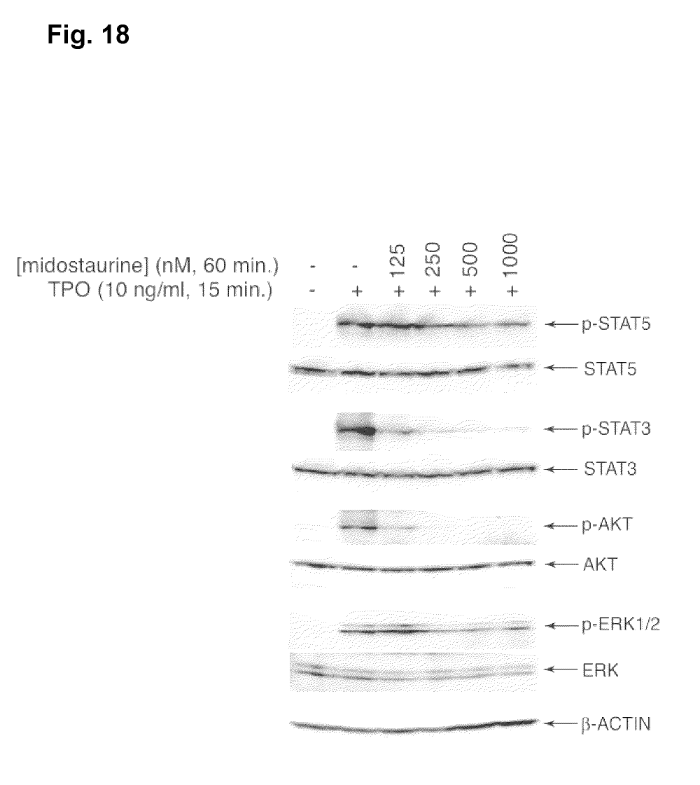

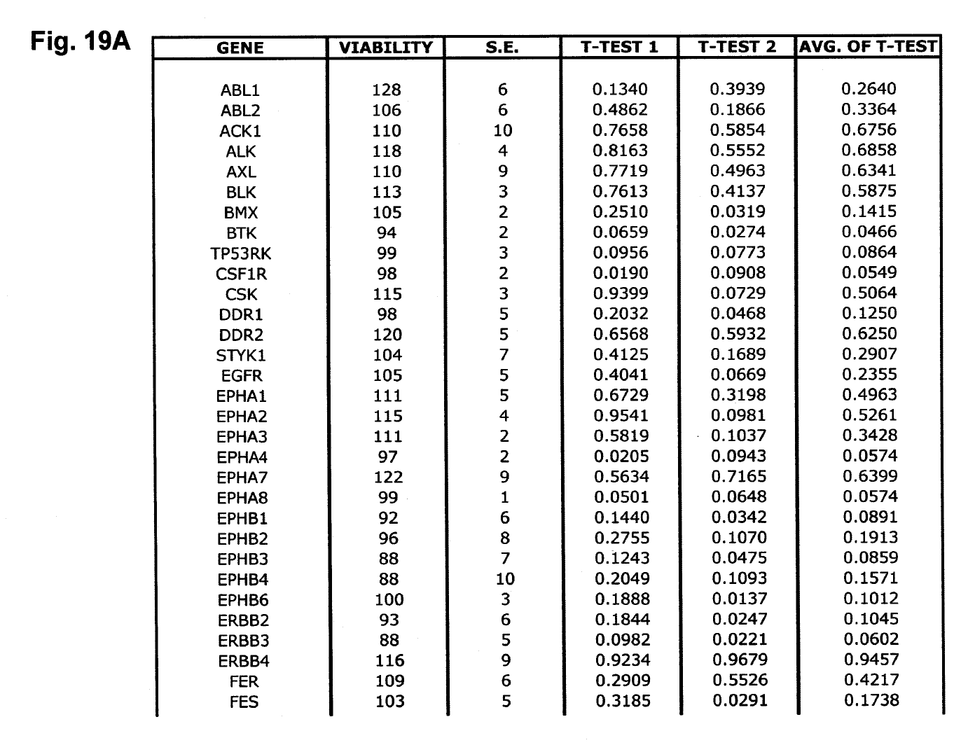

Due to the setting of pneumonia/sepsis and hospitalization, administration of midostaurin was briefly stopped in patient 07-079. However, given the prior response to midostaurin treatment, the patient was placed back on midostaurin, briefly in combination with hydroxyurea because of clinical concern for the rapidly rising WBC count/monocytosis. Treatment with midostaurin resulted in normalization of WBC counts over a period of 5 days, which was subsequently maintained despite discontinuation of hydroxyurea treatment (FIG. 15A). Midostaurin is a derivative of staurosporine, a broad-spectrum tyrosine kinase inhibitor that has been shown to bind to JAK2, the molecular mechanism underlying drug efficacy in this case could be due to midostaurin effects on the JAK2 signaling cascade as was predicted by the siRNA functional screen and sensitivity to the JAK2-specific small-molecule inhibitor, AG490. To confirm this was the case BA/F3 cells expressing MPL^{1886InsGG} were treated with a dose gradient of midostaurin prior to stimulation with thrombopoietin. Subsequent immunoblot analysis indicated that midostaurin decreased phosphorylation of JAK2 as well as STAT5, STAT3, AKT, and ERK in response to thrombopoietin (FIG. 15B and FIG. 18). To further assess the potential of using midostaurin in JAK2-dependent malignancy, the sensitivity to both AG490 and midostaurin of factor-independent BA/F3 cells expressing MPL^{1886InsGG} or MPL^{W515L} was determined. Both cell lines showed strong sensitivity to each inhibitor with the IC₅₀ values for midostaurin being approximately 200 nM for both lines (FIG. 15C). Finally, the sensitivity HEL cells (which express the JAK2^{V617F} oncogene) to both AG490 and midostaurin was tested. Similar to the MPL-dependent BA/F3 cells, HEL cells exhibited sensitivity to both inhibitors with a midostaurin IC₅₀ value of approximately 400 nM (FIG. 15C). HEL cells did appear somewhat less sensitive to both drugs than the MPL-expressing BA/F3 cells, likely due to the high dependence BA/F3 cells generally exhibit toward any oncogene conferring factor-independent growth. Thus, the disclosed siRNA functional screen confirmed a role for tyrosine kinases in leukemogenesis of approximately 1 out of 3 patients. Additionally, the results from the disclosed siRNA functional screen predicted a clinically useful protein target, which was therapeutically implemented in the form of midostaurin treatment. Finally, midostaurin is suggested as a potential therapeutic in patients with JAK2^{V617F}, MPL^{W515L}, MPL^{1886InsGG}, as well as other JAK2-dependent malignancies.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A method for identifying a tyrosine kinase with aberrant activity in a subject diagnosed with a hematological malignancy, comprising:
selecting a subject diagnosed with a hematological malignancy;
contacting an array comprising a set of at least two inhibitory RNAs, wherein each individual inhibitory RNA in the set of inhibitory RNAs is located at an addressable location on the array, and wherein each individual inhibitory RNA in the set of inhibitory RNAs specifically inhibits expression of a tyrosine kinase with a sample comprising white blood cells or bone marrow cells obtained from the subject, wherein the white blood cells or bone marrow cells are addressable;
introducing the inhibitory RNAs into the white blood cells or bone marrow cells by electroporation at the addressable locations on the array;
detecting one or both of cell proliferation and cell viability of the white blood cells or bone marrow cells contacted with each inhibitory RNA that specifically inhibits expression of the tyrosine kinase; and
identifying an inhibitory RNA that decreases one or both of cell proliferation and cell viability of the white blood cells or bone marrow cells as compared to a control, wherein a decrease in one or both of cell proliferation and cell viability of the white blood cells or bone marrow cells as compared to the control identifies a tyrosine kinase with aberrant activity in the subject.

2. The method of claim 1, wherein the control is a sample of white blood cells or bone marrow cells not contacted with the set of inhibitory RNAs.

3. The method of claim 1, further comprising selecting a therapeutic agent that affects a biological signaling pathway comprising the tyrosine kinase identified as having aberrant activity in the subject and administering the agent to the subject.

4. The method of claim 3, wherein the therapeutic agent is a small molecule or antibody that inhibits the activity of the tyrosine kinase identified as having aberrant activity.

5. The method of claim 3, wherein the therapeutic agent is a monoclonal antibody that specifically binds and inhibits the kinase activity of the tyrosine kinase identified as having aberrant activity.

6. The method of claim 1, wherein the identified tyrosine kinase is a receptor tyrosine kinase.

7. The method of claim 1, wherein the identified tyrosine kinase activity is a non-receptor tyrosine kinase.

8. The method of claim 1, wherein electroporation comprises subjecting the cells at the individual addressable locations in the array to two electrical pulses of 150 μsec to 250 μsec duration at 125 V to 175 V.

9. The method of claim 8, wherein electroporation comprises subjecting the cells at the individual addressable locations in the array to two electrical pulses of 200 μsec duration at 150 V.

10. The method of claim 1, wherein the array is a 96 well plate and wherein the plate is subjected to two electrical pulses of 150 μsec to 250 μsec duration at 1000 V to 1200 V.

11. The method of claim 10, wherein the 96 well plate is subjected to two electrical pulses of 200 μsec duration at 1110 V.

12. The method of claim 1, wherein the white blood cells are peripheral white blood cells.

13. The method of claim 1, wherein detecting proliferation of the cell or viability of the cells comprises performing a 3-(4,5-Dimethylthiazol-2-yl)-5-(3-Carboxymethoxyphenyl)-2-(4-Sulfophenyl)-2H-Tetrazolium (MTS) assay, wherein the MTS assay comprises contacting the white blood cells or the bone marrow cells with MTS and measuring the formation of formazan.

14. The method of claim 1, wherein the hematological malignancy comprises chronic myeloid leukemia (CML), primary myelofibrosis, acute lymphocytic leukemia (ALL), chronic neutrophilic leukemia (CNL), chronic myelomonocytic leukemia (CMML), or acute myelocytic leukemia (AML).

15. The method of claim 1, wherein the subject is a human subject.

16. The method of claim 1, wherein the set of inhibitory RNAs is a set of siRNAs, microRNAs, shRNAs, or ribozymes.

17. The method of claim 16, wherein the set of inhibitory RNAs is a set of siRNAs.

18. The method of claim 17, wherein the set of siRNAs comprises a set of 2-91 siRNAs, wherein each of the 2-91 siRNAs inhibits a different one of the 91 human tyrosine kinases.

19. The method of claim 18, where in the siRNAs that inhibit the 91 human tyrosine kinases are selected from the nucleic acid sequences set forth in Table 1.

20. The method of claim 17, wherein the set of siRNAs comprises 2-91 sets of four siRNAs, wherein each set of four siRNAs inhibit a different one of the 91 human tyrosine kinases.

21. The method of claim 20, wherein the set of siRNAs consist of the nucleic acid sequences set forth in Table 1.
